(19) United States
(12) Patent Application Publication
(10) Pub. No.: US 2004/0205473 A1
(43) Pub. Date: Oct. 14, 2004

(54) Method and system for implementing an enterprise information portal

(76) Inventors: Gwyn Fisher, Ottawa (CA); Cam Stevenson, Ottawa (CA); Steven Gutz, Ottawa (CA); Doug Hester, Raleigh, NC (US); John Lewis, Raleigh, NC (US)

Correspondence Address: Ralph A. Dowell, Dowell & Dowell, P.C., Suite 309, 1215 Jefferson Davis Hwy., Arlington, VA, 22202, US

(21) Appl. No.: 10/205,625

(22) Filed: Jul. 26, 2002

Related U.S. Application Data
(63) Continuation of application No. PCT/CA01/00068, filed on Jan. 29, 2001.
(60) Provisional application No. 60/177,657, filed on Jan. 27, 2000.

(51) Int. Cl. G06F 15/00

(52) U.S. Cl. 715/500

(57) ABSTRACT

The invention provides an Enterprise Information Portal (EIP) for access by a user via a browser on a network, said portal comprising: (a) an interface for communicating between said portal and said user; (b) a theme manager for selecting a theme, said theme defining a presentation format for said browser; and (c) a plug-in manager for controlling a plurality of plug-ins, said plug-ins for retrieving and formatting information content for said user, wherein said plug-in retrieves information from both local and remote sources.

The invention relates to the field of data processing systems. More specifically, the invention relates to corporate or enterprise information portals.

### BACKGROUND OF THE INVENTION

Consumer portals such as Yahoo!, Excite, Lycos, and InfoSeek have changed the way web surfers search for information by providing a single access point to satisfy most, if not all, of their content requirements. Portals are now receiving more attention than virtually any other Internet technology. In fact, many of the world's largest companies have begun implementing portal based solutions. In the near future, the implemenation of portal solutions may well redefine markets and the businesses upon which they are built. There is thus a need to redefine traditional information delivery based on the model of the Enterprise Information Portal (EIP).

An EIP is not a single technology or application, but a collection or related functional components that work together. Many existing corporate portals merely display information for users, or allow them to interact with a single application. There is thus a need for EIP solutions that provide users with a web-based workspace that is completely personalized and enables them to not only search for and view information, but also to act on the data using a variety of applications and technologies. Moreover, there are several market-dictated criteria that portal solutions should meet in order to be considered true Enterprise Information Portals and to meet the needs of corporate users.

In theory, an EIP is a web-based tool that bridges the disparate worlds of structured (databases) and unstructured (documents, images) data across the enterprise, providing users with access and analysis capabilities via a single point of access. In order to live up to this definition, an EIP solution must demonstrate a variety of characteristics and provide essential services. The most critical of the principal elements are as follows: security, presentation, personalization, collaboration, publishing and distribution, integration, interactivity, categorization, search, multi-repository support, and metadata management. However, present corporate portals do not provide these principal elements satisfactorily.

Thus, there is a need for an enterprise information portal that provides users with a single logon model. Such a model should streamline the workspace environment and eliminate the need to for users to remember, configure, and maintain multiple usernames and passwords. The goal would be to have a unified logon to all information sources and applications that a user normally has access to in a typical client/server environment. This means all network folders, e-mail systems, solutions, and other password protected accounts. Ideally, portal solutions should leverage existing security models to ensure the integrity of enterprise information.

Presentation is the element most responsible for the single point of access paradigm promised by EIP technology. There is a need then for presentation design that addresses the paramount issues surrounding EIP interfaces, those being:

Fitting all information, regardless or source, comfortably within the display space along with links to related information and applications.

Providing a familiar environment for users that minimizes, or ultimately eliminates, training time.

The key challenge is to address both the issues of integrated information display and ease of use at the same time. EIP solutions on the market today use one of several models, mostly revolving around the familiar Microsoft Windows Explorer hierarchical folder metaphor or an HTML-based “organizational” approach similar to MyYahoo! or My Netscape. Regardless of specific design model, the EIP needs to integrate all elements that a user has access to in a consistent look and feel and organize those elements in a fashion that makes sense to the user.

As with consumer portals, the personalization facility of EIP solutions is a critical ingredient in the productivity enhancement and effective individual information management, both professional and personal/collaborative. The concept of the “My!” facility allows users to customize their interface in order to manage layout, eliminate unnecessary or undesired content, and tailor information feeds in order to maximize efficiency.

Building on the idea of personalization is the idea of individual profiling that EIP solutions need to support. Individual profiling acts very much like information filtering in reverse. Individual profiling starts with a profile of user functions and interests, and then heuristically scans the information environment for new documents or other elements that might be of interest. Armed with the user's job and interest profile, the portal can then suggest new items of interest it has located in the process of scanning information sources. While suggestive computing is still in its infancy, the portal environment is a place in which it can achieve a range and scope that can make this functionality a helpful new mechanism to the knowledge worker environment.

Collaboration expands the role of the EIP from passive information kiosk to a new forum for organizational interactions. Collaboration capabilities through the EIP enable employee-to-employee interaction, and even more importantly, employee-to-customer or other business partner exchanges. By enabling this level of interactivity, EIP solutions can dramatically reduce the time required for such things as customer service and improve stakeholder relations. Within the organization, there are several levels of collaboration that EIP technology can address. Similar to the functionality of Microsoft Exchange or Lotus Notes platforms, enterprise wide collaboration is needed within the web-based EIP environment. In addition to this organizational level, collaboration at the project group level as well as the interest, or functional area (e.g. human resources) could be enabled.

Central to the concept of EIPs is the assumption that disparate applications (for such tasks as content management, and business intelligence) will access other internal and external sources of information and data, bi-directionally share that information, and use it within the portal workspace for processing and analysis. In other words, enterprise applications need to be seamlessly integrated with not only the portal environment but also with other applications as required. Ultimately, EIP solutions should enable organizations to integrate information regardless of platform or data type (structured or unstructured).

Enterprise Information Portals should not be static. That is, they should represent more to users than a web-based interface for viewing information. Rather EIPs should allow users to explore, analyze, query, and share the information presented by the interface. By seamlessly integrating with any enterprise application, EIP solutions provide users with the ability to better understand the information they use and the business environment in which they operate. Moreover, by providing interactive functionality, EIPs further enhance return on investment through process streamlining, and faster, timelier decision-making.

Valuable ideas and concepts may lay undiscovered through traditional access and search methods. Categorization provides a means to unearth and filter these concepts and ideas and organize them in a meaningful taxonomy that can be navigated by the user. The real benefit that categorization brings to the EIP is information context. Within each organization, elements such as current business practices, management initiatives, corporate history, structure and culture, available professional resources, and learning requirements build up a context for working with information. To capture and support this context consciously is one of the early perceptions of the movement toward knowledge management practice in many organizations. For the EIP to succeed, the information available on it must reflect those established patterns and familiar context.

The search element provides a centralized utility for pinpoint access to specific information items (structured, unstructured and metadata) throughout the collections available at the EIP or accessible to it. The challenge in integrating and unifying search functionality is to confront the widespread frustration and skepticism that has developed among users through their experience with inadequate search mechanisms on the Internet. As a general guideline, EIP solutions need to have the ability to generate a comprehensive taxonomy, metadata access, full text access, and concept based search capabilities built into their search functionality.

As organizations continue to diversify the types and purposes of IT systems, the number of repositories for the maintenance of metadata will 'also grow. As EIP solutions are called upon to manage enterprise applications, business intelligence solutions, document management systems, and other sources of metadata, the requirement of centrally managing and being able to access multiple repositories will be critical.

Many organizations have already seen the value that “verticalization” of the portal offers. By taking advantage of vendor-packaged applications that deliver targeted content to specific industries or lines of business, organizations can significantly reduce implementation times. Typically, a good deal of time and resources are spent customizing the software components of EIP solutions. Sound EIP solutions offer the ability to “snap-in” specialized functionality and begin realizing rapid ROI, rather than spending time tailoring the portal to meet industry or departmental specific needs.

A need therefore exists for a fully customizable Web-based workspace that enables access to business-critical applications and information, including structured and unstructured data, for maximum competitive advantage. This EIP should be an enterprise-scalable, application- and platform-independent solution that features a plug-in architecture to seamlessly integrate any enterprise application to the EIP environment, allowing users to act on the information they receive. In general, the need exists for an enterprise information portal that provides organizations with a straightforward, secure, and efficient way of consolidating information access and centralization of enterprise solutions in a web-based environment. Such an enterprise information portal should support the advanced business transformation needed to enable organizations to leverage and harness their knowledge and intellectual assets in superior ways. In doing so, such an EIP solution should allow organizations drive their business forward and help them emerge as leaders in the new e-economy.

### SUMMARY

In accordance with this invention there is provided an Enterprise Information Portal (EIP) for access by a user via a browser on a network, said portal comprising: (a) an interface for communicating between said portal and said user; (b) a theme manager for selecting a theme, said theme defining a presentation format for said browser; and (c) a plug-in manager for controlling a plurality of plug-ins, said plug-ins for retrieving and formatting information content for said user, wherein said plug-in retrieves information form both local and remote sources.

### BRIEF DESCRIPTION OF THE DRAWINGS

The invention may best be understood by referring to the following description and accompanying drawings which illustrate the invention. In the drawings:

FIG. 1 is a block diagram of an enterprise information portal (EIP) according to the present invention;

FIG. 2 is a screen capture illustrating an output produced by several e-clips inserted into a basic HTML page;

FIG. 3 is a block diagram illustrating how the e-clips fit into the functional architecture of a portal server;

FIG. 4 is a block diagram illustrating an e-clip structure;

FIG. 5 is an event trace diagram for the e-clip illustrated in FIG. 4;

FIG. 6 is a block diagram illustrating a portal server in its typical mode of operation where a resident Java based e-clip is executed;

FIG. 7A is a block diagram illustrating an e-clip structure having a distributed component residing on a different network node;

FIG. 7B is a block diagram illustrating a portal server executing an e-clip via an HTTP connection;

FIG. 8 is a block diagram illustrating an alternate e-clip structure;

FIG. 9 is a block diagram illustrating the differences between internal and external component access;

FIG. 10 is a block diagram illustrating how the theme manager fits into the functional architecture of the portal server;

FIG. 11 is a block diagram illustrating a sample theme structure;

FIG. 12 is a block diagram illustrating the general structure of a theme;

FIG. 13 illustrates a sample class structure of the theme manager;

FIG. 14 illustrates the general operation of the session manager;

FIG. 15 is a block diagram illustrating the overall structure of a navigation bar environment;

FIG. 16 is a block diagram illustrating the general architecture for a navigation bar e-clip;

FIG. 17 is a block diagram illustrating a navigation bar component of FIG. 16 in greater detail;

FIG. 18 is an event trace diagram for gathering data by the navigation bar component;

FIG. 19 illustrates the method steps for populating an EIP system's navigation bar with items from an integrated application;

FIG. 20 illustrates the method steps for searching an application using the EIP system.

### DETAILED DESCRIPTION OF THE PREFERRED EMBODIMENTS

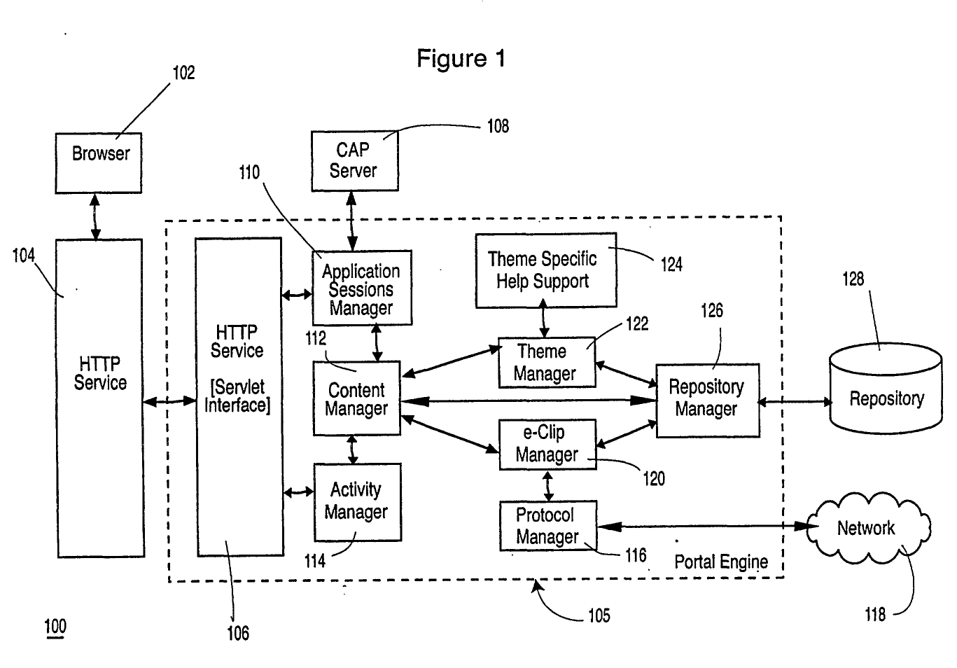

For convenience, like numerals in the description refer to like elements in the drawings. Referring to FIG. 1, a block diagram of an enterprise information portal (EIP) in accordance with an embodiment of the present invention is illustrated generally by numeral 100. A user (not shown) accesses a portal server 105 via a hypertext transfer protocol (HTTP) service interface 104. The portal server 105 comprises an HTTP service servlet interface 106, which is coupled to an application session manager 110, a content manager 112, and an activity manager 114. The application session manager 110 is coupled with the content manager 112, which is coupled with the activity manager 114. The content manager 112 is further coupled to a theme manager 122 and an e-clip manager 120. The theme manager is further coupled to a theme specific help support 124 and a repository manager 126, which is in turn coupled to a repository 128. The e-clip manager 120 is coupled to the repository manager 126 as well as to a protocol manager 116. The protocol manager 116 is coupled to a network 118 such as the Internet. The application session manager 110 is farther coupled to a common authentication protocol (CAP) server 108. The CAP server 108, the repository 128, and the network 118 are external to the portal server 105.

The browser 102 is typically a hypertext mark up language (EML) viewer and acts as a main interface between the user and the portal server 105. The portal server 105 is designed to support as many simultaneous user connections as possible. Examples of browsers include Netscape's Navigator™, Microsoft's Internet Explorer™, Phone.com's UP.Browser™, and the like. The browser 102 and the HTTP service interface 104 are standard in the art and need not be discussed in greater detail.

The portal server 105 is responsible for displaying HTML pages that are either static or dynamic in nature. In the latter case, the portal server 105 generates displays by issuing requests to one or more e-clip components and collecting the resulting HTML produced for creating an output page.

The HTTP services servlet interface 106 is responsible for managing HTTP requests from several different sources. Requests can originate as a result of a user page request, or from another portal server requesting access to a given, shared component or e-clip residing on the portal server 105. The HTTP services servlet interface 106 is designed as a servlet that sits on top of an HTTP server, such as a web server or application server.

The application session manager 110 controls access to external applications registered to the portal server 105. It is not only responsible for managing individual user sessions, but also maintains a global session with each application. The latter is used to support a bidirectional heartbeat for insuring that both the application and the portal 105 are still alive.

The CAP server 108 is able to log individual users into the portal server 105 and manage security tickets produced by a centralized log-in system. This system is responsible for controlling access to shared pages, e-clips, and components. The CAP server is described in more detail in the applicant PCT applicator filed concurrently herewith and incorporated herein by reference.

The content manager 112 is primarily responsible for generating portal pages for user viewing. The content manager 112 works closely with the theme manager and the e-clip manager 120 for generating proper displays based on user preferences and page content.

The theme manager 122 manages themes specific information for providing “look and feel” information for the portal server 105. The theme manager 122 controls which themes are loaded and provides programmatic access to the properties of a theme. The theme dictates how the retrieved information is displayed to the user. The theme specific helps support 124 provides help in accordance with the selected theme. Theme-specific help 124 allows for different html, images, etc., for on-line help depending upon what theme the user is currently in, operating in th esame manner as themes in general. Therefore, if a user changes their UI in certain locations in EIP, only help 124 that applies to that changed UI is changed. In other words, help 124 has the same kind of hierarchical fallback as themes 122 in general.

The e-clip manager 120 controls the execution of all components and e-clips supported by the portal 105. These objects can be invoked by the content manager 112 when rendering pages or may be manipulated as a result of an external request from another portal server 105.

The repository manager 126 manages all data associated with the portal server 105. It manages user page and preference information, as well as all e-clips and components required for constructing and rendering pages. The repository 128 is the memory where the data is stored. The repository 128 may include a database, a file system, or the like. A portal administrator registers applications with the portal repository 128. A user interface allows the administrator to modify appropriate settings for the application.

The activity manager 114 is responsible for monitoring portal user activity for the purpose of building up portal statistics. This information includes user click activity, page creation details, and the like. The information is used for assisting other users attempting similar activities.

The components of the overall architecture described above are described in detail in the following sections. The description will provide firer details to the architecture and function of each of the individual components, and in some cases how they interact with each other.

The HTTP services servlet interface 106 is be identified as “hcleip” and is accessed as a URL using the following format:

http://<server>/servlet/hcleip?[portal parameters]

All classes relating specifically to the portal server shall be defined within a package-naming format as illustrated in Table 1 below.

TABLE 1

| | |
|---|---|
| com.hcl.portal.server | This package contains all |
| | classes directly related |
| | to setting up and |
| | maintaining the portal |
| | server. This includes code |
| | for the EIP servlet. |
| com.hcl.portal.manager.plugin | This package manages the |
| | e-clip architecture |
| | including support for |
| | component sharing. |
| com.hcl.portal.manager.content | This package manages |
| | content provision for |
| | the portal. This group |
| | of classes supports page |
| | rendering and page loading |
| com.hcl.portal.manager.theme | This package contains all |
| | classess relating to |
| | management of portal themes. |
| com.hcl.portal.manager.appsession | This package supports all |
| | application session |
| | management for the portal |
| com.hcl.portal.component | This package is the conven- |
| | tional location for user- |
| | written components and those |
| | that are not part of the |
| | portal kernel. |
| com.hcl.portal.utility | This package contains all |
| | of the utility classes for |
| | the portal product, including |
| | replacer and string |
| | management support. |

A “replacer” performs the task of replacing a given metatag buried in an HTML output stream with a specific block of replacement text. The replacer is typically a Java class that can be added as a filter to the stream of HTML being written back to the browser. When the replacer intercepts a metatag, it replaces that tag with a dynamic block of HTML code. For example, a replacer for the $title_text$ tag is added to the output stream for the replacement text, “<H1>This is the title</H1>”.

The following source:

<HTML>
<HEAD><TITLE>Replace sample</TITLE></HEAD>
<BODY>
<P> The title of this document is:</P>
$title_text$
</BODY>
</HTML>

Would appear as:

<HTML>
<HEAD><TITLE>Replace sample</TITLE></HEAD>
<BODY>
<P> The title of this document is:</P>
<Hl>This is the title</H1>
</BODY>
</HTML>

Replacers can be registered with the portal server 105 at any time. Until the replacers are unregistered, they will replace their assigned metatags transparently in the output stream.

The following section details the Application Program Interface (API) for accessing URL interfaces within the portal server 105. All servers that provide access to these objects should implement the HTTP interfaces to execute e-Clips and components.

As discussed above, the portal servlet code provides support for replacers. Since the replacer interface is not part of the HTTP server itself, page content containing replacers must be loaded through the servlet code. Most application servers load HTML and other content using commands in the form:

http://server/page.html

However, if there are any replacers in the loaded file, they will be ignored by the server's page loader. Furthermore, the portal server 105 will load user pages from a repository (to ease scalability in future releases). Therefore, pages cannot be loaded by specifying a simply URL.

To solve these problems, the HTTP services servlet interface 106 provides a special interface to perform the same page loading tasks from the page repository, and will process any replacers and e-clips as the pages are streamed to the browser. The URL used to accomplish this is of the form:

http://server/servlet/hcleip.cmd=page&object=page.html&user=<portal_username>

This URL format will work correctly even for pages without replacer tags. The “portal_username” element is used to indicate which user page repository this page originates in. Note that the portal server 105 itself is considered a special user “hcleip”, which is the repository structure where the pages used to generate the default portal user interface reside.

Further, the HTTP services servlet interface 106 supports loading user, sector and theme pages [via the URL interface]. To load a user page, the command is of the following format:

http://server/servlet/hcleip?cmd=page&object:=page.html&user=user.name

Note that requests for user pages are validated to ensure that the user has access to the page. To load a sector page the command is of the following format:

http.//server/servlet/hcleip?cmd=page&object=page.html&sctr=sectormame

Note that each request for a sector page is validated to ensure that the user making the request has “read” access to the page. To load a theme page, no access validation is performed. The format is as follows:

http.//server/servlet/hcleip?cmd=page&object=page.html&theme=themename

Note that to improve portability of theme pages between themes, a theme name replacer tag ($ThemeName$) can be specified instead of a hard-coded “Themename” value.

Themes usually require special images to produce the desired presentation. Like all other data for the portal, these images are stored in the repository, and are accessed through the [portal URL API] HTTP services servlet interface. The URL format for loading an image is as follows:

http://server/servlet/hcleip?cmd=iamge&object=image.gif&theme=themename

The portal uses a MIME.PROPERTIES file to determine the MIME type of the image. The portal server 105 supports image formats such as GIF, JPEG, and the like.

Once again, the portability of theme pages between themes can be improved by inserting a theme name replacer tag ($ThemeName$) instead of a hard-coded “themename” value.

A portal document is considered to be a user page plus a title and is targeted at the reserved frame name “EIPDocumentFrame”. This frame includes a frameset consisting of a title bar and a page display frame. This functionality is typically used from a navigation bar. The navigation bar is a particular implementation of an e-clip, and is described in detail further on. The format is as follows:

http://<server>/servlet/hcleip?cmd=doc&object=page.html&title=My+Title&user=Anonymous or,

http//<server>/servlet/hcleip?cmd=doc&object=page.html&title=My+Title&sctr=sectorname

To access a component or e-Clip from an external source, the basic URL format is as follows:

http://<server>/servlet/hcleip?cmd=exec&type=<obj type>&object=<obj name>&request=<request>

where,

| | |
|---|---|
| <server> | Identifies the server name or IP on which |
| | this object will be executed |
| <obj type> | Determines if this object is a |
| | “component” or a “e-clip” |
| <obj name> | Identifies the unique name of this object |
| <request> | Contains the data associated with this object request |

Within a user repository folder, each user is given a space into which their “personality” is stored. This information includes information such things as a profile (user.properties), a keychain (an encrypted file with account information), a personal table of contents (TOC), and any user pages that they own.

The user.properties file is a text file that stores most of the personalization for each user and is normally editable directly only by an administrator. The following an example of a typical profile:

FullName=Steve Gutz

NavbarOrder=Everyone,GuySmut,User,Administrator,Public,Steve.Gutz

DefaultTheme=Default

HomePageType=Sector

HomePageTypeName=Everyone

HomePage=defaultPortal.html

Applications=*

DisableSessionTimeout=true

Each of the valid fields for the user.properties file are described in Table 2.

TABLE 2

| Field | Description |
|---|---|
| FullName | This field normally contains the full name |
| | of the user, but since it is editable from |
| | the user profile editor within the portal, |
| | it may contain any value. During normal |
| | operation, this field is ignored by the |
| | portal, but it's value is accessible either |
| | through the $SessionFullName$ replacer or |
| | through code from a plugin. |
| NavbarOrder | This field stores the user's preferred tree |
| | order. This represents the order in which |
| | sector contents are drawn within the user's |
| | navbar tree. It is controlled by the |
| | ordering mechanism in the user profile editor. |
| DefaultTheme | This value contains the user's preferred theme. |
| HomePage | This field stores the filename of the user's |
| | preferred start page in the portal. This is |
| | the page the user gets when he connects. |
| HomePageType | This field stores the type of repository folder |
| | in which the user's start page is stored. Valid |
| | values are “user”, “sector”, or “theme” |
| HomePageTypeName | This field stores the name of the repository |
| | folder in which the user's start page resides. |
| | Typically this would be the name of the user's |
| | own folder. |
| Applications | The use of this field is currently undocumented |
| DisableSessionTimeout | This field accepts a “true” or “false” value |
| | and is used to control how the portal session |
| | timeout code reacts to this user. If the value is |
| | true, the user's session will never timeout. |

The following section defines the e-clip architecture for the preferred embodiment.

The e-clip architecture constitutes part of the portal server 105. The e-clip architecture is designed such that new applications and web-based information can easily be integrated into the portal server. The e-clip architecture further attempts to shelter developers from the underlying portal technology by providing simple interfaces to all of its capabilities.

Preferably, e-clips, which are also referred to as plug-ins, are designed such that individual components communicate using standard protocols. Therefore, data transferred between portal and external applications will preferably be described using extensible markup language (XML) and HTML. If required, network transfer of data is accomplished using HTTP.

The e-clip architecture is designed such that it excels readily to meet requirements of large user populations. Data sources are easily and transparently accessed across local Intranets, as well as the Internet and Wide Area Networks. The e-clips, and their integral parts, can be distributed and shared among multiple portal servers.

It is preferable that the core portal server code is written in pure Java and, therefore, is platform neutral by nature. E-clips are typically written in platform portable Java. However, as a result of an HTTP based communication protocol as will be described in this section, e-clips can be written in any computer language. Furthermore, in the preferred embodiment, an e-clip does not return simple binary data. All data returned from the e-clip is HTML compliant.

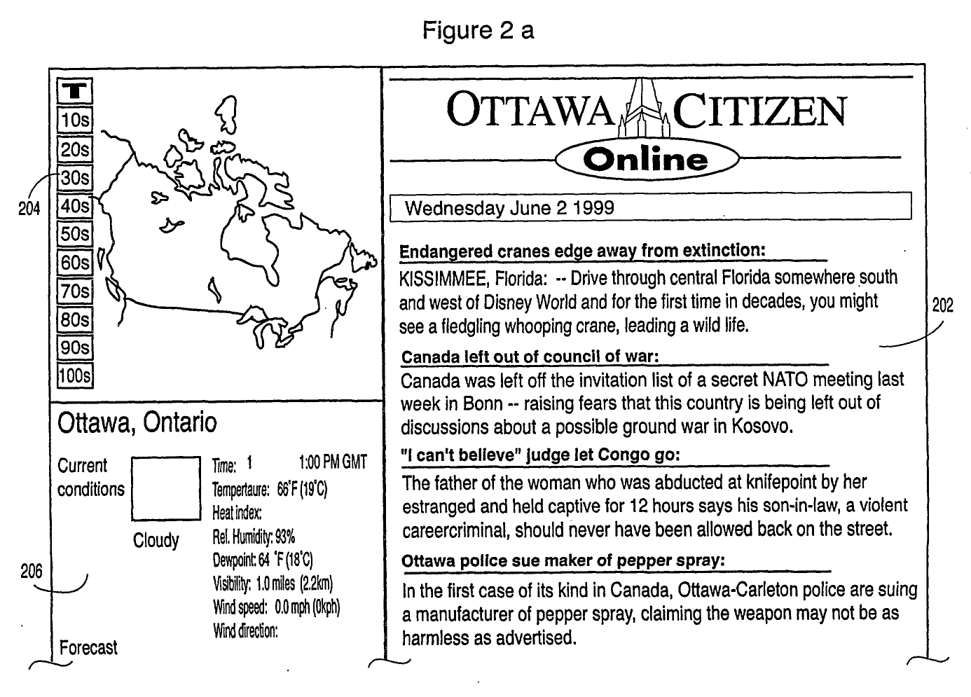

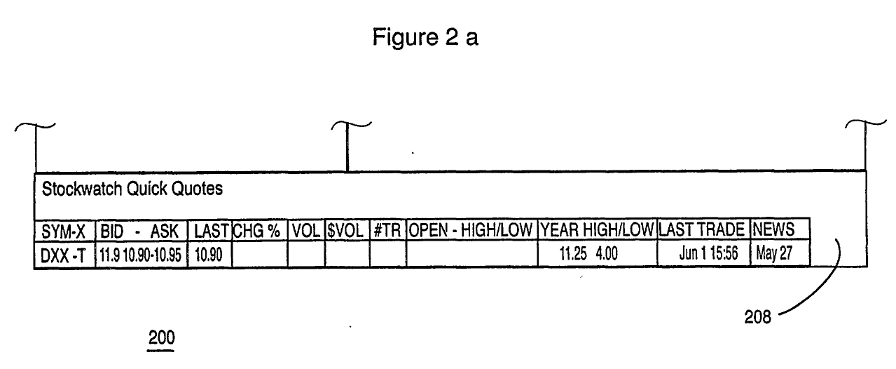

An e-clip is a collection of components responsible for accepting a request from the portal server and processing this request for producing the desired output. Output can be in the form of HTML for a visible e-clip, or some other custom form as required by the portal server. External communication to e-clips is performed through an HTTP/URL interface. Referring to FIG. 2, sample output produced by several e-clips inserted into a basic HTML page is illustrated generally by numeral 200. The page 200 is comprised of several sections each having information provided by a specific e-clip and merged into a single page. A first section 202 includes headlines from a local newspaper, a second section 204 includes a national weather forecast, a third section 206 includes a local weather forecast, and a fourth section 208 includes a current stock quotation. Note that the portal server is designed to generate e-clip results in both HTML table/cell format as well as within a separate HTML frame.

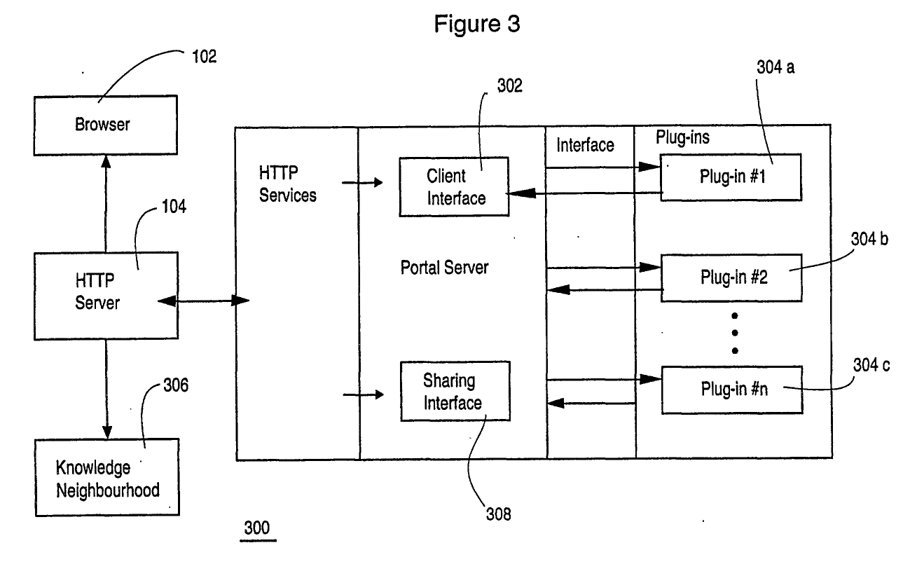

Referring to FIG. 3, a block diagram illustrating how the e-clips fit into the functional architecture of the portal server is shown generally by numeral 300. As previously described, a user requests a web page via the web browser 102. The web browser 102 retrieves the web page via HTTP server 104 and HTTP services servlet interface 106 on the portal server. The request is transferred to a client interface 302 for processing the client request. In accordance with a theme determined by the theme manager (not shown) the client interface accesses e-clips 304a to 304c as required. The details of the theme manager 122 will be discussed later. The e-clips 304a to 304c return the desired information to the client interface 302, which consolidates the information to a single web page and returns the web page to the user.

Alternately, the request for the e-clips may come from another portal server in a knowledge neighbourhood, since e-clips can be shared across portal servers. The other portal server 306 requests the information via the HTTP server 104, which is in communication with the portal server via HTTP services servlet interface 106. The portal server processes the request via a sharing interface 308, which accesses the e-clips 304a to 304c in a similar fashion to the client interface 302.

From the perspective of the e-clip architecture, the portal server interacts with an e-clip using a single point of entry and a single point of return. Typically, an e-clip will not be required to accept information from more than one data source. Several exceptions are possible, one of which is the possibility for an e-clip to merge a portal request with a request from a different source into a single output stream.

The portal server is a Java servlet that is instantiated by a simple application server and resides in a user workstation or corporate server. The portal server is responsible for managing user requests and determining which e-clip is required to service that request. The e-clip manager within the portal controls interactions between specific constituent components and is responsible for transferring information between them. The sharing interface 308 manages requests from other user portals and servers on the network and proxies these requests using internal e-clips.

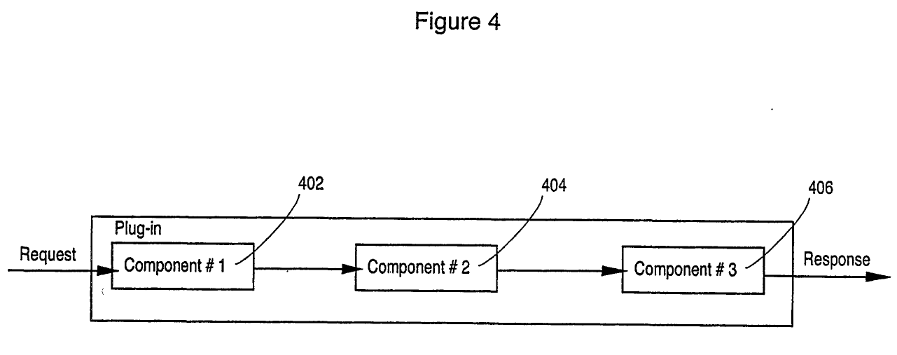

All e-clips managed by the portal server consist of at least one component and are responsible for accepting a client request and producing output in a format digestible by the requesting client. Referring to FIG. 4, a sample e-clip structure is illustrated generally by numeral 400. In this particular example, a request is received from a client and input to a first component 402. Output from the first component 402 is input to a second component 404. Output from the second component 404 is input to a third component 406. Output from the third component 406 is sent back to the client as a response.

In this particular example, the components are organized in a daisy chain structure. The output produced by one component is fed directly into the request input for the next component in the chain. The first component 402 in the chain is typically responsible for querying the data source, while the last component 406 in the chain is typically responsible for ensuring the response is in a format acceptable to the client. Generally, this format is HTML.

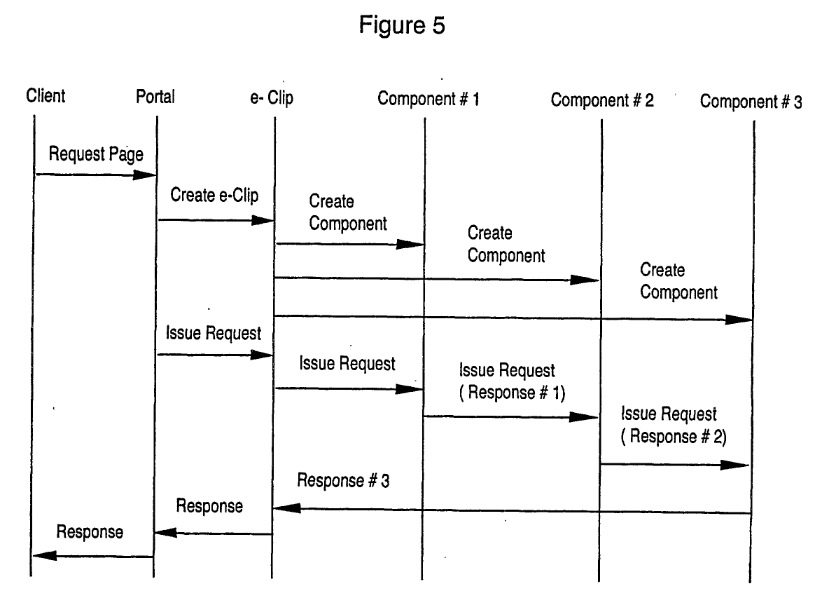

Referring to FIG. 5, an event trace diagram for the e-clip architecture illustrated in FIG. 4 is shown generally by numeral 500. The client sends a page request to the portal server, which causes the portal to create an e-clip and issue a request to that e-clip. When the e-clip is created, the three components are created. However, the request issued by the portal is chained through each of the components in accordance with the architecture illustrated in FIG. 4. Therefore, once the e-clip receives the issue request from the portal, it sends the issue request to the first component 402. The first component 402 sends an issue request to the second component 404, which in turn sends an issue request to the third component 406. The third component 406 returns its response to the e-clip, which returns its response to the portal. The portal then responds to the client.

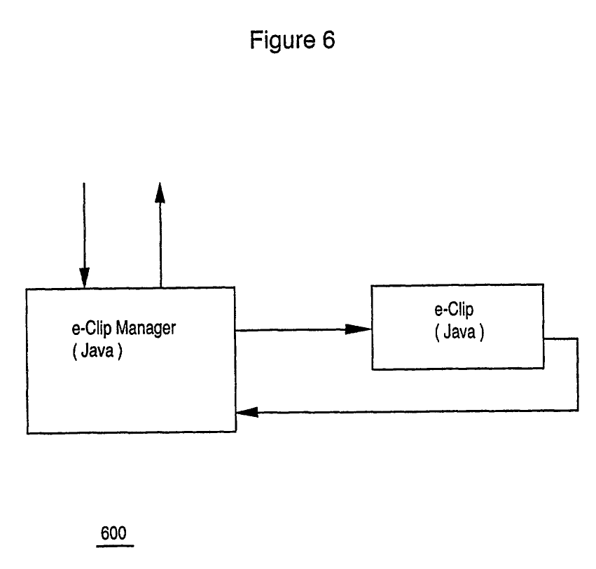

The c-clip illustrated in FIG. 4 is the simplest form, where the e-clip and all of its constituent components are Java code and they reside on the same virtual machine. Referring to FIG. 6, a portal server in its typical mode of operation, where a resident Java based e-clip is executed to produce output is illustrated generally by numeral 600. Internal e-clips offer the best performance because the e-clip object lives in the same virtual machine as the portal server.

However, e-clips can also be accessed from other portal servers in the knowledge neighbourhood. In this case, the e-clip is language neutral and is accessed across a network through a URL interface. The system on which the e-clip resides is therefore required to implement at least a rudimentary HTTP server for supporting the URL API, described later in this section.

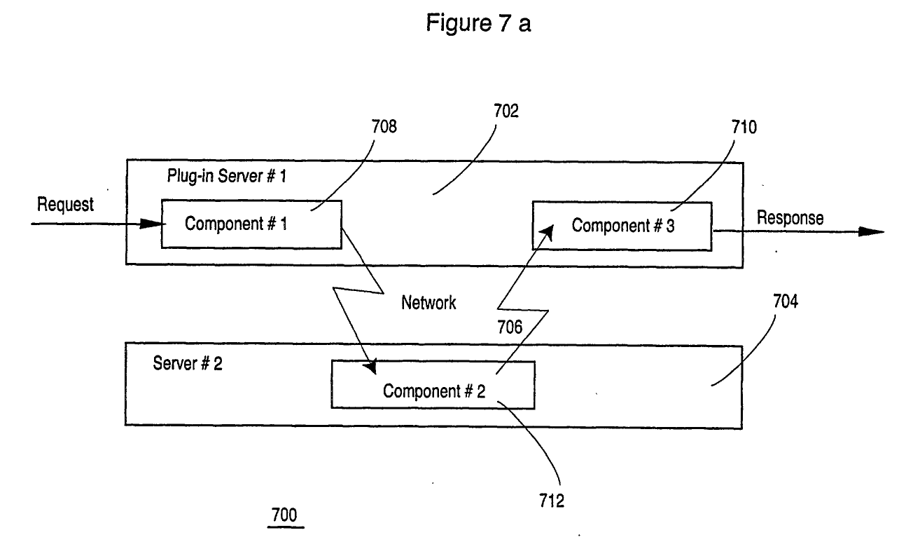

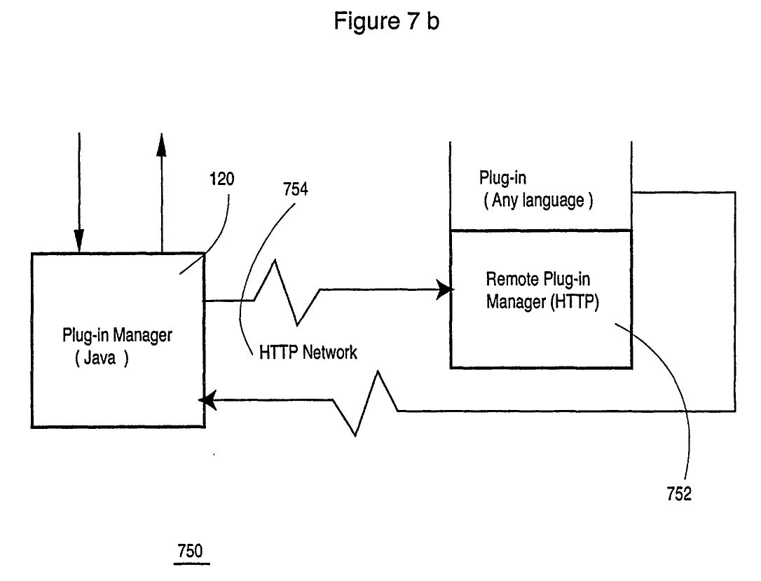

Referring to FIG. 7A, a structure of an e-clip having a distributed component residing on a different network node is shown generally by numeral 700. A first server 702 and a second server 704 are coupled by a network 706. A first component 708 and a third component 710 reside on the first server 702 and a second component 712 resides on the second server 704. In an arrangement similar to the architecture illustrated in FIG. 4, the components are daisy chained together for producing a response to the client request. However, in the present example, the components are located on separate servers.

Referring to FIG. 7B, a portal server executing an e-clip via an HTTP connection is represented generally by numeral 750. The e-clip manager 120 accesses a remote e-clip manager 752 via an HTTP network 754, such as the Internet. The remote e-clip manager accesses a local e-clip 754 and returns the result to the e-clip manager 120 via the HTTP network 754. This provides the ability to distribute processing requirements across multiple servers, allowing for infinite scaling.

In yet an alternate structure, an e-clip response can involve more than a single sequential process. It is possible produce more complex e-clips that merge parallel requests into a single result, or which have internal components generate secondary requests and merge the results into the response.

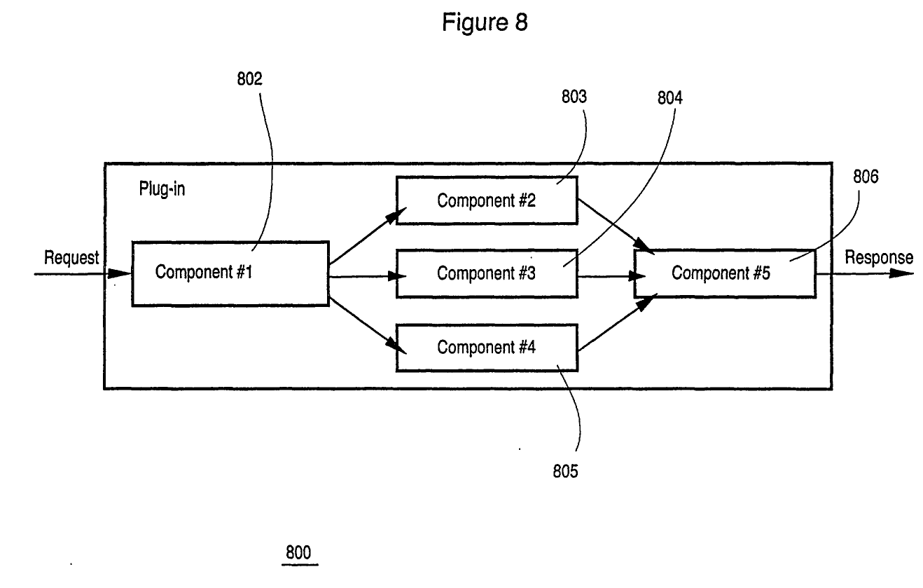

Referring to FIG. 8, an alternate e-clip structure is illustrated generally by numeral 800. A first component 802 receives a request and transmits its response to a second component 803, a third component 804, and a fourth component 805. Each of the components 803-805 receive the request from the first component 802 and process it in parallel. Output from the second component 803, the third component 804, and the fourth component 805 is merged into a single stream, the result of which is the input to a fifth component 806. Output from the fifth component 806 is the e-clip response. The e-clip manager permits components 803 to 805 to operate either synchronously (sequentially) or asynchronously (in parallel threads). In the latter case, the fifth component 806 waits until all component threads have been completed before continuing.

An e-clip is simply a package of constituent components that manages a request and produces a response on behalf of a client. An e-clip is not a piece of purpose-specific code. Rather, an e-clip is described by a text file that is read by the e-clip manager. The following text describes an e-clip structure, similar to that illustrated in FIG. 4, containing three components. The first component handles page requests from the web, the second parses specific information out of the page, and the third component formats the result into an XML packet.

# Define the component chain to handle a retrieval from the web

# parse it and produce an XML output packet

com.hcl.portal.WwwComponent

com.hcl.portal.components.PageParserComponent

http://servet/servlet/hcpeip?cmd=exec&type=component&object=HTML2XMLComponent

Note that the portal server transparently handles requests to and from components located external to the portal server. Therefore, in the e-Clip descriptor file shown above, the line:

http://server/servlet/hcleip?cmd=exec&type=component&object=componentHTML2XML

describes a constituent component residing remotely on a component vendor. The remote component vendor is essential just another portal server. The e-clip manager automatically routes the request via an HTTP POST and retrieves the response from the remote server. Because components can be distributed to external computers, portal e-clips can become technically complex.

The e-clip is responsible for maintaining the current request and response data for all of its constituent components. As such it requires a number of attributes to manage data flow, as shown in Table 3.

TABLE 3

| Attribute | Description |
|---|---|
| Name | A character string uniquely identifying this |
| | e-clip. For example “eclipDF” could be |
| | the name given to the e-clip that accesses a |
| | DOCS/Fulcrum knowledge server. |
| Request | This field contains the current request |
| | information routed to the e-clip by the |
| | portal server. |
| Response | Once the e-clip has performed its duties, |
| | this field will contain the resultant data |
| | produced by the e-clip. |
| ComponentVector | This attribute maintains a list of constituent |
| | component instances that are contained |
| | within the e-clip. |

The components within an e-clip are normally processed in the order in which now appear in the e-clip script. However, this scenario is not ideal for all situations. For example, if several components generate independent results involving different network operations, it will be advantageous to execute these components in parallel to improve overall e-Clip performance. The following e-Clip example shows three components that are executed in parallel on separate threads of execution.

# Define an asynchronous component chain cache=session

com.hcl.portal.WwwComponent

*com.hcl.portal.components.PageParserComponent1

*com.hcl.portal.components.PageParserComponent2

*com.hcl.portal.cornponents.PageParserComponent3

com.hcl.portal.components.PageMergerComponent

Note in the example the addition of a leading “*” character on entries that can be executed asynchronously. The e-clip manager interprets these special characters and automatically executes the components on separate threads of execution. The component immediately following the asynchronous lines shall be blocked until all previous threads have completed.

Often a component will need to obtain the results of a previously executed component. The e-clip manager provides access to these components through a standard API in code. However, access is provided from within an e-clip script. For example:

# Define an asynchronous component chain cache=session

com.hcl.portal.WwwComponent

com.hcl.portal.components.Component1

com.hcl.portal.components.Component2

com.hcl.portal.components.Component3 $com.hcl.portal.components.Component1

com.hcl.portal.components.Component4

In this example, Component3 takes its initial input request from the output generated by Component1. The “$” followed by a fully qualified component name will automatically obtain the request information from the named source.

The HTTP services servlet interface supports many different types of clients. For example, in addition to web browsers, XML formatted output could be used to integrate directly into MS-Office or other common application. Therefore, the e-clips are accessible through standard URL requests as well as internal XML/HTML requests. This section details the interfaces for both request mechanisms.

The URL format for requesting an e-clip from the portal server is as follows:

HTTP://server/servlet/hcleip?cmd=exec&type=eclip&object=myEclip&request=Myrequest

The details of the URL format are described in Table 4.

TABLE 4

| | |
|---|---|
| Cmd=exec | States that this is a URL to execute an |
| | e-Clip or component |
| Type=eclip | Defines this as a request for a specific |
| | e-Clip residing on this server. |
| Object | Is the full unique name of the e-Clip |
| Title | Contains a title string that will be |
| | displayed in the title bar of this e-clip. |
| Border | Contains a true or false value to indicate |
| | if this e-Clip will be drawn with a border. |
| | If its, the portal will encase the e-Clip |
| | output within a border. |
| Request | Contains the request parameters for the e-Clip. |
| | This request must adhere to whatever the format |
| | the e-Clip demands. The portal server will not |
| | tamper with any data in this field |
| Id | Contains a string that uniquely identifies this |
| | instance of the e-Clip. This identifier is |
| | meaningful only if the e-Clip is cached either |
| | globally or in session and is used by the e-Clip |
| | manager to locate instances of e-Clips within the cache. |

The portal server supports both HTTP GET and POST type requests. E-clip requests containing large amounts (>1024 bytes) of information typically use a POST request.

The portal server also accepts requests in XML formatted packets and will automatically extract e-clip request information and replace it with the e-clip's response. The following listing is an XML packet that supplies a request to a specific e-clip:

<html>
<head></head>
<body>
<ECLIP name=“WwwEClip” id=”helloWorld” title=”My Title”>

http://server/hello.html

</ECLIP>
</body>
</html>

Executing this XML-based request produces:

<html>
<head></head>
<body>
<P>Hello World</P>
</body>
</html>

The following are a set of rules for the present embodiment. These rules are particularly useful for HTML based systems. However, for other language-based systems, various modifications to the rules will be apparent to a person skilled in the art.

1. e-clips must always produce complete HTML fragments.

2. e-clip must never include header tags such as <html>, <head>, body>, etc.

3. It is understood that an e-clip's output may be placed within an HTML table cell or within an HTML frame without corrupting the display.

4. e-clips must be capable of residing on the same user page as other e-Clips without causing display corruption.

As previously mentioned, an e-clip is a container for components and is responsible only for routing requests and responses between them. A component contains a minimum set of information required by the e-clip manager, but may contain additional information to support the specific functionality within the component. Table 5 details the e-clip specific attributes of a component.

TABLE 5

| Attribute | Description |
|---|---|
| Name | An identifier uniquely identifying this component. |
| | For example “WwwComponent” would be the name |
| | to the component that accesses the web to load |
| | an HTML page. |
| Server | If the component is remote to the portal server, |
| | this field will contain the URL required to access |
| | the component in its remote location. |
| Request | This field contains the current request information. |
| response | Once the component has performed its duties, this |
| | field will contain the resultant data produced by |
| | the component. |

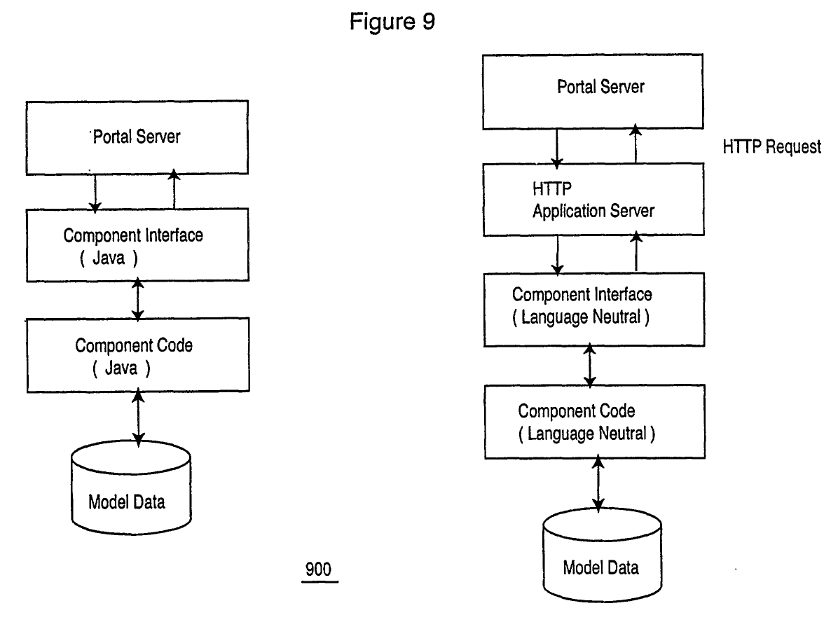

A component is coupled to an e-clip either tightly (by providing an internal Java class) or loosely (by providing a URL path to the component code). In the latter case, the component can reside anywhere on the network including the local workstation. However, for performance reasons, any local component written in Java should avoid network interaction and expose an internal interface for access. Local components written in languages other than Java must implement their own external HTTP interface. Referring to FIG. 9, the differences between internal and external component access is illustrated generally by numeral 900.

The HTTP service servlet interface supports requests from external sources for component access. That is, the portal is a component vendor and must be able to service other portals requesting access to specific shared components. Preferably, all access to components from external server portals is done via an HTTP request by specifying a URL. The URL format to request a component from the portal engine is as follows:

HTTP://server/servlet/hcleip?cmd=exec&type=component&object=myComp&request=MyRequest

The details of the URL format are described in Table 6.

TABLE 6

| | |
|---|---|
| cmd=exec | States that this is a URL to execute an e-clip |
| | or component |
| type=component | Defines this as a request for a specific component |
| | available on this portal server |
| Request | Contains the request parameters for the component. |
| | Note that this request must adhere to whatever the |
| | format the component demands. The portal engine will |
| | not tamper with any data in this field. |
| object | Is the full name of the component (for a Java-based |
| | component, this includes the full package designation |
| | for the class) |

The portal engine supports both HTTP GET and POST type requests. Part requests containing large amounts of request information typically use a POST request.

For testing purposes, a complete test suite is provided for exercising each e-clip. These tests are validated on each platform supported by the portal server. Each individual component is tested separately on each applicable platform before fall integration testing is done within an e-clip.

Some platforms support several different Java virtual machines (for example, Microsoft Windows™). On such platforms, e-clips and component objects should be verified with as many virtual machines as possible. For Windows™, tests should be run for virtual machines from Sun, Microsoft and IBM as a minimum.

Each distributed e-clip and component should be tested independently of an entire system. Since each e-clip and component provide a single point of entry and return, a simple test harness can be designed to verify the operation of these classes.

As previously described, an e-clip is simply a list of components and optional request parameters that perform a specific task. An e-clip accepts an initial request and produces output defined by the last member of its component chain, which is typically an HTML formatter. E-clips are defined as scripts and are contained in standard text files with the following naming convention:

<eClipName>

where eClipName matches the unique name of the e-clip and there is no file extension. As sample e-clip script containing a two component chain is as follows:

<ECLIP>

<DESCRIPTION>

Define the component chain to handle a
retrieval of the front page
for the Ottawa Citizen

</DESCRIPTION>
<PARAMETERS>

cache=session

</PARAMETERS>
<COMPONENTS>

com.hcl.portal.component.WwwComponent
http://www.citizen.com/frontpage.html
ottawaCitizenComponent

</COMPONENT>

</ECLIP>

The first component line declares a component com.hcl.portal.component.WwwComponent that takes a URL and retrieves an HTML page from that location. The e-clip then passes this text to the “ottawaCitizenComponent”, which extract items of particular importance. The results of this component, being the last in the chain, are returned to the e-clip and ultimately back to the portal server for display.

Components can be accessed from a remote portal server or vendor. In these situations, the remote component us accessed using the URL API. The following script shows an example of this:

<ECLIP>

<DESCRIPTION>

Define the component chain to handle a
retrieval of the front page
for the Ottawa Citizen

</DESCRIPTION>
<PARAMETERS>

cache=session

</PARAMETERS>
<COMPONENTS>

com.hcl.portal.component.WwwComponent
http://www.citizen.com/frontpage.html
http://anotherportal?cmd=exec&type=
component&object=ottawaCitizenComponent

</COMPONENT>

</ECLIP>

The e-Clip manager automatically routes the component request to the remote object and retrieves that object's results.

For performance reasons, the results produced by an e-clip are cacheable with either a global scope, wherein the results are available to all users, or with a session scope, wherein the results are available only to the current user. Caching should be used only when a given request generates the same output for an e-clip each time it is executed. e-clips that manipulate session-based servers (such as Docs/Fulcrum) should either not use cached e-clips or should use them cautiously. Conversely, e-clips associated with stateless data such as web pages should use caching to improve client performance and reduce network traffic. By default, e-clips are not cached. To locate cached e-clip instances, the e-clip manager keys on the e-clip name, the optional unique identifier and, in the case of non-static cached e-Clips, the last request it executed.

Caching is controlled by inserting a configuration parameter into the c-clip script.

The format is as follows:

cache=<cache scope>

Where <cache scope> is one of the variable described in Table 7.

TABLE 7

| | |
|---|---|
| Global | The cached results are preserved in the global space |
| | of the portal server and are available to all user |
| | pages making the same request for the e-Clip. This |
| | scope should be used only for information |
| | which is not sensitive (i.e. public knowledge) |
| Session | The cached results stored within the user's are |
| | available only to this one user. This scope should |
| | be used for e-Clips that generate repetitious |
| | information that might be sensitive to a given user. |
| Transient | This default scope indicates that each time the |
| | e-Clip is executed, it's results are regenerated |
| | (no caching is performed) |

In addition to the cache scope, an e-clip script also permits the specification of a refresh time for the cache. This is used to determine if the data for a cached e-Clip needs to be reacquired. The format of the refresh parameters is:

refresh=<refresh time>

where <refresh time> is a combined numerical value and weight character. The weighting for the number is determined using Table 8.

TABLE 8

| | |
|---|---|
| s | The refresh time is specified in seconds. This is |
| | the default and omitting the weighting character |
| | completely will resolve refresh in seconds as well. |
| m | The refresh time is specified in minutes |
| h | The refresh time is specified in hours. |
| d | The refresh time is specified in days |
| w | The refresh time is specified in weeks |

Therefore, for example, if the refresh is set as refresh=3d, the e-clip cache is discarded every three days. If the refresh line is omitted or the specified value is “0”, the cached item will never refresh. However, e-clips cached against the session will refresh the next time the user connects the browser to the portal server.

Caching does not solve simple data persistence problems within an e-clip. Since the c-clip manager does not pass requests to previously cached components, an extension is defined to control data persistence. To enable e-clip persistence for cached objects, a modifier is added to the “cache” statement in the in e-clip description. The form of this statement is as follows:

cache=<cache scope>,static

The addition of the “static” modifier prompts the e-Clip manager to react differently than it does for normal e-Clip caching. In this case a request is passed into the e-clip as it would be for a transient e-clip. However, all data from previous executions of the e-clip remains. This allows e-clips to effectively store data within the storage space scoped by the “cache” statement (either globally or within the user session). The “static” modifier is ignored if it is added to a “cachetransient” statement.

The e-clip script can contain a number of statements to control how it is rendered in the portal server. Table 9 shows additional parameters that can be applied to an e-clip.

TABLE 9

| Parameter | Description | Example |
|---|---|---|
| Title | This parameter defines the default | title=”This is my title” |
| | title used for any instance of this | (Default value: “”) |
| | e-clip. The title is enclosed in | |
| | double quotes. If present, the e-clip | |
| | is rendered with a caption bar. | |
| | This parameter can be overridden | |
| | within a <PLUGIN> tag in a user page. | |
| Border | This boolean parameter controls | border=true |
| | the presence of a border around the | (Default value: false) |
| | e-clip when it is rendered by the | |
| | portal. This parameter can be | |
| | overridden within a <PLUGIN> | |
| | tag in a user page. | |
| Showrefreshbutton | This boolean parameter control the | showrefreshbutton=true |
| | presence of a manual refresh | (Default value: false) |
| | button within the caption bar of the | |
| | e-clip. The refresh button allows | |
| | the user to manually re-fetch the | |
| | e-clip contents from its specified | |
| | source and re-render the page. | |
| | This parameter can be overridden | |
| | within a <PLUGIN> tag in a user | |
| | page. | |
| pageref | This parameter specifies a URL | pageref=”http://www.cnn.com” |
| | that is invoked within a separate | (Default value: “”) |
| | browser window when the user | |
| | select the “show in new window” | |
| | button in the caption bar. This | |
| | button automatically appears if the | |
| | pageref tag is present in the e-clip. | |
| | The URL appears within double | |
| | quotes. This parameter can be | |
| | overridden within a <PLUGIN> | |
| | tag in a user page. | |
| id | This parameter specifies a unique | id=AnyString |
| | value for the e-clip. This can be | (Default value: “”) |
| | used when there is more than one | |
| | cached e-clip with the same name | |
| | and different data. | |
| Unbounded | This boolean flag controls how the | unbounded=true |
| | e-clip will be rendered. If set to | (Default value: false) |
| | false the e-clip will be bounded by | |
| | an HTML table when rendered, | |
| | otherwise no table bounding will | |
| | be performed. This tag is meant | |
| | for internal use only. | |
| Showrefreshtime | If this boolean flag is true, then the | showrefreshtime=true |
| | e-clip is rendered with a caption | (Default value: false) |
| | bar including the last time this | |
| | e-clip was refreshed. | |
| Renderer | This parameter specifies the | renderer=com.hcl.portal. |
| | rendering component for an e-clip. | component.TreeRenditionComponent |
| | The rendering component is the | (Default value: N/A) |
| | last entry in the component chain | |
| | and is responsible for generating | |
| | the final HTML for the e-clip | |

The are two ways to create a component. The easiest method is by using a generic scripting component and providing a script file. Scripting may not be sufficient to complete a task, however. So the e-Clip architecture will also support creating components with code. The following Java source code accepts a URL wraps it in an HTML image tag:

package com.hcl.portal.component;
import java.io.*;
import java.net.*;
public class componentHtmlImg

extends PortalComponent

{

public componentHtmlImg( )
{
}
public void handleRequest( )
{

StringBuffer sb = new StringBuffer( );
sb.append( “<IMG SRC=” + getRequest( ) + “>\n” );
setResponse( sb.toString( ) );

}

}

The details of the PortalComponent class will be shown later. However, an important point of this source code is the handleRequest( ) method, which be implemented for each component. Within the code shown above, the incoming request (a URL pointing to an image) is simply wrapped in an HTML image tag and this new string is written as the response value from this component.

However, the structure of most components is sufficiently similar that they can be created using simple scripts, rather than compiled code. The portal server includes a generic “scripting component” that accepts instructions via a scripting language and uses these instructions to interpret the incoming request and generate an outgoing response. For example, the following is a sample, scripted component:

<COMPONENT>

<DESCRIPTION>

These rules define the extraction range
to get local stock quotes from

the Ottawa Citizen

</DESCRIPTION>

<TAG>

$Body$
<!--STOCKS START− −>
<!--STOCKS END− −>

</TAG>
<REPLACE>

<TABLE BORDER=“0” WIDTH=“100%”>

<TR VALIGN=“TOP”>

<TD ALIGN=“LEFT”>

$Body$

</TD>

</TR>

</TABLE>

</REPLACE>

</COMPONENT>

This script defines a replacer called $Body$ which is defined to be all of the text between “<!-STOCKS START->” and “<!-STOCKS END->” within the raw HTML for a given page. The script:

<Replace>

<P>
$Body$

</Replace>

tells the generic component to replace whatever the e-clip offers as the request input with the contents of the $Body$ replacer prefixed by an HTML paragraph tag.

This section details the API used by the generic scripting component. The scripting language allows developers to intercept and modify text as it passes from the input side to the output side of a component. If the component contains no script then it acts like a pipe, simply passing data from the input to the output side. Scripting provides a mechanism to intervene in this operation to insert or remove text, or to completely replace block of data with something different.

The <Tag> definition is used to define a replacer metatag for a range of text within the input request stream.

<TAG>

metatag
start string
end string

</TAG>

The “metatag” identifies the name of the metatag. This string should be unique within the input stream, so it will typically have the format <$metatagname$>. The “start string” identifies a unique string pattern within the input stream where the replacer content begins. The “end string” identifies a unique string pattern where the replacer content ends.

This format provides a facility to extract a block of text from the input stream delimited by the start and stop strings and associate it with a replacer metatag that can be used in the output stream of the component. The generic scripting component automatically creates a replacer to manage the text replacement for all metatags defined in the script. Finally, there is virtually no limit on the number of metatag values that can be extracted from the input stream or written to the output stream. However no overlap of metatag replacement text can occur.

A “DELETE” script tag removes a specified range of data as it passes through the component. The format for the “DELETE” script tag is as follows:

<DELETE>

start string
end string

</DELETE>

where the start and end string values define string patterns within the data stream where data will be removed. The deletion is inclusive of the start and end strings.

A “DELETEFROM” script tag removes a block of data from a specified matching “start” string to the end of the data buffer. The format is as follows:

<DELETEFROM>

start string

</DELETEFROM>

where the “start string” defines a string pattern within the data stream from which data removal will start. All data from this point to the end of the buffer is removed.

A “DELETETO” script tag removes a block of data from the beginning of the data buffer to a specified matching “end” string. The format is as follows:

<DELETETO>

end string

</DELETETO>

where the “end string” defines a string pattern within the data stream at which data removal will end. All data from start of the buffer to the specified end point is removed from the buffer.

A “PREFIX” script tag allows the insertion of data to the output stream before the incoming data is passed through the component. For example, this tag is used when header information must be inserted into the data stream. The tag format is as follows:

<PREFIX>

Data lines to be inserted

</PREFIX>

A “POSTFIX” script tag allows the insertion of data to the output stream after the incoming data is passed through the component. For example, this tag is used when footer information must be inserted into the data stream. The tag format is as follows:

<POSTFIX>

Data lines to be inserted

</POSTFIX>

A “SUBSTITUTE” script tag allows the substitution of data in the stream with different data For example, this tag is used to correct errant URLs. The tag format is as follows:

<SUBSTITUTE>

Original Data
New Data

</SUBSTITUTE >

A “REPLACE” script tag replaces the entire contents of the component response with a block of data identified. Any metatags defined by the <Tag> definitions or standard replacer tags are replaced within the block of data written to the output stream.

<REPLACE>

Replacement lines of data

</REPLACE>

The replacer tags defined in the script above are a few examples of the possibilities of the e-clip system. Furthermore, a script file for a component can contain a number of standard replacer tags. The following section outlines some examples of hard coded replacer tags that can be used when scripting components.

$eClipRequest$

An original request string passed to the e-clip replaces all instances of this tag in the script. This provides access to the original request string at any point in the e-clip component chain and allows custom URL parameters to be passed to specific components.

$ComponentRequest$

A request string that was passed to this component replaces all instances of this tag. This is useful when the original request string must be extended in some way before passing it to the next component in the chain.

The following are some examples of component scripts. A first example illustrates text deletion, as follows:

<COMPONENT>

<DESCRIPTION>

This script removes a specified range of data
from an HTML page

<DESCRIPTION>
<DELETE>

<!--Ad start− −>
<!--Ad end− −>

</DELETE>

</COMPONENT>

A second example illustrates text replacement, as follows:

<COMPONENT>

<DESCRIPTION>

These rules define the extraction range to get the detailed
Ottawa Weather out of the Weather Network's web server.

<DESCRIPTION>
<TAG>

$Body$
<!--CURRENT CONDITIONS− −>
<!--Begin generated HTML− −>

</TAG>
<REPLACE>

<P>
$Body$

</REPLACE>

</COMPONENT>

A third example illustrates postfix data, as follows:

<COMPONENT>

<DESCRIPTION>

These rules describe how a SearchServer query server
(based on SBJ) can accept a search request. On input,
the component must identify the servlet to which
this request will be made along with any fixed
parameters. This component script will then add (to
the end of that string) any additional parameters
required to complete the search, including the
search request string.

<DESCRIPTION>
<POSTFIX>

?key=fancy&fc=DOCS&qs=$partRequest$

</POSTFIX>

<COMPONENT>

The following section details the theme manager 122 for the preferred embodiment. The theme manager 122 constitutes part of the portal server 105. The theme manager 122 is an asynchronous process within the portal engine 105 that is responsible for managing access to images and pages based on a selected look-and-feel selected by the user of the portal administrator. Themes encompass overall presentation of the portal user interface including e-clip rendering, navigation bar display and operation, and the language of the user.

The theme manager 122 supports object-like hierarchies of themes. Therefore, one theme may be based on another, while providing new or different rendering of e-clips, pages, and images. The theme manager 122 stores and retrieves information relating to themes within the portal repository 128.

In addition to a default central portal theme, the theme manager 122 provides a configuration interface to permit users to select a theme from a list. Each user theme operates independently of the default system theme and the theme selected by other users. Theme creation and configuration is made as simple as possible. In the preferred embodiment, this is accomplished through HTML and text editors.

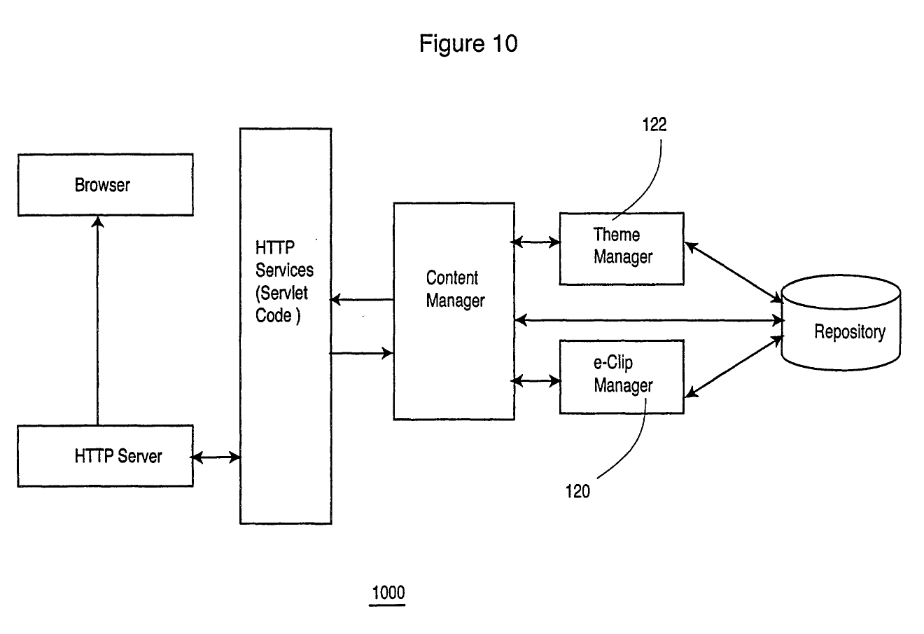

Referring to FIG. 10, a block diagram illustrating how the theme manager 122 fits into the functional architecture of the portal server 105 is shown generally by numeral 1000. The theme manager 122 interacts with the portal server block to receive page and image requests, with the content repository to load user pages, and with the e-clip manager to render e-clips displays. The Theme Manager is an asynchronous process within the portal engine responsible for rendering the user interface of the user's portal session.

The content manager is an asynchronous process within the portal engine responsible for generating content based on requests received from the client browser. The e-clip manager controls the execution of all components and e-clips supported by the portal, as previously described. These objects can interact with the theme manager to render e-clips with the correct appearance for the selected theme. The repository manages portal pages and images for each theme residing within the portal. All information relating to the themes themselves originates in the repository.

The theme manager performs asynchronous queued operations on behalf of all users of the portal 105. The portal initialization code creates a single instance of the theme manager object that is used by all request operations.

The theme manager is a block of code within the portal 102 for managing templates. These templates specify fonts, colors and images relating to a particular presentation style. Theme templates are inheritable, which means that one theme can be based on another, in whole or in part.

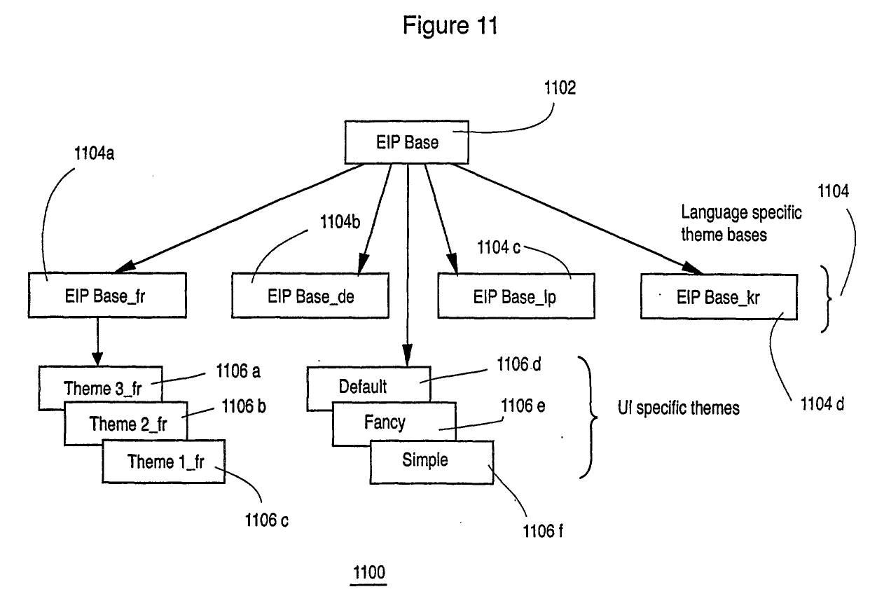

Referring to FIG. 11, a sample theme structure for the present embodiment is illustrated generally by numeral 1100. A base template 1102 provides basic presentation information. In the present embodiment, the base template is referred to as “EIPBase”. All other themes and language specific renditions evolve from the EIPBase template 1102.

For example, a plurality of language specific base templates 1104 is derived from the base template 1102. Examples of such language specific base templates include a French template 1104a, a German template 1104b, a Japanese template 1104c, and a Korean template 1104d. A plurality of user interface specific templates 1106 is derived from the language specific base templates 1104. For example, a first French (or default) theme 1106c, a second French (or fancy) theme 1106b, and a third French (or simple) theme 1106a are derived from French template 1104a.

Furthermore, in addition to siring language-specific theme bases 1104, the EIPBase template 1102 also directly provides default pages and images required for English language support. These include a default theme 1106d, a fancy theme 1106e, and a simple theme1106f. Typically, for each language specific theme, three themes will be provided as follows as indicated in Table 10.

TABLE 10

| Theme | Description |
|---|---|
| Default | This theme is the “middle-of-the-road” theme. |
| | It provides standard HTML with a minimum of glitz. |
| | It is designed for standard 4.x-level web browser |
| | on desktop and notebook systems. |
| Fancy | This theme makes maximum use of advanced browser |
| | capabilities to present the most appealing portal |
| | presentation possible. |
| Simple | This theme is designed for use on palm-based PDAs |
| | such as Pilots and WinCE systems. Typically, it |
| | exploits no advanced features and is design to |
| | support the reduced screen size of handheld devices. |

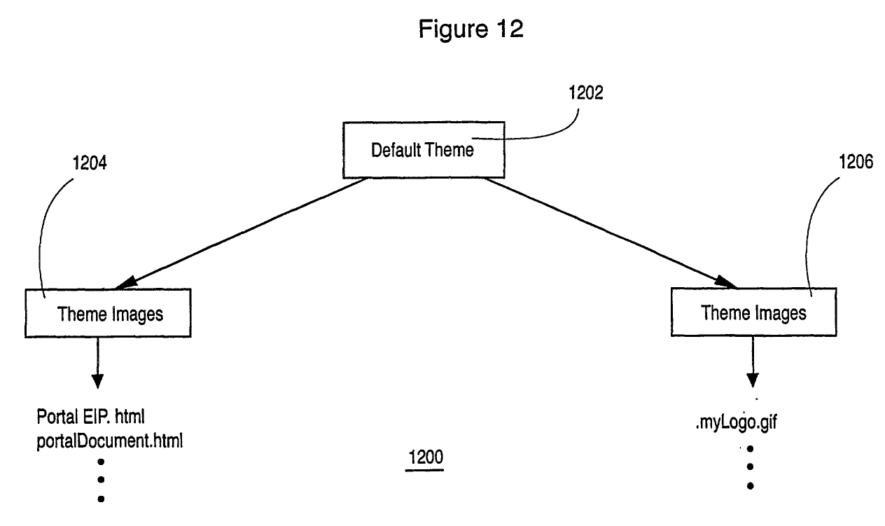

Themes are basically a bin into which theme pages and images are stored and can be retrieved upon request by the portal 105 or a user. Referring to FIG. 12, the structure of a theme is illustrated generally by numeral 1200. A theme 1202 comprises theme pages 1204 and page images 1206. The theme pages 1204 include a plurality of web pages 1206. The web pages 1206 may or may not contain frames and framesets. The page images 1206 comprise a plurality of images in various image formats including GIF, JPG, TIF, and the like.

The only restrictions on a theme in the present embodiment are the inclusion of a start page named portalEIP.html and a document display page named portalDocument.html. The purpose of these pages is described later in this section.

To request a theme page using the portal API, a URL of the following form is used:

http://server/servlet/hcleip?cmd=page&object=pageName.html&theme=<theme name>

where <theme name> is the name of the theme containing the page. If the URL reference is referenced from within an HTML document, the “$ThemeName$” replacer tag can be used instead of the actual theme name. This allows for theme-independent pages wherein the content manager replaces the tag with the name of the theme currently loaded for the user. If the page doesn't exist in the current theme, the theme manager reverts to a parent theme. Similarly, to load a theme-specific image, a URL of the following format is used:

http://server/servlet/hcleip?cmd=image&object=imageName.gif&theme=<theme name>

As noted, themes can be based on other themes, which provides a powerful capability to revert, or “fallback”, to a parent theme when requested. This allows theme creators to derive new themes from existing themes and replace or implement only new features. For example, if a new theme based on “Default” does not provide a “portalEIP.html” file, attempts to load this page from the new theme will prompt the theme manager to load it from the “Default” theme. If, however, the new theme based on “Default” does provide a portalEIP.html page, it will be loaded and any similar files existing within the theme hierarchy will be ignored. Fallback works for any theme page or image. As long as the requested resource lies within the hierarchy of a theme, the theme manager will find it.

Each theme provides a configuration file named “theme.properties” that describes the uniqueness of the theme. The following list illustrates theme properties for a sample theme:

| ParentTheme | EIPBase |
|---|---|
| BackgroundColor | #F5F5ED |
| DialogTextColor | #034C71 |
| DialogBackgroundColor | #CCDCEA |
| CaptionTextColor | white |
| CaptionBackgroundColor | #00639C |
| NavbarBackgroundColor | #CCDCEA |
| NavbarTextColor | black |

Typical properties included in a theme are listed in Table 11.

TABLE 11

| Property Name | Description |
|---|---|
| ParentTheme | This value identifies a parent theme. |
| | Generally, a value is specified for |
| | this property. When in doubt use |
| | “EIPBase” |
| Watermark | Specifies the background image used |
| | for all pages rendered with this theme. |
| | This image is applied to all user |
| | pages displayed by the portal. The |
| | default from EIPBase is |
| | PortalBackground.jpg. This value and |
| | a“BackgroundColor” property |
| | are mutually exclusive. |
| BackgroundColor | Specifies the background color for all |
| | pages rendered with this theme. This |
| | color is applied to all user pages |
| | displayed by the portal. |
| DialogBackgroundColor | Specifies the background color used by |
| | all display elements that “look” |
| | like dialog boxes. For example, the |
| | portal login screen uses this value to |
| | paint the background of the form it |
| | displays. |
| DialogTextColor | Specifies the text colour used by |
| | display elements that “look” |
| | like dialog boxes. For example the |
| | portal login screen uses this value to |
| | paint the text of the form it displays |
| CaptionBackgroundColor | Specifies the background color used in |
| | the title bar of all display elements |
| | that “look” like dialog boxes. |
| | For example the portal login screen |
| | uses this value to paint the background |
| | of the cell containing the form title. |
| | This value is also used for the title |
| | of any rendered e-clip titles |
| CaptionTextColor | Specifies the text color used in the |
| | title bar of all display elements that |
| | “look” like dialog boxes. For |
| | example the portal login screen uses |
| | this value to paint the text of the |
| | form title. This value is also used for |
| | the title of any rendered e-clip titles |
| NavbarBackgroundColor | Specifies the background color used in |
| | the navigation bar e-clip. |
| NavbarTextColor | Specifies the text color used in the |
| | navigation bar e-clip. |

The following section outlines reserved pages stored in the theme. Typically, only pages directly relating to the portal will ever be changed by theme creators. Pages relating to e-clips should not be modified under normal circumstances. Theme names that begin with the letters “EIP” are reserved for portal use. Any theme whose name begins with this sequence will not appear in a theme selection list presented to the user and is strictly for creating base themes. The base versions of these pages reside in the EIPBase theme in the repository.

The portal reserves a large number of page-names within all themes exclusively for its own use. Although new themes are free to re-implement these pages, their use must remain specific. This section outlines these reserved pages and their uses.

Theme pages are used directly by a theme and can be overridden in any theme. Samples of such pages are provided in Table 12.

TABLE 12

| Page | Description |
|---|---|
| PortalEIP.html | The portal invokes this page after a user |
| | logs in to the portal. It is the top-most |
| | page of the portal and typically will |
| | contain only framesets. |
| PortalDocument.html | This page is sent to the browser in |
| | response to a “cmd=doc” URL |
| | request. It typically contains a frameset |
| | containing a titlebar and a replacer for |
| | the document page being displayed. |
| portalAccessError.html | Displayed when the user tries to access |
| | a page to which he has no rights |
| portalBlank.html | Displays a blank page |
| userLogin*.html | Displays the login page using a single |
| | contained e-clip: utilityLogin. |
| userLogout*.html | Contains the form asking the user if he |
| | really wants to log out |
| portalTitledPlugin.html | Contains a template for e-clips that |
| | display a title bar. |
| portalUntitledPlugin.html | Contains a template for e-clips that do |
| | not display a title bar. |

Login Pages

These pages are used by the utilityLogin e-clip. This internal e-clip is responsible for showing the login screen to the user and passing it's form input to the portal for authentication.

| Page | Description |
|---|---|
| userLoginTable*.html | Contains the HTML presentation for the |
| | login page. |
| userLoginSimple.html | Contains the login form for simple |
| | username/password logins. |
| userLoginDomain.html | Contains the login form for qualified |
| | username/password/domain logins. |

Administration Pages

These pages are used by one of the internal administration e-clips:

| Page | Description |
|---|---|
| adminAppConfig.html | Contains the HTML script |
| | to administer the |
| | applications associated |
| | with the portal |
| adminSectorManagement*.html | These pages are used by |
| | the group maintenance |
| | e-clip |
| adminViewPlugins*.html | These pages are used by |
| | the e-clip maintenance |
| | e-clip. |
| adminUserManagement*.html | These pages are used by |
| | the user administration |
| | e-clips |
| adminAppManagement*.html | These pages are used to |
| | administer external |
| | applications integrated |
| | into the portal |
| AdminRepositoryImport*.html | These pages are used to |
| | administrate repository |
| | importing and maintenance. |
| AdminServerStatistics*.html | These pages are used to |
| | display server statistics. |

Sample pages used by one of the internal user configuration e-clips are described in Table 12.

TABLE 12

| Page | Description |
|---|---|
| UserEditProfile.html | Contains the HTML |
| UserPropertiesEditor*.html | script to modify |
| UserKeyChainEditorForm.html | the user's profile, |
| UserKeyChamEditorFormQualified.html | including the |
| UserKeyChainEditorFormSimple.html | application keychain. |
| | As previous described, |
| | the keychain is an |
| | encrypted file |
| | containing account |
| | information |
| UserUP*.html | These pages are used |
| | to manage user page |
| | creation for the portal. |

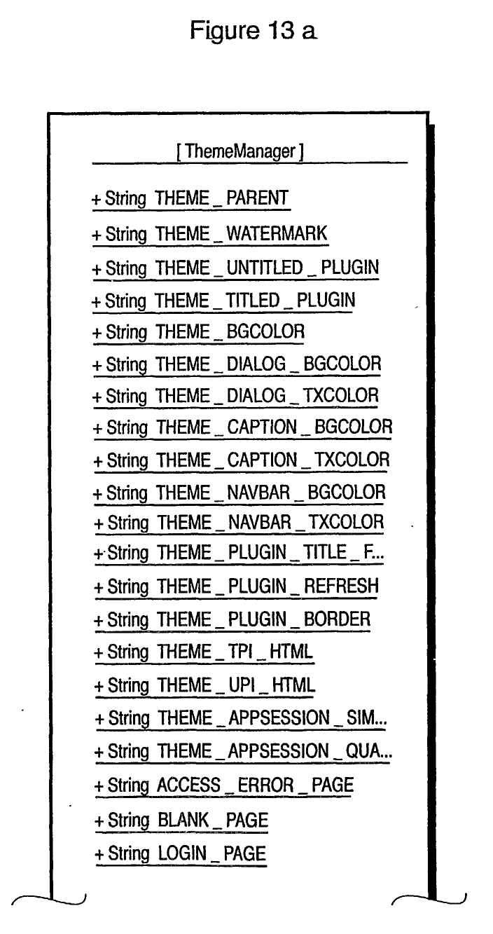

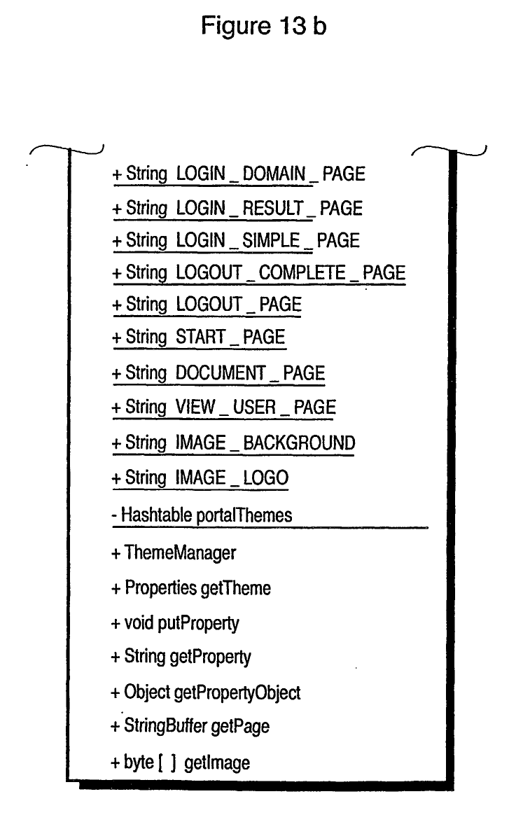

FIG. 13 illustrates a sample class structure of the theme manager for the preferred embodiment, which is represented generally by numeral 1300.

The following section details the application session manager 110 for the preferred embodiment. The portal server 105 manages two types of session within each application in use. First a global session, to which timer events are sent and on which all user sessions depend, is managed. Second, user sessions each corresponding to a unique user of the portal server, is managed. Each session requires application-specific login credentials to be provided by the portal repository. Such a system is particularly useful

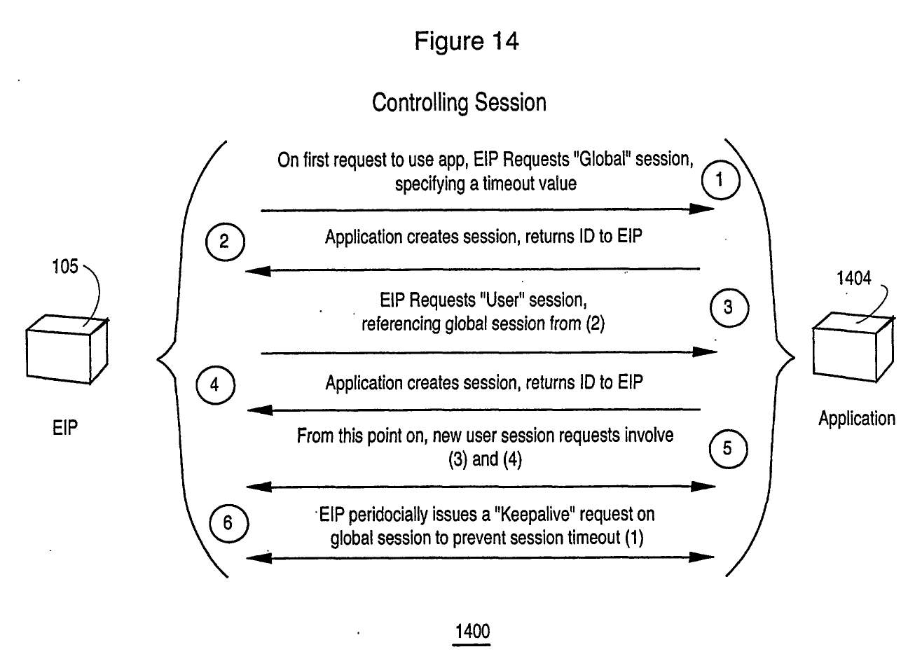

Referring to FIG. 14, the general operation of the session manager is illustrated generally by numeral 1400. The portal server 105 communicates with an application 1404 in a sequence of steps. On a first request to use the application 1404, the EIP requests a global session and specifies a timeout value. In response, the application 1404 creates a session and returns its identifier to the portal server 105. In order to create a new user sessions, the portal server 105 requests a user session, referencing the global identifier previously received. The application 1404 creates another session and returns its identifier to the portal server 105. Periodically, the portal server 105 issues a “keepalive” request on the global session to prevent a session timeout.

When a user interacts with the portal server, such interaction is typically personal in nature. That is, the tasks that the portal server allows a user to complete in a cooperating application reflects the privileges and responsibilities that the user would enjoy were they to interact directly with the application without the intervention of the portal server. A cooperating application is an application that provides the portal server with registration information such that the portal server can reflect elements of the functionality of the application. An example is the navigation bar, which is described further on.

Further, the portal server provides the cooperating applications information regarding a failure in the portal server allowing them to shutdown outstanding user sessions This information is propagated to the applications without undue burden on the system as a whole.

Users of the portal server are allowed to interact with cooperating applications via CAPS in a fully secure mode, without requiring the user to login to the application. Therefore, the portal server itself maintains some information regarding the identity of the user. This is true not only in the context of the portal but also in the context of every cooperating application. This context is used for establishing a session in cooperating applications.

User credentials for every cooperating application are securely stored in the repository. The repository holds a secure keychain for each user, specifying the login credentials for that user in each cooperating application.

Each registered application informs the portal server what credentials it requires to validate a user. This information is stored in a “properties” file in the portal repository under an Applications branch. For example, the directory structure may appear as:

\Applications

\DOCSFulcrum

\application.properties

In the present embodiment, the application.properties file comprises the following attributes:

ApplicationID=<app ID form, e.g. Hcl.Fulcrum>

ApplicationTitle=<full, descriptive name of application>

AuthenticationType={simple|qualified}

QualifierTitle=<name of qualifier, e.g. Domain>

SupportsAnonymous={true|false}

RequiresSession={true|false}

DAC=<class name of data access component to use>

NavBarURL=<where is the app's NavBar bandler?>

NavBarDTDVersion=<version of NB DTD understood by application>

The portal server uses these attributes to present a configuration page to end-users. The configuration page allows the users to specify their own login information for each cooperating application.

In the case of a “simple” authentication type, the portal presents a username and a password entry fields. In the case of a “qualified” authentication type, the portal also presents a qualifier field, entitled with a qualifier title value. If the “Supports Anonymous” attribute is set to “true”, the portal gives the user the opportunity to connect to the application without specific credentials. The “Requires Session” attribute is used by the application session manager to determine whether it should establish a specific session for the user, or whether the cooperating application in question is transactional in nature.

For example, consider the following sample “application.properties”:

ApplicationID=hcl.fulcrum

ApplicationTitle=DOCSFulcrum

AuthenticationType=qualified

QualifierTitle=NT Domain

SupportsAnonymous=true

RequiresSession=true

DAC=com.hcl.portal.component.HttpDAComponent

NavBarURL=http://elmo/cgi/dfxml.dll

NavBarDTDVersion=v1

Using these attributes, the portal might create the following HTML portion:

<TABLE>

<TR VALIGN=“TOP”>

<TD WIDTH=“50%”>

<TABLE BORDER=“0”>

<TR>

<TD>Specify credentials for:
DOCSFulcrum</TD>

</TR>
<TR VALIGN=“CENTER” >

<TD>User name:</TD>
<TD><input type=“text” name=
“DOCSFulcrum_un”></TD>

</TR>
<TR VALIGN=“CENTER” >

<TD>Password:</TD>
<TD><input type=“password” name=
“DOCSFulcrum_pw”></TD>

</TR>
<TR VALIGN=“CENTER” >

<TD>NT Domain:</TD>
<TD><input type=“text” name=
“DOCSFulcrum_qual”></TD>

</TR>

</TABLE>

</TD>

</TR>

</TABLE>

This portion of HTML is written within the framework of a larger HTML form, containing input's for all the cooperating applications that are installed in the portal server. This form is the user preference form that is presented to the user on a first login.

A secure storage mechanism is created on a per-application, per-user credential basis. The per-user, per-application credentials are stored in the repository, under the user's private folder in an encrypted file called “keychain.properties”. The encryption class used to encrypt/decrypt the keychain is loaded from the repository from a class file called “keychain”. The keychain is encrypted and therefore requires decrypting before being of any use. The keychain is only read when it has to be, which is once per session (or following an update to the user's preferences). Thus, the class managing the keychain is loaded at a session scope.

The keychain data file is of the following format:

file ::= <header><key chain>
header ::= <version><crypto id>
version ::= <byte>
crypto id::= <long>
key chain ::= <app count><app data>*
app count ::= <byte>
app data ::= <app name><auth type><credentials>
app name ::= <string>
auth type ::= <byte>
credentials ::= <string><string>[<string>]

The portal uses the file header to detect an attack. That is if the cryptography identification does not match that specified in the cryptography class, access to the file is blocked.

Applications that have no defined credentials default to an anonymous user setting. The anonymous user has no key chain and therefore no access to any cooperating applications on a secured basis.

While the above has been described with reference to a session keychain, a global session keychain is stored in a similar fashion. The global session keychain is stored under the portal server's user directory in the repository.

A control mechanism is provided for controlling application session information for all applications. The mechanism provides startup and shutdown of the session manager for an application and startup and shutdown of an application user session. The control mechanism returns an IDENTITY block for an application user session.

The application session manager further supports efficient timeouts so that cooperating applications can terminate user sessions in the event of critical failure in the portal. In order to provide an efficient “ping” mechanism, the portal maintains a “global” session with each cooperating application. Therefore, watchdog timer events need only be sent to a single session per application. The keychain for the global session is stored in the portal server's user directory, in a typical keychain file, in the repository.

The application session manager provides a mechanism for enumerating the installed applications. In order to provide several of the above points, a means to enumerate installed applications is required. Therefore, in the root of the “Applications” branch of the repository, a single properties file contains a list of installed applications. This file is of the form:

Applications=DOCSFulcrum, CyberDOCS, BI/Suite

The list of applications can then be used to traverse the subdirectories of the Applications folder to ascertain specific application configuration data.

As previously mentioned the portal supports the concept of anonymous users. A checkbox on the login screen provides the user with one method for logging-in anonymously. Furthermore, there are portal configurations that do not use CAP at all. Hence, sessions are not authenticated at all and the users are treated similarly to an anonymous user.

Every user of the portal has a CAP ticket or token and a keychain, and for every cooperating application, each user will have a session ID. The CAP ticket or token is a data element that is passed to any part of the data processing system that needs to know the idenity of the user. The ticket or token indicates that the user supplied authentic credentials to the CAP server. Each cooperating application has a single global application session, which will consist of a keychain and a session ID. A manager class, ApplicationSessionManager, is created for brokering user requests for application session, securely querying the repository for key chains, and holding application session ID's for each user in each cooperating application. The ApplicationSessionManager class is defined below as:

public class ApplicationSessionManager

extends PortalManager
{

//Functional methods:
//Establish an application session for a user
public void establishApplicationSession(HttpSession session,
String app);
//Update the session ID for a user
public void updateApplicationSessionID(HttpSession session,
String app,String newID);
//Tear down an application session for user
public void destroyApplicationSession(HttpSession session,
String app);
//Informational methods:
//Return a formatted IDENTITY block for an application
public String getApplicationSessionIdentity(HttpSession user,
String app);
//Return configuration information for an application
public ApplicationConfiguration getApplicationConfiguration
(String app);
//Return a Vector of all current ApplicationConfigurations
public Vector
//getApplicationConfigurations( )

}

For each user, for each application, an identity is stored so that the (XML-based) IDENTITY block can be created for that user for that application. Therefore, in the application session manager a vector of users is stored. Each vector element stores a reference to a vector of applications, each element of which references an instance of an ApplicationSession class:

class ApplicationSession

{

//The states that the IDENTITY can reflect
static public final short ANONYMOUS = 0;
static public final short TICKET = 1;
static public final short KEY = 2;
//Data members
public short m_state;
public String [symbol] m_keys;

}

The zero'th element of the user vector is reserved for the portal user, that is, the owner of the global sessions in each cooperating application.

The KeyChain class encapsulates the encrypted data stored in the file keychain.properties. The KeyChain class manages decryption/encryption of this file via the private methods “readKeyChain( )” and “storeKeyChain( )” respectively. However, as mentioned, the ApplicationSessionManager is responsible for securely querying the repository for keychains and the retrieval and setting of credentials stored in the keychain. Only the ApplicationSessionManager can instantiate KeyChains and retrieve or set credentials contained therein.

public class ApplicationSessionManager

extends PortalManager

{

//INFORMATIONAL METHODS:
//Get a user's keychain
public KeyChain getKeyChain(

| | |
|---|---|
| String | userName, |

| | |
|---|---|
| HttpSession | session, |

| | |
|---|---|
| RepositoryManager | rm, |

| | |
|---|---|
| Vector | appConfigVector) |

//Get a keychain's credentials
public String[] []getKeyChainCredentials(

| | |
|---|---|
| KeyChain | kc, |

| | |
|---|---|
| String | userName, |
| HttpSession | session, |
| Vector | appConfigs) |

//Get a keychain's credentials for the specified
application
public String[] getKeyChainAppCredentials(

| | |
|---|---|
| KeyChain | kc, |

| | |
|---|---|
| String | userName, |

| | |
|---|---|
| HttpSession | session, |

| | |
|---|---|
| String | appID) |

//Set a keychain's credentials

public boolean setKeyChainCredentials(

| | |
|---|---|
| String[] | credentials, |

| | |
|---|---|
| KeyChain | kc, |

| | |
|---|---|
| String | appID, |
| HttpSession | session, |
| String | userName) |

}

The application session manager further stores per-application configuration information.

For each cooperating application, the application session manager stores an instance of a public class ApplicationConfiguration. The information in these instances is read from the repository, applications section, from the file “application.properties” for each application as described in the following code.

public class ApplicationConfiguration
{

//Types of authentication supported
public final short SIMPLE = 0;
public final short QUALIFIED = 1;
//Generic configuration information
public String m_appID;
public String m_appName;
public short m_authType;
public String m_qualTitle;
public boolean m_supportsAnon;
public boolean m_requiresSession;
public String m_dacClassName;
//NavBar-specific configuration information
public String m_navBarURL;
public String m_navBarDTDVersion;

}

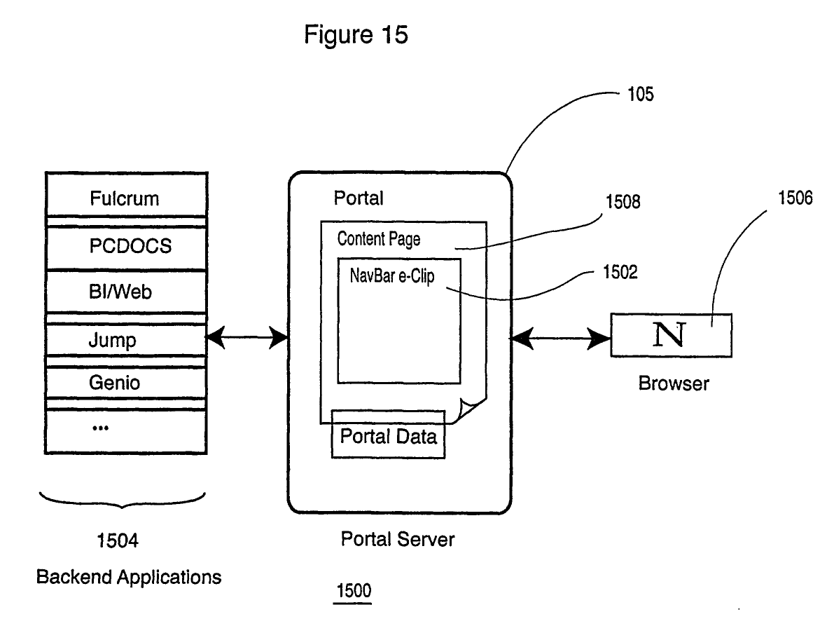

The application session manager is further described along with the navigation bar, and specifically with reference to FIG. 15.

The following sections describe the navigation bar in greater detail. As previously mentioned, the navigation bar is a particular implementation of an e-clip. Specifically, the navigation bar is a user interface device from which all portal resources may be accessed. A navigation bar e-clip gathers and merges hierarchical data for the navigation bar and renders it as a tree as described below.

When a user connects to the portal server, a hierarchical set of links is provided in the left pane of the user interface. Collectively these links are known as the navigation bar. The links in the navigation bar serve as direct links into applications, corporate information and user information. The constituent data of the navigation bar may come from multiple back-end applications. Thus, the navigation bar can unify this data into a single hierarchy. In order to unify data from multiple back-end applications, the navigation bar facility operates in the context of the portal server.

The user is presented with a single navigation bar whereby all portal resources are accessed. The navigation bar (navbar) e-clip finds applications and other potential sources of data for the navbar that are currently available in the portal.

Furthermore, the navbar e-clip gathers data from one or more data sources. For efficiency, concurrent requests for data to multiple data providers are made.

The navbar e-clip enriches data in order to more fully describe the rendition and behavior associated with the data in the context of the portal. This includes the assignment of icons and custom URLs to nodes in the tree of known types. The navbar e-clip organizes all the data it has gathered into a single hierarchy and presents the hierarchy as an HTML document. Multiple renditions may be required depending on browser requirements and user interface design.

The navbar e-clip can operate with large quantities of data. It does not assume that it will be able to retrieve all available data with a single request. Therefore, multiple requests for large quantities of data may be required. In qualitative terms, the tree presented by the navbar e-clip responds to a user's expansion and collapse requests quickly. If the user moves off a page containing the navigation bar and returns to the page a short time later, the navigation bar looks the same as it had previously looked.

To ensure responsiveness, the design of the navigation bar attempts to minimize the number of network transactions required for expanding and collapsing operations. Where possible, the operation is handled on the browser, eliminating a network transaction. This will be possible for some expansions on browsers supporting dynamic HTML (DHTML) rendition. The server does not know about an expansion or collapse that is performed using DHTML. Expansions and collapses performed using DHTML are not reflected in the state of the tree that is stored in the portal session for the user.

Alternately, a request may need to be made from the browser to the portal. The portal handles this request making as few additional requests to a back-end application as possible. This is achieved if more data is cached on the portal than is returned to the browser.

Referring to FIG. 15, the overall architecture of a navbar environment is illustrated generally by numeral 1500. A navbar e-clip 1502 operates in a multi-tiered environment. Data is obtained from interfaces provided by back-end applications 1504, which are, themselves, multi-tiered applications. A browser 1506 serves as a client and interacts with the navbar e-clip by requesting a content page 1508 from the portal 105.

The navbar e-clip 1502 is included in the content page 1508. When the content manager interprets the page 1508, the navbar e-clip is invoked to generate a navigation bar. The script that defines the navbar e-clip is of the form:

# Component chain for navbar e-clip

com.hcl.portal.navbar

com.hcl.portal.treeRendition

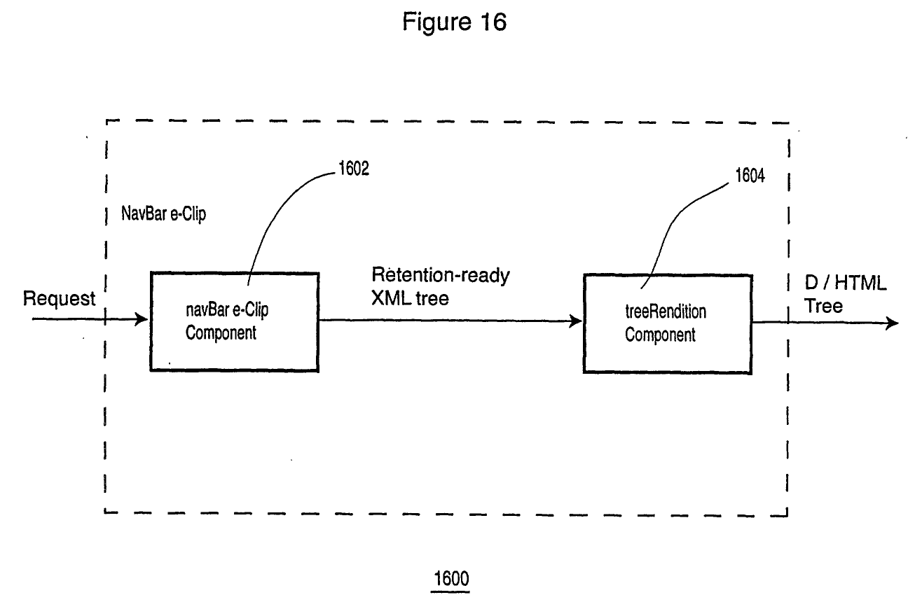

Referring to FIG. 16, a general architecture for a navbar c-clip is illustrated generally by numeral 1600. The navbar e-clip 1600 comprises a navbar component 1602 and a TreeRendition component 1604. Each of these components extends the PortalComponent class.

The navbar component 1602 is responsible for all logic involved in obtaining data and preparing the data for rendition. The TreeRendition component 1604 comprises presentation logic required to effectively render hierarchical data described in an XML document.

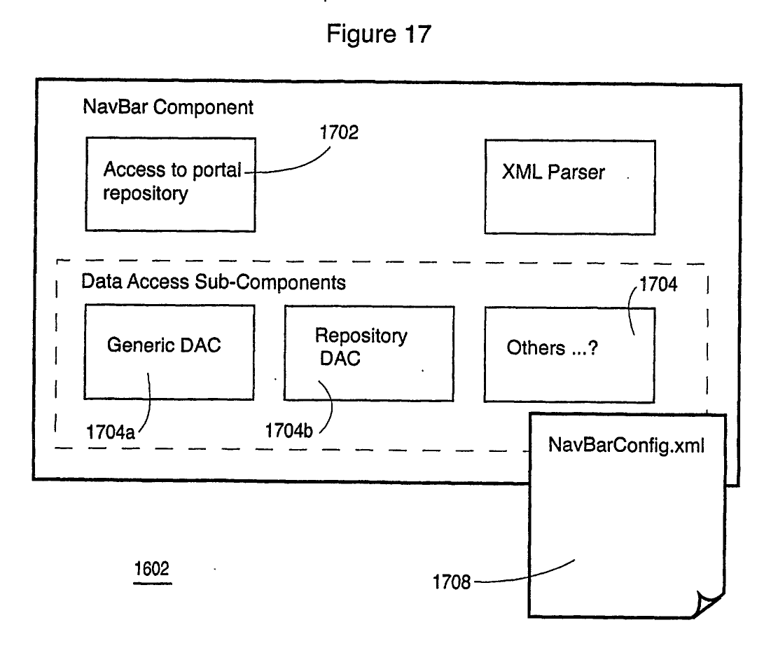

Referring to FIG. 17, the navbar component 1602 is illustrated in greater detail. In order to discover available sources of information for the navigation bar, the navbar component 1602 includes an access component 1702 for querying the portal repository 128. Requests for data are issued through data access components 1704. Response XML returned from a data access component is parsed into an XML tree using an XML parser 1706 and enriched using rules provided in a NavBarConfig file 1708.

The output of the navbar component 1602 is an XML document conforming to the TreeRendition DTD. The e-clip manager 120 passes the response of the navbar component 1602 to the request of the TreeRendition component 1604, which in turn responds with an HTML rendition of the tree.

The navbar component 1602 obtains from the portal repository 128 user page information, a list of the available applications, configuration information for each application and the URL that may be used to access each application. The application registers the information of interest to the navbar with the repository. Such information includes:

| Key | Description | Sample |
|---|---|---|
| ApplicationID | Unique Application | HCL.FULCRUM |
| | identifier. Equivalent | |
| | to APPID in NavBar | |
| | Response | |
| NavBarUrl | A resource locator that | http://dingo/cgi-bin/dfxml.dll |
| | will be passed to the | |
| | component data access | |
| | component with NavBar | |
| | request. | |
| DAC | The rally qualified | com.hcl.portal.component.HttpDAComponent |
| | classname of the data | |
| | access component to be | |
| | used to obtain data | |
| | from this application. | |
| DTDVERSION | Indicates the version | 1 |
| | of the NavBar Request | |
| | and Response DTD that | |
| | is supported by the | |
| | application. | |

This information is registered with the portal as a set of global settings for an application, and is stored in the application.properties item in the repository. The Application Session Manager 110 provides access to this information.

The user may store in the keychain information that could be used to override some settings in the application table of contents file. For instance, a particular user may wish to always connect to DOCSFulcrum anonymously. In such a case, the user's keychain would contain a directive to log on to DOCSFulcrum anonymously. User-specific configuration information can also be contained in the keychain to replace globally defined configuration information. However, the user interface allows a user to set up a keychain for an application permits only reasonable modifications.

The data access components 1704 are Java classes residing on the portal server. A data access component 1704 extends PortalComponent, and is called using similar methods as are used when the e-clip manager invokes any PortalComponent.

A generic data access component 1704a is provided. Most applications intending to provide navbar data using HTTP and XML should use the generic data access component 1704a. However, this component may not be appropriate for all applications. For instance, it is possible to access navigation bar data stored in the portal repository without issuing an HTTP request back to the portal server. Applications that wish to provide a custom data access component to service navbar requests must specify the data access component class name DACCLASSNAME of the component when registering with the portal.

The data access component 1704 expects to be provided a request that conforms to the Navigation Bar Request document type definition (DTD) and the value of NAVBARURL registered for the particular application. A data access component returns a response conforming to the Navigation Bar Response DTD.

The navbar component 1602 generates appropriate navbar request datagrams, based on input received. On initialization, or when expanding a node containing a replaceable reference, a request is generated for each data source. To service a tree expansion within a particular application, a request is generated for a single data source.

For each data source with a pending navbar request, a thread is initialized. The request, a NavBarURL value, and the data access component class name are passed to the thread. Each thread attempts to locate, load and link the data access component, make the request and wait for the response. A synchronized method is called from the thread to add the response data into an XML tree or handle the error. The thread then removes itself from a vector of pending threads. All threads created by the navbar component 1602 are terminated before the navbar component returns control to the e-clip manager 120.

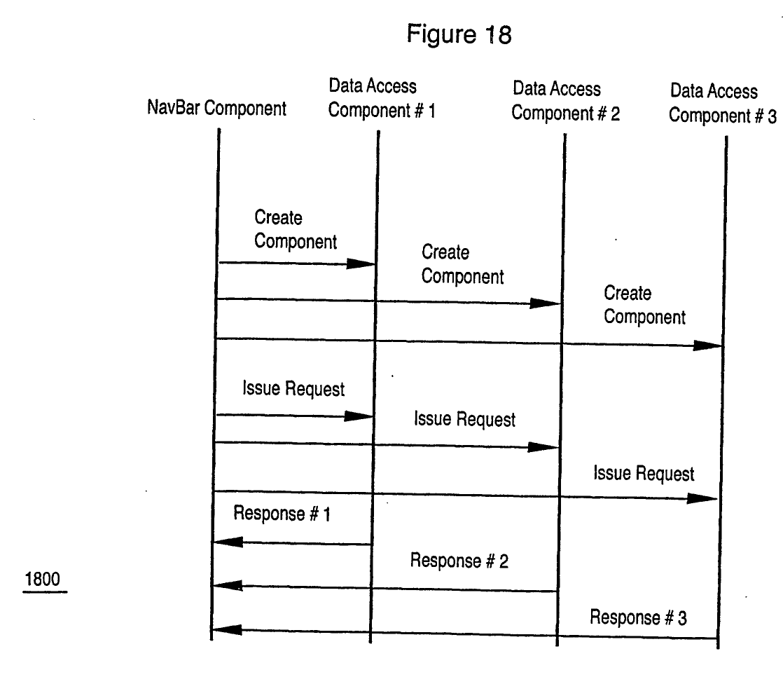

Referring to FIG. 18, an event trace diagram for gathering data is illustrated generally by numeral 1800. The navbar component creates all the components in parallel. Similarly, the navbar component issues a request to each of the components in parallel. Once the component has finished processing the request, it returns a response to the navbar component. This approach provides the navbar component with concurrent requests for data and synchronized XML tree updates, conditional loading of requests to data access components, and preservation of the navbar state information while data access components are executing

The desire to define rendition and behavior at the portal level motivates the navbar e-clip's data enrichment. Customarily, trees have an icon at each node to indicate the type of the item. Depending on the interface theme or user preferences, the desired images could vary in size, colour and iconography. Data providers are not required to provide multiple icons to the portal, nor do they know about icon files that exist on the portal server. To provide this functionality, the navbar component is able to enrich navbar data with the name of the icon that is used for the entry. The NavBarConfig file may contain information to map a known class identifier CLASSID to an icon file name. This centralizes knowledge of icons at the portal level, in an icon directory and the NavBarConfig file. Knowledge of class identifiers CLASSIDs is shared between the back-end application and the NavBarConfig file.

For some tree items, clicking on a link will simply launch a new browser window pointed at a URL that points directly back to a back-end application. For tree items like this, it may be desirable for the back-end product to provide the desired URL as part of the XML returned in the NavBar request. The URL is opaque to the NavBar component.

For other tree items, it might be necessary to append additional portal level information to the URL, target the response to a specific frame, or send a request to another portal e-clip. The data providers cannot be expected to know about portal variables, the names of target frames or the names of e-clips and their expected parameters. Therefore, for known types of tree items, the navbar component uses a passed-in UTR or constructs a URL, typically from response data. For entries of a given CLASSID, the NavBarConfig file contains a description of how the URL should be constructed. If the CLASSID for an entry is not defined or does not implement a description of how the URL should be constructed, the base class is examined for an implementation and so on. The default behavior is to use the URL provided in the navigation bar XML response without modification.

The repository provides a template for the way in which navigation bar XML responses are to be organized into a single hierarchy. The top level tree structure is defined with intermingling replaceable entries, to indicate where data from applications should be inserted.

The tree rendition component, TreePendition, extends PortalComponent and expects XML documents conforming to a Tree Rendition DTD as its request data. Based on a user agent HTTP header and portal settings, an HTML rendition of the tree is returned. It is possible that TreeRendition could return many HTML renditions optimized for differing browsers, versions, platforms and portal themes. The priority is delivering a generic HTML rendition (HTML 3.2 or the like) that provides excellent browser reach and a CSS/DHTML offering (Internet Explorer 4 or 5, or the like) that provides an enhanced user experience and aesthetically pleasing demonstrations.

Depending on what information is included in the navigation bar, the tree contains an arbitrarily large number of nodes. The navigation bar does not always obtain all the tree data at initialisation. The navigation bar must be able to fetch additional data from back-end applications in response to a user request.

The Navigation Bar Request DTD anticipates this. The navbar component generates a request that specifies a start node and a desired depth. The navbar component merges the response from this request into the tree. As previously described, if the user moves off a page containing the navigation bar and returns to the page a short time later, the navigation bar should look the same as it previously looked. Therefore, the expansion state of the navigation bar is stored in the portal session for the user. A subsequent request for a page containing the navigation bar will cause it to be rendered using the data stored in session state.

The navbar component handles exceptions by generating an AL datagram that conforms to a(Request Status DTD. The error will is passed to the TreeRendition component so that it may be rendered as HTML. Errors occurring in the TreeRendition component are rendered likewise.

While the above description refers to specific components, additional components will be apparent to a person skilled in the art. Such additional components include components that render hierarchical data using a structure similar to a Yahoo-style drill-into tree, a set of tab strips, or an Outlook-style shortcut bar.

The following section describes how the navbar component interprets the information provided by the NavBarConfig file. NavBarConfig contains the necessary information to do the following map an icon to an entry of any given class identifier CLASSID and generate a URL for an entry of any class identifier CLASSID. The data required to perform these tasks is formatted using XML and stored in the NavBarConfig file.

The purpose of the NavbarConfig file is to avoid adding any awareness of the underlying applications into the navbar component. Any specific processing that needs to be done on data of a particular class is described using this file. If a new class of data is added to the navigation bar, and a special icon is prepared for that class, the NavBarConfig file is edited to map the new icon to the new class.

To illustrate how the navbar component uses the configuration file NavBarConfig, consider the following example of associating an ICON with a URL.

A class identifier CLASSID for a Fulcrum Agent is designated as HCL.FULCRUM.AGENT, and is known to the back-end application and the NavBarConfig file. An icon, agent.gif, for Fulcrum Agent is created and placed in the portal's images directory tree. As a response to a navbar request, the following XML is added to tree:

...
<ENTRY TAG=“1.0” CLASSID=”HCL.FULCRUM.AGENT”>

<LABEL>Results of agent 1</LABEL>
<URL>http://elmo/dfxml/getdoc.asp?0123841724</URL>

</ENTRY>

...

The navbar component then processes the new additions to the tree, in order to convert ENTRYs to the Tree Rendition DTD. The CLASS Tree is walked in NavBarConfig:

<CLASS CLASSNAME=”HCL”>

<LINKS>

<LINK ALT=“View” TARGET=“right_fr”>

<PART TYPE=“REFXML”>this!URL</PART>

</LINK>

<LINKS>
<CLASS CLASSNAME=“Fulcrum”>

<ICON>magnifyingglasstriangle.gif</ICON>
<CLASS CLASSNAME=“Agent”>

<ICON>agent.gif</ICON>

</CLASS>

</CLASS>

</CLASS>

Navbar finds the most specific implementation of “HCL.FULCRUM.AGENT” that implements the ICON element. In this case an ICON, agent.gif, is defined for “HCL.FULCRUM.AGENT”, so the XML for the entry is updated as follows:

...
<ENTRY TAG=“1.0” CLASSID=”HCL.FULCRUM.AGENT”>

<LABEL>Results of agent 1</LABEL>
<ICON>agent.gif</ICON>
<URL>http://elmo/dfxml/getdoc.asp?0123841724</URL>

<ENTRY>

Next (or at the same time as above), the navbar attaches a URL to the entry. NavBar finds the most specific implementation of “HCL.FULCRUM.AGENT” that implements the LINKS element. In this case, the class “HCL” is the most specific class that implements LINKS.

<CLASS CLASSNAME=”HCL”>

<LINKS>

<LINK ALT=“View” TARGET=“right_fr”>

<PART TYPE=“REFXML”>this!URL</PART>
</LINK>

</LINKS>

...

The NavBar component then sees that the LINK for the ENTRY of CLASSID=“HCL.FULCRUM.AGENT” is the value of the URL element for the current ENTRY (this!URL), and the ENTRY is updated in the tree as follows (which looks the same as before):

...
<ENTRY TAG=“1.0” CLASSID=”HCL.FULCRUM.AGENT”>

<LABEL>Results of agent 1</LABEL>
<ICON>agent.gif</ICON>
<URL>http://elmo/dfxml/getdoc.asp?0123841724</URL>

</ENTRY>

An icon and a link have now been associated with the entry. Finally, navbar performs a step to make the newly added ENTRY conform to the TreeRenditon DTD.

The repository provides a template that defines how the contents of the navigation bar are organised. This template contains all the user's tree data and stubs that indicate where application data should be inserted. The application's table of contents file in the repository defines how information from different sources should be amalgamated into a single tree.

The following section describes how data is merged into a tree. The user's template for the tree is read in from the repository.

<TREETEMPLATE>

<ENTRY TAG=”1”>

<LABEL>IDS_MY_INFORMATION</LABEL>
<ICON>folder.gif</ICON>
<REPLACEENTRY APPID=“HCL.FULCRUM.AGENTSERVICE”/>
<REPLACEENTRY APPID=“HCL.PCDOCS.PROJECTS”/>

</ENTRY>
<ENTRY TAG=”2”>

<LABEL>IDS_CORPORATE_INFORMATION</LABEL>
<ICON>folder.gif</ICON>
<REPLACEENTRY APPID=“HCL.JUMP”/>

</ENTRY>

</TREETEMPLATE>

Data is returned by an application is as follows:

<NAVRESP>

<APPINFO APPID=“HCL.FULCRUM.AGENTSERVICE”/>
<ENTRY TAG=“1” CLASSID=”HCL.FULCRUM.AGENTS”>

<LABEL>Agent Results</LABEL>
<ENTRY TAG=“1.0” CLASSID=”HCL.FULCRUM.AGENT”>

<LABEL>Results of agent 1</LABEL>
<URL>http://elmo/dfxml/getdoc.asp?0123841724</URL>

</ENTRY>

</ENTRY>

</NAVRESP>

The REPLACEENTRY element in the template with the matching APPID is replaced with the data.

A CLASSMAP DTD defines the format of the NavBarConfig file, the configuration file used by the NavBar component. The CLASSMAP DTD describes information about icons and URLs for CLASSIDs.

A CLASSMAP element contains the information required to map an icon and to obtain a URL for an entry of a given CLASSID.

Element CLASSMAP

Purpose: Provide information to map CLASSID to icons and URL rules.

Allowable sub-elements: ROOTCLASS

Attributes: None.

Element ROOTCLASS

Purpose: Base class for linking icons and URL rules to CLASSID. Last stop in the inheritance chain.

Allowable sub-elements: ICON, LINKS, CLASS*

Attributes: None.

Element CLASS

Purpose: Provide information to map CLASSID to icons and URL rules.

Allowable sub-elements: ((ICON?, LINKS?)|(PLUGIN)), CLASS*

| | | |
|---|---|---|
| Attributes: | Name: | CLASSNAME |
| | Description: | The short name of the class |
| | Type: | CDATA |
| | Default: | Required |

Element ICON

Purpose: The file name to an icon to display for this node. The TreeRendition component uses this file name to construct a URL, based on the current rendition and portal theme.

| Sub-elements: | #PCDATA | |
|---|---|---|
| Attributes: | Name: | WIDTH |

Description: The override width attribute for the image. Corresponds to the WIDTH attribute of the HTML IMG tag. Maybe be expressed as nn pixels or nn % for percentage length. If not specified, no width attribute is specified for the HTML IMG tag.

| | |
|---|---|
| Type: | CDATA |
| Default: | Implied |

Name: HEIGHT

Description: The override height attribute for the image. Corresponds to the HEIGHT attribute of the HTML IMG tag. Maybe be expressed as nn pixels or nn % for percentage length. If not specified, no height attribute is specified for the HTML IMG tag.

| | |
|---|---|
| Type: | CDATA |
| Default: | Implied |

Element LINKS

Purpose: Provides information to construct a set of URLs for a CLASSID.

Allowable sub-elements: LINK+

Attributes: None

Element LINK

Purpose: Provide information to construct a single URL.

Allowable sub-elements: PART+

| | | |
|---|---|---|
| Attributes: | Name: | LABEL |

Description: A tooltip to display for the link. If multiple URLs are present, this may be displayed as the label in a context menu. For localization, this should be the name of a localized string. The NavBar component will replace this string name with a string.

| | |
|---|---|
| Type: | CDATA |
| Default: | Implied |

Name: TARGET

Description: The name of the frame the link will be targeted to.

| | |
|---|---|
| Type: | CDATA |
| Default: | Implied |

Element PART

| Purpose: | A portion of a URL | |
|---|---|---|
| Sub-elements: | #PCDATA | |
| Attributes: | Name: | TYPE |

Description: Describes the nature of the data for the part. It will either be a string or a reference into the XML tree where a string can be obtained.

| | |
|---|---|
| Type: | STRING \| REFXML \| |

STRING_ENCODE | REFXML_ENCODE

| | |
|---|---|
| Default: | Required |

Element PLUGIN

Purpose: A means to specify a plugin to be used for an ENTRY in the tree.

| | |
|---|---|
| Sub-elements: | PART+ |

| | | |
|---|---|---|
| Attributes: | Name: | NAME |

| Description: | The name of the plugin. | |
|---|---|---|
| | Type: | CDATA |

| | |
|---|---|
| Default: | Required |

| | |
|---|---|
| Name: | TITLE |

| Description: | The title of the plugin. | |
|---|---|---|
| | Type: | CDATA |

| | |
|---|---|
| Default: | Implied |

| | |
|---|---|
| Name: | BORDER |

| Description: | Border attribute for plugin. | |
|---|---|---|
| | Type: | CDATA |

| | |
|---|---|
| Default: | Implied |

| | |
|---|---|
| Name: | SHOWREFRESHBUTTON |

| Description: | ShowRefreshButton attribute for plugin. | |
|---|---|---|
| | Type: | CDATA |

| | |
|---|---|
| Default: | Implied |

| | |
|---|---|
| Name: | PAGEREF |

| Description: | PageRef attribute for plugin. | |
|---|---|---|
| | Type: | CDATA |

| | |
|---|---|
| Default: | Implied |

DTD
<!--
# Name: hcleip_classmap_V1.DTD
# Description: DTD for class mapping in NavBar component
# Version: 1.0
# Language: English
# Organization: Hummingbird Communications Ltd.
# Date: August 23, 1999
− −>
<!ENTITY % PARTTYPE “(STRING | REFXML | STRING_ENCODE | REFXML_ENCODE)”>
<!ELEMENT CLASSMAP (ROOTCLASS)>
<!ELEMENT ROOTCLASS (ICON, LINKS, CLASS*)>
<!ELEMENT CLASS ( ((ICON?, LINKS?)|(PLUGIN)), CLASS*)>
<!ATTLIST CLASS

| | | |
|---|---|---|
| CLASSNAME | CDATA | #REQUIRED |

>
<!ELEMENT ICON (#PCDATA)>
<!ATTLIST ICON

| | | |
|---|---|---|
| WIDTH | CDATA | #IMPLIED |
| HEIGHT | CDATA | #IMPLIED |

>
<!ELEMENT LINKS (LINK+)>
<!ELEMENT LINK (PART+)>
<!ATTLIST LINK

| | | |
|---|---|---|
| LABEL | CDATA | #IMPLIED |
| TARGET | CDATA | #IMPLIED |

>
<!ELEMENT PART (#PCDATA)>
<!ATTLIST PART

| | | |
|---|---|---|
| TYPE | %PARTTYPE; | #REQUIRED |

>
<!ELEMENT PLUGIN (PART+)>
<!ATTLIST PLUGIN

| NAME | CDATA | #REQUIRED |
|---|---|---|
| TITLE | CDATA | #IMPLIED |
| BORDER | CDATA | #IMPLIED |
| SHOWREFRESHBUTTON CDATA | | #IMPLIED |
| PAGEREF | CDATA | #IMPLIED |

>

A TreeTemplate DTD defines the format of TreeTemplate, the configuration file used by the NavBar component. The TreeTemplate DTD contains information about how the data should be organized into a tree. The root node of the document is named TREERENDITION, because the document is transformed immediately to become TreeRendition DTD compliant.

Element TREETEMPLATE

Purpose: Defines the layout of the tree

Allowable sub-elements: (REPLACEENTRY|ENTRY)*

Attributes: None

Element REPLACEENTRY

Purpose: A placeholder for data from an application

Allowable sub-elements: None

Attributes: Name: APPID

Description: The fully qualified APPID for the application that should contribute data in this location.

| | |
|---|---|
| Type: | CDATA |
| Default: | Required |

Name: STARTTAG

Description: A tag that is meaningful to the back-end application to indicate what data should be contributed in this location.

| | |
|---|---|
| Type: | CDATA |

| | |
|---|---|
| Default: | Implied |

Element ENTRY

Purpose: Defines the layout of the tree

Allowable sub-elements: (LABEL?, ACTIVITYDATA?, TOOLTIP?, (URL?|

APPDATA+), (REPLACEENTRY|ENTRY)*)

Attributes: None

Element LABEL

Purpose: A human readable label for the entry. For localization, this should be the name of a localized string. The NavBar component will replace this string name with a string.

| | |
|---|---|
| Sub-elements: | #PCDATA |
| Attributes: | None |

Element ICON

Purpose: The file name to an icon to display for this node. The TreeRendition component uses this file name to construct a TRL, based on the current rendition and portal theme.

| Sub-elements: | #PCDATA | |
|---|---|---|
| Attributes: | Name: | WIDTH |

Description: The override width attribute for the image. Corresponds to the WIDTH attribute of the HTML IMG tag. Maybe be expressed as nn pixels or nn % for percentage length. If not specified, no width attribute is specified for the HTML IMG tag.

| | |
|---|---|
| Type: | CDATA |
| Default: | Implied |

Name: HEIGHT

Description: The override height attribute for the image. Corresponds to the HEIGHT attribute of the HTML IMG tag. Maybe be expressed as nn pixels or nn % for percentage length. If not specified, no height attribute is specified for the HTML IMG tag.

| | |
|---|---|
| Type: | CDATA |
| Default: | Implied |

Element ACTIVITYDATA

Purpose: A piece of information that can be used to log the context of an action taken by a user for the entry. For localization, this should be the name of a localized string. The NavBar component will replace this string name with a string.

| | |
|---|---|
| Sub-elements: | #PCDATA |
| Attributes: | None |

Element TOOLTIP

Purpose: A descriptive Windows-style tooltip which describes the entry. For localization, this should be the name of a localized string. The NavBar component will replace this string name with a string.

| | |
|---|---|
| Sub-elements: | #PCDATA |
| Attributes: | None |

Element URL

Purpose: A URL that references some action to be taken for the entry.

| | | |
|---|---|---|
| Sub-elements: | #PCDATA | |
| Attributes: | Name: | LABEL |

Description: A tooltip or status bar message to display for the link. If multiple URLs are present this may be displayed as the label in a context menu.

| | |
|---|---|
| Type: | CDATA |
| Default: | Required |

Name: TARGET

Description: The name of the frame the link should be targeted to.

| | |
|---|---|
| Type: | CDATA |
| Default: | “_blank” |

Element APPDATA

Purpose: Provide application specific data to the NavBar Plugin which cannot be provided through the use of the URL element. Use of this element is tightly coupled with the NavBar Plugin tree control. Included here for consistency with NavResp DTD

Sub-elements: #PCDATA

Attributes: Name: NAME

Description: A unique name for this piece of application specific data.

| | |
|---|---|
| Type: | CDATA |
| Default: | Required |

Example: <APPDATA NAME=“AgentID”>

17215

</APPDATA>

DTD
<!--
# Name: hcleip_treetemplate_V1.DTD
# Description: DTD for XML tree template for NavBar component
# Version: 1.0
# Language: English
# Organization: Hummingbird Communications Ltd
# Date: August 23, 1999
− −>
<!ENTITY % PARTTYPE “(STRING | REFXML)”>
<!ENTITY % BOOLEAN “(TRUE | FALSE)”>
<!ENTITY % URLDISP “(INFRAME | NEWWINDOW)”>
<!ELEMENT TREETEMPLATE (REPLACEENTRY|ENTRY)+>
<!ELEMENT REPLACEENTRY EMPTY>
<!ATTLIST REPLACEENTRY

| | | |
|---|---|---|
| APPID | CDATA | #REQUIRED |
| STARTTAG | CDATA | #IMPLIED |

>
<!ELEMENT ENTRY (LABEL?, ICON?, ACTIVITYDATA?, TOOLTIP?, (URL? | APPDATA+),
(REPLACEENTRY | ENTRY)*)>
<!ATTLIST ENTRY

| | | |
|---|---|---|
| TAG | CDATA | #REQUIRED |
| CLASSID | CDATA | #IMPLIED |
| TERMINAL | %BOOLEAN; | “FALSE” |
| VOLATILE | %BOOLEAN; | “FALSE” |

>
<!ELEMENT LABEL (#PCDATA)>
<!ELEMENT URL (#PCDATA)>
<!ATTLIST URL

| | | |
|---|---|---|
| DISPOSITION | %URLDISP; | #IMPLIED |

>
<!ELEMENT APPDATA (#PCDATA)>
<!ATTLIST APPDATA

| | | |
|---|---|---|
| NAME | CDATA | #REQUIRED |

>
<!ELEMENT ACTIVITYDATA (#PCDATA)>
<!ELEMENT TOOLTIP (#PCDATA)>

The following is a NavBarConfig Classmap example:

<!DOCTYPE CLASSMAP SYSTEM “hcleip_classmap_V1.DTD”>
<CLASSMAP>

<ROOTCLASS>

<ICON>default.gif</ICON>
<LINKS>

<LINK LABEL=“IDS_OPEN” TARGET=“_blank”>

<PART TYPE=“REFXML”>this!URL</PART>

</LINK>

</LINKS>
<CLASS CLASSNAME=“HCL”>

<CLASS CLASSNAME=“BI”>

<ICON>BIWEB.gif</ICON>
<CLASS CLASSNAME=“Report”>

<ICON>bireport.gif</ICON>
<LINKS>

<LINK LABEL=“IDS_VIEW_REPORT” TARGET=“right_fr“>

<PART TYPE=“REFXML”>this!URL</PART>

</LINK>

</LINKS>

</CLASS>

</CLASS>
<CLASS CLASSNAME=“FULCRUM”>

<ICON>magnifyingglasstriangle.gif</ICON>
<CLASS CLASSNAME=“AGENT”>

<ICON>agent.gif</ICON>
<LINKS>

<LINK LABEL=“IDS_VIEW_AGENT” TARGET=“right_fr”>
<PART

TYPE=“STRING”>hcleip?page=agentplugin&amp;agentID=</PART>

<PART TYPE=“REFXML”>this!APPDATA#AGENTID</PART>
</LINK>

</LINKS>

</CLASS>

</CLASS>

</CLASS>

</ROOTCLASS>

</CLASSMAP>
The following is an example of a tree template:
<!DOCTYPE TREETEMPLATE SYSTEM “hcleip_treetemplate_V1.DTD”>

<TREETEMPLATE>

<ENTRY TAG=”1”>

<LABEL>IDS_MY_INFORMAION</LABEL>
<REPLACEENTRY APPID=“HCL.FULCRUM.AGENTSERVICE”/>
<REPLACEENTRY APPID=“HCL.PCDOCS.PROJECTS”/>

</ENTRY>
<ENTRY TAG=”2”>

<LABEL>IDS_CORPORATE_INFORMATION</LABEL>
<REPLACEENTRY APPID=“HCL.FULCRUM.KMAP”/>

</ENTRY>

</TREETEMPLATE>

The following section describes URL Construction for the configuration file NavBarConfig. It has been noted that back-end applications should, when providing data to the NavBar, provide a URL for the ENTRY. This is usually possible, unless the required URL for an ENTRY calls back into a portal e-clip, which the back-end application does not know about.

A target is determined for the URL. If a TRL element with a DISPOSITION attribute is provided, the DISPOSITION value is translated into a real frame name. If the DISPOSITION value is not provided, or if a URL is not present, the TARGET attribute is used to target the constructed URL to an appropriate frame. NavBarConfig, through the CLASSMAP XML, provides a mechanism for constructing a URL from a combination of data defined at the portal level and data provided by the application.

In the NavBarConfig file, each LINK element describes what will become a URL. A link may contain more than one PART. The strings that result from each PART are concatenated to create the URL.

A PART may be either a STRING or an REFXML. If the PART is of type STRING, the contents of the PART are used directly in the concatenation. If the PART is of type REFXML, the navbar component knows that the contents of the PART are actually a reference into the XML tree containing the navbar data. The navbar component uses the reference to pull a string out of the XML tree that may be used in the concatenation. The additional PART types STRING_ENCODE and REFXML_ENCODE are similar to STRING and REFXML, except that the string is URL encoded prior to concatenation.

The syntax for an REFXML reference is as follows:

this!elementname[#attributename]

where “This” is recognized as meaning the current ENTRY, elementname is the name of the element for which the value is desired, and attributename is the value of the NAME attribute if there is more than one elementname with the desired value. It is therefore possible to retrieve the values of APPDATA elements for an ENTRY. This can be extended if required.

Consider the following navbar response describing a node in a knowledge map:

<ENTRY TAG=”1.2.1” CLASSID=”HCL.FULCRUM.KMAP.NOTMARKED.ISINDEXED”>

<LABEL>No Limits Public Folder</LABEL>
<APPDATA NAME=”CONTAINERID”>1234566543321</APPDATA>
<APPDATA NAME=”TAG”>1.2.1</APPDATA>

</ENTRY>

Suppose a corresponding CLASS was defined in NavBarConfig as follows (character encoding is omitted for clarity):

...
<CLASS CLASSNAME=”ISINDEXED”>

<ICON>indexedfolder.gif</ICON>
<LINKS>

<LINK LABEL=”Mark Folder” TARGET=”_self”>

<PART TYPE=”STRING”>

http://.../hcleip?page=navbarpage&cmd=
mark&containerid=

</PART>
<PART TYPE=”REFXML”>

this!APPDATA#CONTAINERID

</PART>
<PART TYPE=”STRING”>

&tag=

</PART>
<PART TYPE=”REFXML”>

this!APPDATA#TAG

</PART>

</LINK>

</LINKS>

</CLASS>

When the navbar component processes the ENTRY, it performs the following string concatenation to generate the URL:

“http://. . . /hcleip?page=navbarpage&cmd=mark&containerid=”+“1234566543321”+“&tag=”+“1.2.1”

The purpose of including an ACTIVITYDATA element in for an ENTRY is to ensure that a message is logged when the user clicks on the ENTRY. To ensure that this logging takes place, the navbar component prepares a URL for the ENTRY that points to the logging e-clip page. The URL also contains an encoded version of the “real URL” so the logging e-clip may redirect the user to the correct location after performing the necessary logging. For instance:

<ENTRY TAG=”1.2”>

<LABEL>Steve's Sunshine Girl Page</LABEL>
<URL>http://spritzerboy/tanktopbabe.jpg</URL>
<ACTIVITYDATA>I am perving at chicks</ACTIVITYDATA>

</ENTRY>

causes the following URL to be generated:

<URL TARGET=”main_fr”>

http://.../hcleip?page=logthis&msg=
I%20am%20perving%20at%20chicks&realURL=http%3A%2
F%2Fspritzerboy%2Ftanktopbabe%2Ejpg

</URL>

Data access components are responsible for obtaining data for the NavBar. They are portal components and extend PortalComponent. Data access components are instantiated and called by the navbar component. The navbar component calls the methods of the data access component just as the e-clip manager would. They are passed the navigation bar XML Request Datagram and the NavBarURL that was registered for the application in the repository.

A generic data access component, com.hcl.portal.httpdac is provided. If an application exposes an HTTP interface, accepts XML conforming to the Navigation Bar Request DTD and returns a response conforming to the Navigation Bar Response DTD, the generic component is sufficient. The generic data access component extracts the NavBarURL from its request, posts the Navigation Bar request to the NavBarURL, and returns the response.

For some applications the generic component's functionality may not suffice and a custom data access component may be written and registered with the application in the repository. Such components extend PortalComponent, expect a navigation bar request datagram and the contents of NavBarURL for the application, and return a navigation bar response datagram.

As an alternative to writing custom data access components, back-end application developers are encouraged to use the generic data access component and to write a servlet, isapi dil, ASP page, and the like that is able to accept the navbar request datagram and return the data as a navbar response datagram.

The following functions facilitate concurrent data retrieval. Navigation request packets and threads are generated for each data source. On each thread, data access components are created. A request is made and the results are waited upon. The results are added to an XML tree via a synchronized access method. A completed thread is set to isFinished and can destructed or self-destructive. The main thread will periodically check the completion state of the threads it initialized until all are complete or a timeout elapses.

The Tree Rendition component is capable of rendering a tree. It is aware of browser types and portal themes. It does not need to know anything about the data it is rendering.

The Tree Rendition component has slightly different data requirements than does the navbar component, and consequently a few variations on the navigation bar response DTD are required. These differences are highlighted below.

Each ENTRY has a sub-element called ICON, which contains the file name of the image file to use for the node. The file is present in an image directory that is known to the Tree Rendition component.

Each ENTRY has one or more sub-elements called URL. The first of these is the URL that is invoked when a user clicks on the label for a node. If multiple URLs are present, they may be displayed as a context menu or via some other means, depending on browser capabilities. If multiple URLs are present, the LABEL attribute of the URL is used as the text for the link. The first URL is the default link.

Each ENTRY has a GLOBALTAG that identifies it uniquely in the tree. This GLOBALTAG is passed back to the parent e-clip page in a request for an expansion or collapse.

Each ENTRY has a STATE attribute to indicate whether the node is displayed as collapsed or expanded. Some renditions may only render the tree from the root down to the collapsed nodes. Other renditions may render the entire tree, with sections beyond the collapsed nodes initially invisible, but delivered to the client and available without making a round trip to the server.

Each ENTRY has a HASCHILDREN attribute to indicate whether or not a node has children. The value of this attribute indicates to the TreeRendition component whether or not a “plus” icon should precede the node in the tree. Note that this attribute can be set and provided to the TreeRendition component in such a way that all nodes are assumed to have children until an expansion is performed.

Given an XML tree conforming to the Tree Rendition DTD, the Tree Rendition component generates an HTML response. The TreeRendition component is also capable of formatting an error as HTML for output to the browser. Alternately, this function could be handled by another component in the component chain of the e-clip.

TreeRendition DTD

The following DTD defines the expected input to the TreeRendition component. This DTD allows for two distinct types of input, an XML tree to be rendered as HTML and an Error Description.

ENTRY

An ENTRY corresponds to a node in the tree. Note that the attribute list for an ENTRY allows the optional inclusion of a TAG, which is extraneous data as far as TreeRendition is concerned. This has been done so that the components providing data to the TreeRendition component need not strip out this data prior to providing an XML tree to TreeRenditon.

Element ENTRY

| Purpose: | Defines the a node in the tree | |
|---|---|---|
| Allowable sub-elements: | | (LABEL?, ICON?, TOOLTIP?, URL*, ENTRY*) |
| Attributes: | Name: | GLOBALTAG |

| | |
|---|---|
| Description: | A tag which uniquely describes |

the entry in the tree.

| | |
|---|---|
| Type: | CDATA |
| Default: | Required |

| | |
|---|---|
| Name: | STATE |
| Description: | Indicates whether the node |

should be displayed as
expanded or collapsed.

| | |
|---|---|
| Type: | EXPANDED \| COLLAPSED |
| Default: | Required |

| | |
|---|---|
| Name: | HASCHILDREN |
| Description: | Indicates whether an expansion |

icon should be placed in front
of the node when collapsed.

| | |
|---|---|
| Type: | TRUE \| FALSE |
| Default: | Required |

| | |
|---|---|
| Name: | VOLATILE |
| Description: | Indicates that the entry and |

its children are likely to
change frequently. Collapse
operations on this node
should cause cached children
to be discarded.

| | |
|---|---|
| Type: | CDATA |
| Default: | Implied |

| | |
|---|---|
| Name: | TAG |
| Description: | Not required and not used. |

Allowable so that a
component providing data
need not strip out this
information.

| | |
|---|---|
| Type: | CDATA |
| Default: | Implied |

Element LABEL

| | |
|---|---|
| Purpose: | A human readable label for the entry. |
| Sub-elements: | #PCDATA |
| Attributes: | None |

Element ICON

| Purpose: | | The file name to an icon to display for |
|---|---|---|
| | | this node. The TreeRendition component |
| | | uses this file name to construct a URL, |
| | | based on the current rendition and portal theme. |
| Sub-elements: | #PCDATA | |
| Attributes: | Name: | WIDTH |

| | |
|---|---|
| Description: | The override width attribute |

for the image. Corresponds to
the WIDTH attribute of the
HTML IMG tag. Maybe be expressed
as nn pixels or nn% for percentage
length. If not specified, no width
attribute is specified for the
HTML IMG tag.

| | |
|---|---|
| Type: | CDATA |
| Default: | Implied |

| Name: | HEIGHT |
|---|---|
| Description: | The override height attribute for |
| | the image. Corresponds to the HEIGHT |
| | attribute of the HTML IMG tag. Maybe |
| | be expressed as nn pixels or nn% for |
| | percentage length. If not specified, |
| | no height attribute is specified |
| | for the HTML IMG tag. |
| Type: | CDATA |

| | |
|---|---|
| Default: | Implied |

Element TOOLTIP

| | |
|---|---|
| Purpose: | A descriptive Windows-style tooltip which describes the entry. |
| Sub-elements: | #PCDATA |
| Attributes: | None |

Element URL

| Purpose: | A URL that references some action to be taken for the entry. | |
|---|---|---|
| Sub-elements: | #PCDATA | |
| Attributes: | Name: | LABEL |

| | |
|---|---|
| Description: | A tooltip or status bar message |

to display for the link. If
multiple URLs are present, this
may be displayed as the label
in a context menu.

| | |
|---|---|
| Type: | CDATA |
| Default: | Required |

| | |
|---|---|
| Name: | TARGET |
| Description: | The name of the frame the link |

will be targeted to.

| | |
|---|---|
| Type: | CDATA |
| Default: | Required |

DTD
<!--
# Name: hcleip_treerendition_V1.dtd
# Description: DTD for TreeRendition component
# Version: 1.0
# Language: English
# Organization: Hummingbird Communications Ltd.
# Date: August 23, 1999
− −>
<!ENTITY % BOOLEAN “(TRUE | FALSE)”>
<!ENTITY % INTEGER “CDATA”>
<!ENTITY % PERCENTAGE “CDATA”>
<!ENTITY % NODESTATE “(EXPANDED | COLLAPSED)”>
<!ENTITY % REQSTATUS SYSTEM “hcleip_reqstatus_V1.dtd”>
%REQSTATUS;
<!ELEMENT TREERENDITION (ENTRY | ERROR)>
<!ELEMENT ENTRY (LABEL?, ICON?, TOOLTIP?, URL*, ENTRY*)>
<!ATTLIST ENTRY

| | | |
|---|---|---|
| GLOBALTAG | CDATA | #REQUIRED |

| | | |
|---|---|---|
| STATE | %NODESTATE; | #REQUIRED |

| | | |
|---|---|---|
| HASCHILDREN | %BOOLEAN; | #REQUIRED |

| | | |
|---|---|---|
| VOLATILE | %BOOLEAN; | #IMPLIED |

| | | |
|---|---|---|
| TAG | CDATA | #IMPLIED |

>
<!ELEMENT LABEL (#PCDATA)>
<!ELEMENT ICON (#PCDATA)>
<!ATTLIST ICON

| | | |
|---|---|---|
| WIDTH | CDATA | #IMPLIED |
| HEIGHT | CDATA | #IMPLIED |

>
<!ELEMENT TOOLTIP (#PCDATA)>
<!ELEMENT URL (#PCDATA)>
<!ATTLIST URL

| | | |
|---|---|---|
| LABEL | CDATA | #REQUIRED |
| TARGET | CDATA | #REQUIRED |

>
Examples
<!DOCTYPE TREERENDITION SYSTEM “hcleip_treerendition_V1.DTD”>
<TREERENDITION>
<ERROR CODE=“NOAUTH” REASON=“No soup for you!”/>
</TREERENDITION>
<!DOCTYPE TREERENDITION SYSTEM “hcleip_treerendition_V1.DTD”>
<TREERENDITION>
<ENTRY GLOBALTAG=“1” STATE=“EXPANDED” HASCHILDREN=“TRUE”>

<LABEL>Today's Menu</LABEL>
<ICON WIDTH=“16” HEIGHT=“16”>menu.gif</ICON>
<URL LABEL=“Today's Menu” TARGET=“main_fr”>

http://members.aol.com/rynocub/soupnazi.htm

</URL>
<ENTRY GLOBALTAG=“1.1” STATE=“COLLAPSED” HASCHILDREN=“FALSE” TAG=“4-2”>

<LABEL>Mulligatawny</LABEL>
<ICON>mullig.gif</ICON>

<URL LABEL=“Kiss someone in the line” TARGET=“main_fr”>

nosoup.htm

</URL>
<URL LABEL=“Order soup, put money on counter, move to left”
TARGET=“main_fr”>

muligatawny.htm

</URL>
<URL LABEL=“Move to right and order soup, say por favor nicely”
TARGET=“main_fr”>

Por_favor_Adios_Muchacho.htm

</URL>
<URL LABEL=“Take soup, check to see if you got bread, say ‘Bread, beautiful’”
TARGET=“main_fr”>

yourepushingyourlucklittleman.htm

</URL>

</ENTRY>

</ENTRY>
</TREERENDITION>

The following section describes a method for populating an enterprise information portal (“EIP”) system's navigation bar with items from an integrated application is described. In general, communications between an EIP system's navigation bar and an underlying component application are conducted by “XML datagrams”. An XML datagram is a packet of control information (i.e. either a request or a response) used to communicate between a client and server or between a server and server, encoded in XML, and adhering to a well-defined document type definition (“DTD”). A navigation bar may be considered to be an EIP system “plugin” or module. Each plugin type will typically have its own set of request/response XML datagram pairs. Therefore, in order to allow for the use of validating XML parsers, each request type and response type must have its own well thought out DTD. Such DTDs are provided by the invention.

In particular, to allow the navigation bar to be populated with hierarchical or “tree-like” data elements or fragments from an integrated application, the DTDs and XML datagrams of the method described herein have the following unique features and advantages:

1. Support the premise that all applications have some (perhaps simple) navigable structure.

2. Applications contribute hierarchical or tree like data elements or fragments that are “plugged in” to the navigation bar.

3. Allow for on-demand retrieval of tree fragments during depth navigation.

4. Items are tagged with unique class Ids to allow for differences in display or action in the navigation bar.

5. Items are tagged as browsable or searchable (or both).

6. Items tagged as type “browsable” or type “both” will have their supplied URL invoked if a user clicks on them.

7. Items tagged as type “searchable” or type “both” will be able to participate in a search as a data source (represented by their supplied TAG attribute).

In general, the DTDs and XML datagrams of the method described herein have the following unique features and advantages:

1. Generalization. It is general enough to be used effectively by component applications and contains a minimum of application specific encoding.

2. Well Bounded. Element rules are well defined in order to minimize post-parsing effort required.

3. Character Set Encoding. Character encoding is via UTF-8.

4. Navigation Bar DTDs. Communications between the navigation bar EIP plugin and an underlying integrated application takes place using a transactional request/response methodology. Both the request from the plugin to the application and the response from the application to the plugin are encoded in XML using a well-defined DTD. These are referred to as XML datagrams.

5. Controlling Session. Application sessions are controlled outside of navigation bar requests and responses using their own session control datagrams. A session (where required by an application) will be established at user login time, and destroyed at user logoff time (either deliberately or as the result of a timeout). Global sessions are used to more easily control groups of user application sessions. With the first request to an application, the plugin (again, where session is required by an application) will establish a global session. Subsequent requests for user sessions will reference the established global session. The plugin may then control all user sessions via the global session (e.g. DESTROY, KEEPALIVE, etc.). Applications requiring a session ensure that where a session ID is required to access a resource referenced by a URL in the navigation bar response datagram, it is encoded in the URL and is returned as part of the datagram.

6. Entry Class IDs. Class ID's are attached to each entry in a navigation bar response datagram. Class ID's permit the navigation bar plugin to take a special action for a particular known class of entry. For Class ID's to be used in any meaningful manner, they must be defined at both the application and navigation bar plugin levels.

7. Adhering to Requests. Applications responding to navigation bar request datagrams may exceed limits stated in the request. For example, a request for a maximum depth in a tree type response may exceed the number of levels requested if, in the application's judgement, it would be more efficient to do so.

8. Returning Request Status in the Absence of Data. A component application may sometimes need to return a response to a request from a Portal Plugin where no data is available to return (e.g. an error occurred). The component application should make use of the REQSTATUS DTD to accomplish this.

9. Location of DTDs. DTDs are be distributed (or made available) to all validating XML parsers.

10. Validation of DTDs. Using a well-defined DTD allows for simpler post-parsing code to be written. The DTD itself, however, is validated in much the same way as an application protocol interface (“API”). To validate a DTD, XML files are written for each valid and non-valid case defined in the DTD, and a simple parser must be run on each of these files testing simply that valid XML files are successfully parsed and invalid XML files are not.

According to another aspect of the invention, an EIP system is described. This EIP system has stored therein data representing sequences of instructions which when executed cause the above described method and to be performed.

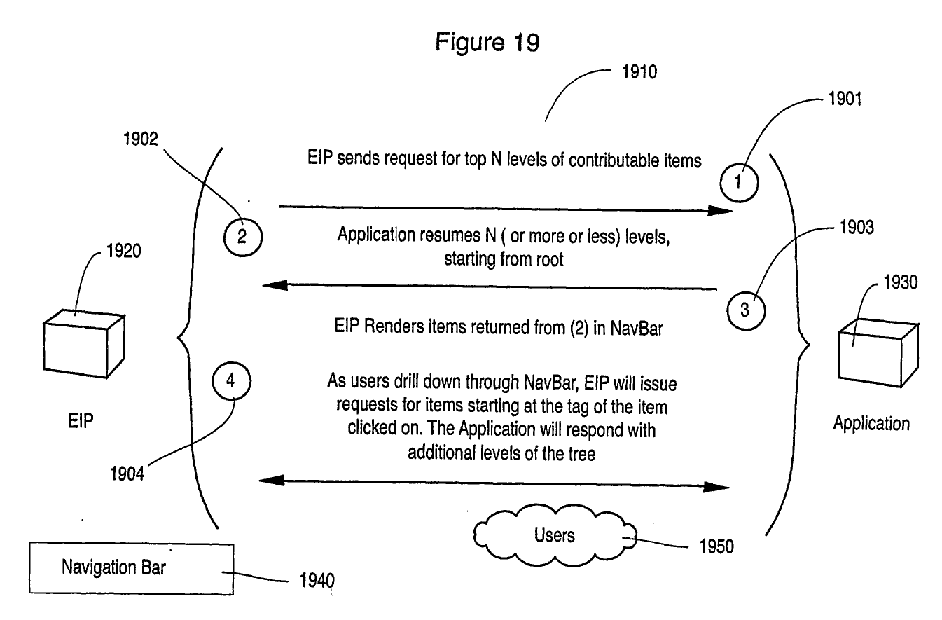

FIG. 19 illustrates the method steps 1910 for populating an EIP system's 1920 navigation bar 1940 with items from an integrated application 1930.

At step 1901, the EIP system 1920 sends a request to the integrated application 1930 for the top N levels of hierarchical or tree-like data elements or fragments which are to be contributed to the EIP system's navigation bar 1940, where N is an integer. This navigation bar request has a DTD and XML datagram (i.e. request) associated with it. The DTD and XML datagram may be referred to as “NAVREQ”. It consists of two primary elements which are defined as follows:

Information about the user issuing the request (“IDENTITY”), which is required.

Controlling information for the application's response (“ITEMINFO”), which is optional.

Now, the IDENTITY primary element contains authenticating information for the request. Authentication must be in the form of a ticket (“TICKET”) or user ID/password/domain style credentials (“KEYS”) or an indication that the request should be made as the anonymous user (“ANONYMOUS”). In addition, the IDENTITY element may contain information regarding an existing session (“SESSION”) and application specific configuration information (“CFGINFO”). The characteristics of each of these elements are listed below.

Element IDENTITY

| | |
|---|---|
| Purpose: | Provide information about the user issuing the request |
| | including, but not limited to, authentication information. |

Allowable sub-elements: ((KEYS | TICKET | ANONYMOUS),
SESSION?)

| | | |
|---|---|---|
| Attributes: | Name: | USERAGENT |
| | Description: | Contains the USER AGENT field re- |
| | | trieved from HTTP requests from the |
| | | user's browser. Used by the application |
| | | to target specific browsers. |
| | Type: | CDATA |
| | Default: | Required |
| | Name: | LANGUAGE |
| | Description: | Specifies the (human) language to be used |
| | | for the session. |
| | Type: | (CDATA) Two character ISO abbreviation |
| | | for language. |
| | Default: | en |
| | Name: | COUNTRY |
| | Description: | Specifies the country information to be |
| | | used for the session. |
| | Type: | (CDATA) Two character ISO abbreviation |
| | | for country. |
| | Default: | US |

Element KEYS

| Purpose: | Allows a user id/password/domain set to be passed to the | |
|---|---|---|
| | server in order to perform authentication on the re- | |
| | quested search. The KEYS element may contain child | |
| | KEYS elements in order to allow for multiple key sets | |
| | to be passed to an application handler. | |
| Sub-elements: | KEYS* | |
| Attributes: | Name: | USERID |
| | Description: | The textual user id. |
| | Type: | CDATA |
| | Default: | Required |
| | Name: | PASSWORD |
| | Description: | The textual password. |
| | Type: | CDATA |
| | Default: | Required |
| | Name: | QUALIFIER |
| | Description: | A qualifier to determine where USERID & |
| | | PASSWORD are valid. For Windows NT, |
| | | this would be the Domain. |
| | Type: | CDATA |
| | Default: | Implied |
| | Name: | NAME |
| | Description: | An optional differentiator for KEYS. For |
| | | example, NAME = “MSX” to signify |
| | | Microsoft Exchange credentials. |
| | Type: | CDATA |
| | Default: | Implied |
| Example: | <KEYS userid = “cam.stevenson” | |
| | password = “notmypassword” qualifier = “ottawa”/> | |
| Element | TICKET | |
| Purpose: | Specifies a ticket provided by the CAP. The TICKET | |
| | element may contain child KEYS elements in order to | |
| | allow for multiple key sets to be passed to an appli- | |
| | cation handler. Note that since TICKET accepts character | |
| | data (#PCDATA) as well as optional KEYS, that the | |
| | allowable sub-elements becomes ANY to satisfy XML | |
| | requirements on mixed model sub-elements. | |
| Sub-elements: | ANY | |
| Atiributes: | NONE | |
| Example: | <TICKET>{someticketdata}</TICKET> | |
| Element | ANONYMOUS | |
| Purpose: | Specifies that this transaction should take place in the | |
| | context of the anonymous user. The ANONYMOUS | |
| | element may contain child KEYS elements in order to | |
| | allow for multiple key sets to be passed to an applica- | |
| | tion handler. | |
| Sub-elements: | KEYS* | |
| Attributes: | NONE | |
| Example: | <ANONYMOUS/> | |
| Element | SESSION | |
| Purpose: | Provides a reference to an established session. | |
| Sub-elements: | CFGINFO | |
| Attributes: | Name: | ID |
| | Description: | An established application session ID. |
| | Type: | CDATA |
| | Default: | Implied |

| | |
|---|---|
| Example: | <SESSION ID = “{01234-57432}”/> |
| Element | CFGINFO |
| Purpose: | Provides a location for the transmission of application |
| | specific configuration information. |
| Sub-elements: | #PCDATA |
| Attributes: | NONE |
| Example: | <CFGINFO>some coufig info</CFGINFO> |

The ITEMINFO primary element allows some control over the amount of data returned by the application, and the starting point from which the information should be returned. If ITEMINFO is not specified in the EIP system's 1920 navigation bar request datagram at step 1901, the application 1930 shall assume that it should return its entire tree structure starting from the root. The characteristics of these elements are listed below.

| Element | ITEMINFO | |
|---|---|---|
| Purpose: | Allows control over data returned by application | |
| Allowable | None | |
| sub-elements: | | |
| Attributes: | Name: | STARTTAG |
| | Description: | A tag from which to begin retrieving data. |
| | | If STARTTAG is not specified, the root |
| | | node is implied. |
| | Type: | CDATA |
| | Default: | Implied |
| | Name: | MAXDEPTH |
| | Description: | The maximum depth of the tree which the |
| | | application should return (advisory only). |
| | | If MAXDEPTH is not specified, the entire |
| | | tree starting from STARTTAG is implied. |
| | Type: | % INTEGER; |
| | Default | Implied |
| | Name: | INCLUDESELF |
| | Description: | If TRUE, the application should include |
| | | the node referenced by STARTTAG in its |
| | | response. If FALSE, the node referenced |
| | | by STARTTAG should not be included. |
| | Type: | % BOOLEAN; |
| | Default | FALSE |

For example, the following is the DTD code for a navigation bar request (i.e. “NAVREQ”).

<!--

| | |
|---|---|
| # Name: | hcleip_navreq_V1.dtd |
| # Description: | DTD for XML based datagrams - request for NavBar |
| # | contribution |
| # Version: | 1.2 |
| # Organization: | Hummingbird Communications Ltd. |
| # Date: | November 14, 1999 |
| −> | |
| <!-- | |

| # | Changes since 1.1: |
|---|---|
| # | |
| # | |
| # | <KEYS>, <TICKET> and <ANONYMOUS> can accept sub <KEY> elements |
| # | <KEYS> may have new attribute NAME |
| # | |
| # | Changes since 1.0: |
| # | |
| # | Add INCLUDESELF attribute on ITEMINFO |

| | |
|---|---|
| # | Semantic definition: include the node |
| # | referenced by STARTTAG in the response. |

#

− −>

| | | |
|---|---|---|
| <!ENTITY | % BOOLEAN | “(TRUE \| FALSE)”> |
| <!ENTITY | % INTEGER | “CDATA”> |
| <!ENTITY | % SESSCTL | “(ESTABLISH \| DESTROY)”> |

<!ELEMENT NAVREQ (IDENTITY, ITEMINFO?)>
<!ELEMENT IDENTITY ((KEYS | TICKET | ANONYMOUS), SESSION?)>
<!ATTLIST IDENTITY

| | | |
|---|---|---|
| USERAGENT | CDATA | #REQUIRED |
| LANGUAGE | CDATA | “en” |
| COUNTRY | CDATA | “US” |

>
<!ELEMENT KEYS (KEYS*)>
<!ATTLIST KEYS

| | | |
|---|---|---|
| USERID | CDATA | #REQUIRED |
| PASSWORD | CDATA | #REQUIRED |
| QUALIFIER | CDATA | #IMPLIED |
| NAME | CDATA | #IMPLIED |

>
<!--

# TICKET accepts multiple KEYS and #PCDATA for the ticket itself
# unfortunately this is not expressable in XML so we use the
# ANY element for allowable children

− −>
<!ELEMENT TICKET ANY>
<!ELEMENT ANONYMOUS (KEYS*)>
<!ELEMENT SESSION (CFGINFO)?>
<!ATTLIST SESSION

| | | |
|---|---|---|
| ID | CDATA | #IMPLIED |

>
<!ELEMENT CFGINFO (#PCDATA)>
<!ELEMENT ITEMINFO EMPTY>
<!ATTLIST ITEMINFO

| | | |
|---|---|---|
| STARTTAG | CDATA | #IMPLIED |
| INCLUDESELF | %BOOLEAN; | “FALSE” |
| MAXDEPTH | %INTEGER; | #IMPLIED |

>

Consider the following two additional examples. First, to retrieve up to two levels of data from the application's “tree”, starting at a tag “1.1”, no session would be involved, and the “NAVREQ” datagram would be as follows:

<?xml version=‘1.0’ encoding=‘utf-8’ ?>
<!DOCTYPE NAVREQ SYSTEM “hcleip_navreq_V1.dtd”>
<NAVREQ>

<IDENTITY USERAGENT=“IE4.0xxxxx”>

<KEYS USERID=“cam. stevenson” PASSWORD=“foobar”
QUALIFIER=“ottawa”/>

</IDENTITY>
<ITEMINFO STARTTAG=“1.1” MAXDEPTH=“2”/>

</NAVREQ>

Second, to retrieve one level of the application's “tree”, starting from the root, an established reference “SESSION” reference would be supplied, and the “NAVREQ” datagram would be as follows:

<?xml version=‘1.0’ encoding=‘utf-8’ ?>
<!DOCTYPE NAVREQ SYSTEM “hcleip_navreq_V1.dtd”>
<NAVREQ>

<IDENTITY USERAGENT=“IE4.0xxxxx”>

<TICKET>{abc123}</TICKET>
<SESSION ID=“{812312312312}”/>

</IDENTITY>

<ITEMINFO MAXDEPTH=“1”/>

</NAVREQ>

Referring to FIG. 19, at step 1902, the application 1930 responds to the EIP system's 1920 request and provides the N (or more or less) levels of hierarchical or tree-like data elements or fragments to be contributed to the EIP system's navigation bar 1940. This navigation bar response has a DTD and XML datagram (i.e. response) associated with it. The DTD and XML datagram may be referred to as “NAVRESP”. It consists of three primary elements which are defined as follows:

Information regarding the response (“APPINFO”), which is optional.

Information regarding the session (“SESSION”), which is optional.

The response data (“ENTRY”), which is required.

Now, the APPINFO primary element provides information to the caller regarding the application, the SESSION primary element allows an application to pass a new session ID back to the caller, and the ENTRY primary element describes the data being returned as the application's contribution to the EIP system's navigation bar. Note that the ENTRY element may contain sub-elements in order to present the tree structure. ENTRYs which are to be used for searching must be marked as such by setting the “TYPE” sub-element to “SEARCH”. ENTRYs which are to be used only for navigation purposes must be marked as such by setting the “TYPE” sub-element to “NAVIGATE”. ENTRYs which are to be used for both searching and navigation purposes must be marked by setting the TYPE sub-element to “BOTH”. Each ENTRY may contain one or more “URL” or “APPDATA” sub-elements. The characteristics of each of these elements are listed below.

| Element | APPINFO | |
|---|---|---|
| Purpose: | Provide information about the application to caller. | |
| Allowable sub-elements: | NONE | |
| Attributes: | Name: | APPID |
| | Description: | A tag which uniquely describes the application. |
| | Type: | CDATA |
| | Default: | Required |
| | Notes: | This must be the “root class” of classes specified using the |
| | | CLASSID attribute of the ENTRY element |
| Element | SESSION | |
| Purpose: | Provides a reference to a new, established, session. | |
| Sub-elements: | CFGINFO | |
| Attributes: | Name: | ID |
| | Description: | A new application session ID. |
| | Type: | CDATA |
| | Default: | Required |

| | |
|---|---|
| Element | ENTRY |
| Purpose: | Provide the application's contribution to the portal navigation bar. |

Allowable sub-elements: (LABEL?, ACTIVITYDATA?, TOOLTIP?, (URL | APPDATA)*, ENTRY*)

| Attributes: | Name: | TAG |
|---|---|---|
| | Description: | A tag which uniquely describes the entry. |
| | Type: | CDATA |
| | Default: | Required |
| | Name: | CLASSID |
| | Description: | A unique descriptor identifying the type of this ENTRY element. |
| | | This descriptor is tightly coupled with the NavBar Plugin. |
| | Type: | CDATA |
| | Default: | Implied |
| | Name: | TERMINAL |
| | Description: | An indication to the caller that the entry contains no children. |
| | Type: | %BOOLEAN; |
| | Default: | FALSE |
| | Name: | VOLATILE |
| | Description: | An indication to the caller that the entry and its children are |
| | | likely to change frequently. |
| | Type: | %BOOLEAN; |
| | Default | FALSE |
| | Name: | TYPE |
| | Description: | The type of the ENTRY, either SEARCH (the entry should be |
| | | used for searching), NAVIGATE (the entry should be used |
| | | for navigation/browsing) or BOTH. |
| | Type: | (SEARCH \| NAVIGATE \| BOTH) |
| | Default: | NAVIGATE |

| | |
|---|---|
| Element | LABEL |
| Purpose: | A human readable label for the entry. |
| Sub-elements: | #PCDATA |
| Attributes: | NONE. |
| Example: | <LABEL> |

Results of Agent 1

| | </LABEL> |
|---|---|
| Element | ACTIVITYDATA |
| Purpose: | A piece of information that can be used to log the context of an action |
| | taken by the user for the entry. |
| Sub-elements: | #PCDATA |
| Attributes: | NONE. |
| Example: | <ACTIVITYDATA> |

AGENT=1 QUERY=cat+dog RESULTS=123

| | </ACTIVITYDATA> |
|---|---|
| Element | TOOLTIP |
| Purpose: | A descriptive Windows-style tooltip which explains the entry. |
| Sub-elements: | #PCDATA |
| Attributes: | NONE. |
| Example: | <TOOLTIP> |

Click here to display the results of agent 1.

| | </TOOLTIP> | |
|---|---|---|
| Element | URL | |
| Purpose: | A URL that references some action to be taken for the entry. | |
| Sub-elements: | #PCDATA | |
| Attributes: | Name: | DISPOSITION |
| | Description: | An indication of how the portal should display data |
| | | resulting from the use of the URL. |
| | Type: | INFRAME \| NEWWINDOW |
| | Default: | Implied |
| | Notes: | DISPOSITION can be one of the following: |
| | | INFRAME - The portal should display the |
| | | data in a separate frame. |
| | | NEWWINDOW - The portal should display |
| | | the data in a new window. |
| | | If neither INFRAME nor NEWWINDOW is specified, the |
| | | plugin will make its own decision as to the best way |
| | | to display the information returned from URL. |
| | Name: | NAME |
| | Description: | The name of the URL. Used to differentiate between |
| | | multiple URL elements. This is not necessarily a |
| | | human readable value. |
| | Type: | CDATA |
| | Default: | Implied |
| | Name: | LABEL |
| | Description: | A human readable label for the URL. For example “View |
| | | Document as HTML”. |
| | Type: | CDATA |
| | Default: | Implied |

| | |
|---|---|
| Example: | <URL DISPOSITION=”NEWWINDOW”> |

http://elmo/webfind/default.asp

| | </URL> | |
|---|---|---|
| Element | APPDATA | |
| Purpose: | Provide application specific data to the NavBar Plugin which cannot be | |
| | provided through the use of the URL element. Use of this element is | |
| | tightly coupled with the NavBar Plugin tree control. | |
| Sub-elements: | #PCDATA | |
| Attributes: | Name: | NAME |
| | Description: | A unique name for this piece of application specific data. |
| | Type: | CDATA |
| | Default | Required |

| | |
|---|---|
| Example: | <APPDATA NAME=”AgentID”> |

17215

</APPDATA>

For example, the following is the DTD code for a navigation bar request (i.e. “NAVRESP”).

<!--

| | |
|---|---|
| # Name: | hcleip_navresp_V1.dtd |
| # Description: | DTD for XML based query datagrams - response to nav bar |
| # | contribution request |
| # Version: | 1.3 |
| # Organization: | Hummingbird Communications Ltd. |
| # Date: | November 12, 1999 |
| − −> | |
| <!-- | |

| # | |
|---|---|
| # | Changes since 1.2: |
| # | |
| # | Changed: |
| # | |
| # | ENTRY URL/APPDATA elements changed to * from + |
| # | |
| # | Changes since 1.1: |
| # | |
| # | Changed: |
| # | |
| # | ENTRY may have multiple URL and/or APPDATA elements |
| # | |
| # | Added: |
| # | |
| # | URL now has optional NAME and LABEL attributes |

| | |
|---|---|
| # | Semantic defintion: NAME is an identifier for machine |
| # | based identification (e.g. NAME=“HELP”). NAME must |
| # | be negotiated bewteen the consumer and producer of |
| # | the NAVRESP datagram. LABEL is |
| # | a human-readable label for the URL |
| # | |

| | |
|---|---|
| # | Changes since 1.0: |
| # | Added: |
| # | TYPE attribute on ENTRY element |

| | |
|---|---|
| # | Semantic definition: Defines whether |
| # | the entry can be used as a data source |
| # | specification in a search (SEARCH), should |
| # | be used to populate the NavBar (NAVIGATE) |
| # | or both (BOTH). Default type is NAVIGATE |
| # | which is the current behavior |
| # | |
| # | |

− −>
<!ENTITY % BOOLEAN “(TRUE | FALSE)”>
<!ENTITY % INTEGER “CDATA”>
<!ENTITY % URLDISP “(INFRAME | NEWWINDOW)”>
<!ENTITY % ENTRYTYPE “(SEARCH | NAVIGATE | BOTH)”>
<!ELEMENT NAVRESP (APPINFO?, SESSION?, ENTRY+)>
<!ELEMENT APPINFO EMPTY>
<!ATTLIST APPINFO

| | | |
|---|---|---|
| APPID | CDATA | #IMPLIED |

>
<!ELEMENT SESSION EMPTY>
<!ATTLIST SESSION

| | | |
|---|---|---|
| ID | CDATA | #REQUIRED |

>
<!ELEMENT ENTRY (LABEL?, ACTIVITYDATA?, TOOLTIP?, (URL | APPDATA)*, ENTRY*)>
<!ATTLIST ENTRY

| | | |
|---|---|---|
| TAG | CDATA | #REQUIRED |
| CLASSID | CDATA | #IMPLIED |
| TERMINAL | %BOOLEAN; | “FALSE” |
| VOLATILE | %BOOLEAN; | “FALSE” |
| TYPE | %ENTRYTYPE; | “NAVIGATE” |

>
<!ELEMENT LABEL (#PCDATA)>
<!ELEMENT URL (#PCDATA)>
<!ATTLIST URL

| | | |
|---|---|---|
| DISPOSITION | %URLDISP; | #IMPLIED |
| NAME | CDATA | #IMPLIED |
| LABEL | CDATA | #IMPLIED |

>
<!ELEMENT APPDATA (#PCDATA)>
<!ATTLIST APPDATA

| | | |
|---|---|---|
| NAME | CDATA | #REQUIRED |

>
<!ELEMENT ACTIVITYDATA (#PCDATA)>
<!ELEMENT TOOLTIP (#PCDATA)>

As an additional example, the following is a “NAVRESP” datagram:

<?xml version=‘1.0’ encoding=‘utf-8’ ?>
<!DOCTYPE NAVRESP SYSTEM “hcleip_navresp_V1.dtd”>
<NAVRESP>

<SERVINFO APPID= “HCL.FULCRUM”/>
<ENTRY TAG=“1”>

<LABEL>Agent Results</LABEL>
<ENTRY TAG=“1.0”>

<LABEL>Results of agent 1</LABEL>
<URL>http://elmo/dfxml/getdoc.asp?0123841724</URL>

</ENTRY>
<ENTRY TAG=“1.1”>

<LABEL>Results of agent 2</LABEL>
<URL>http://elmo/dfxml/getdoc.asp?8468551131</URL>

</ENTRY>
<ENTRY TAG=“1.2”>

<LABEL>Results of agent 3</LABEL>
<URL>http://elmo/dfxml/getdoc.asp?5213665878</URL>

</ENTRY>

</ENTRY>
<ENTRY TAG=“2”>

<LABEL>Launch DOCSFulcrum WebFIND</LABEL>
<URL DISPOSITION=“NEWWINDOW”>

http://elmo/webfind/default.asp

</URL>

</ENTRY>

</NAVRESP>

Referring to FIG. 19, at step 1903, the EIP system 1920 renders the information returned from the application 1930 in its navigation bar 1940. for presentation to the EIP system's 1920 users 1950.

At step 1904, as users 1950 drill down through the navigation bar's 1940 tree-like data, the EIP system 1920 issues further requests to the application 1930 for items starting at the tag of the item that the user selects or clicks on in the navigation bar 1940. The application 1930 will then respond with the additional levels of the tree that are required.

Consider the following two datagram exchange examples. First, a request is made for the first two levels of a tree making use of an established session as follows:

<?xml version=‘1.0’ encoding=‘utf-8’ ?>

<!DOCTYPE NAVREQ SYSTEM “hcleip_navreg_V1.dtd”>
<NAVREQ>

<IDENTITY USERAGENT=”IE4.0xxxxxx”>

<KEYS USERID=“cam.stevenson”
PASSWORD=“foobar”
QUALIFIER=“ottawa”/>

<SESSION ID=”7127312-91283812-83848585”/>

</IDENTITY>
<ITEMINFO MAXDEPTH=“2”/>

</NAVREQ>

Note here that the starting point for the retrieval is at the “top of tree” since the STARTTAG sub-element was not provided in the ITEMINFO element. The response to this datagram would be as follows:

<?xml version=‘1.0’ encoding=‘utf-8’ ?>
<!DOCTYPE NAVRESP SYSTEM “hcleip_navresp_V1.dtd”>
<NAVRESP>

<SERVINFO APPID=“HCL.FULCRUM”/>
<ENTRY TAG=“1”>

<LABEL>Agent Results</LABEL>
<ENTRY TAG=“1.0”>

<LABEL>Results of agent 1</LABEL>
<URL>http://elmo/dfxml/getdoc.asp?0123841724</URL>

</ENTRY>
<ENTRY TAG=“1.1”>

<LABEL>Results of agent 2</LABEL>
<URL>http://elmo/dfxml/getdoc.asp?8468551131</URL>

</ENTRY>
<ENTRY TAG=“1.2”>

<LABEL>Results of agent 3</LABEL>
<URL>http://elmo/dfxml/getdoc.asp?5213665878</URL>

</ENTRY>

</ENTRY>
<ENTRY TAG=“2”>

<LABEL>Launch DOCSFulcrum WebFIND</LABEL>
<URL DISPOSITION=“NEWWINDOW”>

http://elmo/webfind/default.asp

</URL>

</ENTRY>

</NAVRESP>

Now, if a user wished to expand the tree, at element 1.1 for example, the following request would be made, again using and established session:

<?xml version=‘1.0’ encoding=‘utf-8’ ?>
<!DOCTYPE NAVREQ SYSTEM “hcleip_navreq_V1.dtd”>
<NAVREQ>

<IDENTITY USERAGENT=”IE4.0xxxxxx”>

<KEYS USERID=“cam.stevenson” PASSWORD=“foobar”
QUALIFIER=“ottawa”/>

<SESSION ID=”7127312-91283812-83848585”/>

</IDENTITY>
<ITEMINFO STARTTAG=”1.1” MAXDEPTH=“1”/>

</NAVREQ>

The corresponding response would be as follows:

<?xml version=‘1.0’ encoding=‘utf-8’ ?>
<!DOCTYPE NAVRESP SYSTEM “hcleip_navresp_V1.dtd”>
<NAVRESP>

<SERVINFO APPID=“HCL.FULCRUM”/>
<ENTRY TAG=“1.1.1”>

<LABEL>Some other item label (1)</LABEL>
<URL>http://url_to_item_1</URL>

</ENTRY>

<ENTRY TAG=“1.1.2”>

<LABEL>Some other item label (2)</LABEL>
<URL>http://url_to_item_2</URL>

</ENTRY>

<ENTRY TAG=“1.1.3”>

<LABEL>Some other item label (3)</LABEL>
<URL>http://url_to_item_3</URL>

</ENTRY>
<ENTRY TAG=“1.1.4”>

<LABEL>Some other item label (4)</LABEL>
<URL>http://url_to_item_4</URL>

</ENTRY>

</NAVRESP>

The following section describes system level (infrastructure) XML Document Type Definitions (DTDs) for use between the EIP and component applications. These system level DTDs include the Session Control DTD (“SESSIONCTL”) and the Request Status DTD (“REQSTATUS”).

In general, communications between an EIP system's plugins (e.g. navigation bar) and an underlying component application are conducted by “XML datagrams”. An XML datagram is a packet of control information (i.e. either a request or a response) used to communicate between a client and server or between a server and server, encoded in XML, and adhering to a well-defined document type definition (“DTD”). Each plugin type will typically have its own set of request/response XML datagram pairs. Therefore, in order to allow for the use of validating XML parsers, each request type and response type must have its own well thought out DTD. Such DTDs are provided by the exemplary embodiment of the invention.

In particular, the exemplary embodiment has three distinct communication exchange types for communications between an EIP and an integrated application, as follows:

1. Session Control (to establish and maintain active sessions on behalf of a user between EIP and the integrated application).

2. Navigation bar requests/responses (to obtain a hierarchy from the integrated application that should be placed in the EIP navigation bar).

3. Search (perform search and retrieval against an integrated application).

In general, the DTDs and XML datagrams of the method described herein have the following unique features and advantages:

1. Generalization. It is general enough to be used effectively by component applications and contains a minimum of application specific encoding.

2. Well Bounded. Element rules are well defined in order to minimize post-parsing effort required.

3. Character Set Encoding. Character encoding is via UTF-8.

4. Location of DTDs. DTDs are be distributed (or made available) to all validating XML parsers.

5. Validation of DTDs. Using a well-defined DTD allows for simpler post-parsing code to be written. The DTD itself, however, is validated in much the same way as an application protocol interface (“API”). To validate a DTD, XML files are written for each valid and non-valid case defined in the DTD, and a simple parser must be run on each of these files testing simply that valid XML files are successfully parsed and invalid XML files are not.

The Session Control DTD (“SESSIONCTL”) and the Request Status DTD (“REQSTATUS”) will now be described in detail.

The Session Control DTD (SESSIONCTL) is used to request establishment, request termination and to “keep alive” application session instances. For applications that require session, the EIP establishes a “global” application session valid for the life of the portal instance, and a per-user application session valid from user logon time to user logoff time (requested or via timeout).

SESSIONCTL typically contains two elements, “IDENTITY” and “SESSION”. The SESSION element is required. The IDENTITY element is optional since SESSIONCTL is used both to request a session (in which case it is provided) and to return a session ID (in which case it is not required). SESSIONCTL is used for both the request datagram (from the EIP plugin) for session control and the corresponding response datagram from the component application in the case where a new session is established. In all other request cases, the component application should use a datagram encoded using the REQSTATUS DTD to return either “SUCCESS” or an indication of error.

Now, the IDENTITY element contains authenticating information for the request. Authentication must be in the form of a ticket (“TICKET”) or user ID/password/domain style credentials (“KEYS”) or an indication that the request should be made as the anonymous user (“ANONYMOUS”). The SESSION element controls application session instantiation, destruction and periodic renewal. When the EIP is making a request, “REQUEST” (and dependent attributes) must be filled in as appropriate. When a response is returned by a component application, only ID. The SESSION element has a “CFGINFO” sub-element that provides a location for the transmission of application specific configuration information. The characteristics of each of these elements are listed below.

| | |
|---|---|
| Element | IDENTITY |
| Purpose: | Provide authentication information regarding the user |
| | on whose behalf the request is being made. |

Allowable sub-elements: (KEYS | TICKET | ANONYMOUS)

| Attributes: | Name: | USERAGENT |
|---|---|---|
| | Description: | Contains the USER AGENT field re- |
| | | trieved from HTTP requests from the |
| | | user's browser. Used by the application to |
| | | target specific browsers. |
| | Type: | CDATA |
| | Default | Required |
| | Name: | LANGUAGE |
| | Description: | Specifies the (human) language to be used |
| | | for the session. |
| | Type: | (CDATA) Two character ISO abbreviation |
| | | for language. |
| | Default: | en |
| | Name: | COUNTRY |
| | Description: | Specifies the country information to be |
| | | used for the session. |
| | Type: | (CDATA) Two character ISO abbreviation |
| | | for country. |
| | Default: | US |
| Element | KEYS | |
| Purpose: | Allows a user id/password/domain set to be passed to the | |
| | server in order to perform authentication on the re- | |
| | quested search. The KEYS element may contain child | |
| | KEYS elements in order to allow for multiple key sets | |
| | to be passed to an application handler. | |
| Sub-elements: | KEYS* | |
| Attributes: | Name: | USERID |
| | Description: | The textual user id. |
| | Type: | CDATA |
| | Default: | Required |
| | Name: | PASSWORD |
| | Description: | The textual password. |
| | Type: | CDATA |
| | Default: | Required |
| | Name: | QUALIFIER |
| | Description: | A qualifier to determine where USERID & |
| | | PASSWORD are valid. For Windows NT, |
| | | this would be the Domain. |
| | Type: | CDATA |
| | Default: | Implied |
| | Name: | NAME |
| | Description: | An optional differentiator for KEYS. For |
| | | example, NAME = “MSX” to signify |
| | | Microsoft Exchange credentials. |
| | Type: | CDATA |
| | Default | Implied |
| Example: | <KEYS userid = “cam.stevenson” | |
| | password = “notmypassword” qualifier =“ottawa”/> | |
| Element | TICKET | |
| Purpose: | Specifies a ticket provided by the CAP. The TICKET | |
| | element may contain child KEYS elements in order to | |
| | allow for multiple key sets to be passed to an applica- | |
| | tion handler. Note that since TICKET accepts character | |
| | data (#PCDATA) as well as optional KEYS, that the | |
| | allowable sub-elements becomes ANY to satisfy XML | |
| | requirements on mixed model sub-elements. | |
| Sub-elements: | ANY | |
| Attributes: | NONE | |
| Example: | <TICKET>{someticketdata}</TICKET> | |
| Element | ANONYMOUS | |
| Purpose: | Specifies that this transaction should take place in the | |
| | context of the anonymous user. The ANONYMOUS | |
| | element may contain child KEYS elements in order to | |
| | allow for multiple key sets to be passed to an applica- | |
| | tion handler. | |
| Sub-elements: | KEYS* | |
| Attributes: | NONE | |
| Example: | <ANONYMOUS/> | |
| Element | SESSION | |
| Purpose: | Allows control of application session | |
| Allowable | CFGINFO | |
| sub-elements: | | |
| Attributes: | Name: | ID |
| | Description: | Identifier for an established session |
| | Type: | CDATA |
| | Default: | Implied |
| | Name: | REQUEST |
| | Description: | The action to be taken for the application |
| | | session. |
| | Type: | ESTABLISH \| DESTROY \| KEEPALIVE |
| | Default | Implied |
| | Notes: | REQUEST can be one of the following: |
| | | ESTABLISH - Establish a new session. ID |
| | | will not exist in the case where |
| | | SCOPE = “GLOBAL”, but should be set |
| | | to the global session ID where SCOPE = |
| | | “USER”. |
| | | DESTROY - Destroy an established |
| | | session. ID must be valid |
| | | KEEPALIVE - Stop an existing session |
| | | from timing out. ID must be valid. |
| | Name: | TIMEOUT |
| | Description: | Provide an indication to an application |
| | | when it should time out the session if it |
| | | has not received either REQUEST = |
| | | “XEEPALIVE” or any other requests |
| | | which use the session. Expressed in |
| | | minutes. |
| | Type: | % INTEGER; |
| | Default: | Implied. If TIMEOUT is not specified, the |
| | | session will not time out. |
| | Notes: | It is the responsibility of the application |
| | | receiving the request to cause timeout of |
| | | sessions it has created. Also, a timeout on |
| | | the global session should cause all assoc- |
| | | iated user sessions to be destroyed. |
| | Name: | SCOPE |
| | Description: | Describes the scope of the session being |
| | | requested or being acted upon |
| | Type: | (GLOBAL \| USER) |
| | Default: | USER |
| | Notes: | The SCOPE attribute is used to control the |
| | | type of session being requested or acted |
| | | upon. |
| | | SCOPE = “GLOBAL” indicates that a |
| | | global application session is being acted |
| | | upon. |
| | | SCOPE = “USER” indicates that a per- |
| | | user application session is being acted |
| | | upon. Where a component application |
| | | requires session, the plugin will request a |
| | | single global session, and an application |
| | | session for each user as required. |

| | |
|---|---|
| Notes: | The ID attribute should always be specified, except in the |
| | case where SCOPE = “GLOBAL” and REQUEST = |
| | “ESTABLISH” (i.e. the request to establish a global |
| | session). Once a global session has been established, re- |
| | quests to establish individual user sessions should contain |
| | ID, set to the global session ID. |
| Element | CFGINFO |
| Purpose: | Provides a location for the transmission of application |
| | specific configuration information. |
| Sub-elements: | #PCDATA |
| Attributes: | NONE |
| Example: | <CFGINFO>some config info</CFGINFO> |

For example, the following is the DTD code for a session control request (i.e. “SESSIONCTL”).

<!--

| | |
|---|---|
| # Name: | hcleip_sessionctl_V1.dtd |

| # Description: | DTD for XML based datagrams - |
|---|---|
| | session control |

| | |
|---|---|
| # Version: | 1.3 |
| # Organization: | Hummingbird Communications Ltd. |

| # Date: | | November 13, 1999 |
|---|---|---|
| -- > | | |
| <!-- | | |
| | # | |
| | # | Changes since 1.2: |
| | # | |
| | # | REQUEST attribute on SESSION becomes IMPLIED |
| | # | from REQUIRED |
| | # | |
| | # | Changes since 1.1: |
| | # | |
| | # | <KEYS> can accept sub <KEY> elements |
| | # | <KEYS> may have new attribute NAME |
| | # | |
| | # | Changes since 1.0: |
| | # | |
| | # | |
| | # | <IDENTITY> becomes optional on <SESSIONCTL> |
| | # | |

-- >
<!ENTITY % BOOLEAN “(TRUE | FALSE)”>
<!ENTITY % INTEGER “CDATA”>
<!ENTITY % SESSCTL “(ESTABLISH | DESTROY | KEEPALIVE)”>
<!ENTITY % SCOPE “(GLOBAL | USER)”>
<!ELEMENT SESSIONCTL (IDENTITY?, SESSION)>
<!ELEMENT IDENTITY (KEYS | TICKET | ANONYMOUS)>
<!ATTLIST IDENTITY

| | | |
|---|---|---|
| USERAGENT | CDATA | #REQUIRED |
| LANGUAGE | CDATA | “en” |
| COUNTRY | CDATA | “US” |

>
<!ELEMENT KEYS (KEYS*)>
<!ATTLIST KEYS

| | | |
|---|---|---|
| USERID | CDATA | #REQUIRED |
| PASSWORD | CDATA | #REQUIRED |
| QUALIFIER | CDATA | #IMPLIED |
| NAME | CDATA | #IMPLIED |

>
<!--

# TICKET accepts multiple KEYS and #PCDATA for the ticket itself
# unfortunately this is not expressable in XML so we use the
# ANY element for allowable children
-- >

<!ELEMENT TICKET ANY>
<!ELEMENT ANONYMOUS (KEYS*)>
<!ELEMENT SESSION (CFGINFO?)>
<!ATTLIST SESSION

| | | |
|---|---|---|
| ID | CDATA | #IMPLIED |

| | | |
|---|---|---|
| REQUEST | %SESSCTL; | #IMPLIED |
| TIMEOUT | %INTEGER; | #IMPLIED |
| SCOPE | %SCORE; | “USER” |

>

Consider the following four additional examples. First, to establish a global session, the plugin would send the following “SessionCTL” datagram:

<?xml version=‘1.0’ encoding=‘utf-8’ ?>
<!DOCTYPE SESSIONCTL SYSTEM “hcleip_sessionctl_V1.dtd”>
<SESSIONCTL>

<IDENTITY USERAGENT=”IE4.0xxxxx”>

<KEYS USERID=“the_portal_user” PASSWORD=“foobar”

QUALIFIER=“ottawa”/>

</IDENTITY>
<SESSION REQUEST=”ESTABLISH”SCOPE=”GLOBAL”/>

</SESSIONCTL>

On success, the component application would send the following datagram:

<?xml version=‘1.0’ encodings=‘utf-8’ ?>
<!DOCTYPE SESSIONCTL SYSTEM “hcleip_sessionctl_V1.dtd ”>
< SESSIONCTL >

<SESSION ID=”{82371923871298312}”/>

</ SESSIONCTL >

Second, to keep a global session alive, the plugin would send the following datagram:

<?xml version=‘1.0’ encoding=‘utf-8’ ?>
<!DOCTYPE SESSIONCTL SYSTEM “hcleip_sessionctl_V1.dtd”>
<SESSIONCTL>

<IDENTITY USERAGENT=”IE4.0xxxxx”>

<KEYS USERID=“the_portal_user” PASSWORD=“foobar”

QUALIFIER=“ottawa”/>

</IDENTITY>
<SESSION ID=”the_global_session_id”
REQUEST=”KEEPALIVE”/>

</SESSIONCTL>

On success, the component application would send the following datagram:

<?xml version=‘1.0’ encoding=‘utf-8’ ?>
<!DOCTYPE REQSTATUS SYSTEM “hcleip_reqstatus_V1.dtd”>
<REQSTATUS>

<ERROR CODE=”NOERROR”/>

</REQSTATUS>

Third, to establish a user session, the plugin would send the following datagram:

<?xml version=‘1.0’ encoding=‘utf-8’ ?>
<!DOCTYPE SESSIONCTL SYSTEM “ hcleip_sessionctl_V1.dtd ”>
<SESSIONCTL>

<IDENTITY USERAGENT=”IE4.0xxxxx”>

<KEYS USERID=“cam.stevenson” PASSWORD=“foobar”
QUALIFIER=”ottawa”/>

</IDENTITY>
<SESSION ID=”the_global_session_id”
REQUEST=“ESTABLISH”/>

</SESSIONCTL>

On success, the component application would send the following datagram:

<?xml version=‘1.0’ encoding=‘utf-8’ ?>
<!DOCTYPE SESSIONCTL SYSTEM “hcleip_sessionctl_V1.dtd ”>
< SESSIONCTL >

<SESSION ID=”{3123453871765312}”/>

</ SESSIONCTL >

Fourth, to destroy an established user session, the plugin would send the following datagram:

<?xml version=‘1.0’ encoding=‘utf-8’ ?>
<!DOCTYPE SESSIONCTL SYSTEM “hcleip_sessionctl_V1.dtd ”>
<SESSIONCTL>

<IDENTITY USERAGENT=”IE4.0xxxxx”>

<KEYS USERID=“cam.stevenson” PASSWORD=“foobar”
QUALIFIER=“ottawa”/>

</IDENTITY>
<SESSION ID=”{3123453871765312}” REQUEST=”DESTROY”/>

</SESSIONCTL>

On success, the component application would send the following datagram:

<?xml version=‘1.0’ encoding=‘utf-8’ ?>
<!DOCTYPE REQSTATUS SYSTEM “hcleip_reqstatus_V1.dtd”>
<REQSTATUS>

<ERROR CODE=”NOERROR”/>

</REQSTATUS>

The Request Status DTD (REQSTATUS) DTD is used by the component application to return the status of a request (from a EIP plugin) to the EIP plugin in the case where there is not need to return any other information. The REQSTATUS DTD typically contains one “ERROR” element. The ERROR element provides an indication to the EIP plugin as to the success or failure of the request. The characteristics of this element are listed below.

| Element | ERROR | |
|---|---|---|
| Purpose: | Provide indication of an error, or indication of a successful request in the | |
| | absence of response data. | |
| Allowable sub-elements: | NONE. | |
| Notes: | The ERROR element consists of a CODE attribute, which is selected out | |
| | of a well-defined list. To provide more information to support personnel | |
| | attempting to determine the cause of a failure, the REASON attribute | |
| | should contain a more specific error code or a more detailed explanation of | |
| | the failure. | |
| Attributes: | Name: | CODE |
| | Description: | One of a well-defined list of failure codes. |
| | Type: | (NOERROR \| NOAUTH \| BADAUTH \| BADFORM \| |
| | | INVPARM \| IMMFAIL \| SERVFAIL \| |
| | | BADSESSION \| NOLIC \| NODTD) |
| | | (As well as Query & MetaData errors) |
| | Default | Required |
| | Notes: | CODE must contain one of a well-defined list of errors, |
| | | defined thus: |
| | | NOERROR - No error occurred. This should be used to |
| | | indicate the success of an operation In the absence of |
| | | response data. |
| | | NOAUTH - Required authentication credentials were needed |
| | | and not supplied in the request |
| | | BADAUTH - Credentials supplied in the request were invalid. |
| | | BADFORM - Request datagram was not well-formed XML. |
| | | INVPARM - Validation failed on request datagram, or a |
| | | parameter specified in the request was invalid. |
| | | IMMFAIL - the server/application believes that failure is |
| | | imminent (clean up and log off). |
| | | SERVFAIL - a server/application failure prevented the |
| | | request from being fulfilled. |
| | | BADSESSION - the session referenced in the request |
| | | was not available, either because it did not exist or |
| | | because it did not belong to the specified user. |
| | | NOLIC - No licenses were available to service the |
| | | rqeuest |
| | | NODTD - the referenced DTD was not available, |
| | | either because it did not exist or due to a versioning |
| | | mismatch. |
| | Name: | REASON |
| | Description: | An application specific descriptive reason or error |
| | | message. |
| | Type: | CDATA |
| | Default: | Implied |

| | |
|---|---|
| Example: | <ERROR CODE=”INVALID” REASON=”Line 4”/> |

<ERROR CODE=”NOAUTH” REASON=”No soup for you!”/>

For example, the following is the DTD code for a status request (i.e. “REQSTATUS”).

<!--

| | |
|---|---|
| # Name: | hcleip_reqstatus_V1.dtd |
| # Description: | DTD for XML based query datagrams - status of request |
| # Version: | 1.2 |
| # Organization: | Hummingbird Communications Ltd. |
| # Date: | November 12, 1999 |

-- >
<!--

| # | |
|---|---|
| # | Changes since 1.1: |
| # | |
| # | New error codes for searching (QRYERRCODES) |
| # | New error codes for meta data (MDERRCODES) |
| # | |
| # | |
| # | Changes since 1.0: |
| # | Added the following ERRCODES: |
| # | |
| # | NOLIC - No more licenses available |
| # | NODTD - The DTD that the request is based on is not supported |
| # | |
| # | Changes since 1.1: |
| # | |
| # | Added QRYERRCODES |
| # | |

-- >
<!ENTITY % BOOLEAN “(TRUE | FALSE)”>
<!ENTITY % INTEGER “CDATA”>
<!ENTITY % ERRCODES “NOERROR | NOAUTH | BADAUTH | BADFORM | INVPARM |
SERVFAIL | IMMFAIL | BADSESSION | NOLIC | NODTD”>
<!ENTITY % QRYERRCODES “QRY_NODOCS | QRY_CANTHANDLE | QRY_BADOP | QRY_BADCOL
| QRY_BADITEM | QRY_BADID | QRY_BADSCHEMA”>
<!ENTITY % MDERRCODES “MD_BADCLASS | MD_BADDATA”>
<!ELEMENT REQSTATUS (ERROR)>
<!ELEMENT ERROR EMPTY>
<!ATTLIST ERROR

| CODE | (%ERRCODES; \| %QRYERRCODES; \| %MDERRCODES;) #REQUIRED | |
|---|---|---|
| REASON | CDATA | #IMPLIED |

>

Consider the following two additional examples. First, if the request is completed successfully, the following “REQSTATUS” datagram is sent:

<?xml version=‘1.0’ encoding=‘utf-8’ ?>
<!DOCTYPE REQSTATUS SYSTEM “hcleip_reqstatus_V1.dtd”>
<REQSTATUS>

<ERROR CODE=”NOERROR”/>

</REQSTATUS>

Second, if the request failed due to an authentication error, the following “REQSTATUS” datagram is sent:

<?xml version=‘1.0’ encoding=‘utf-8’ ?>
<!DOCTYPE REQSTATUS SYSTEM “hcleip_reqstatus_V1.dtd”>
<REQSTATUS>

<ERROR CODE=”NOAUTH” REASON=”Not permitted to log in
at this time of

day”/>
</REQSTATUS>

The following section describes a method for XML based integrated searching in the an enterprise information portal (“EIP”) system is described. In general, searching by the EIP system is conducted by “XML datagrams”. An XML datagram is a packet of control information (i.e. either a request- or a response) used to communicate between a client and server or between a server and server, encoded in XML, and adhering to a well-defined document type definition (“DTD”). The terms defined next will be used in the description to follow:

1. “Search Functionality Provider” is an application outside the scope of the EIP which provides search functionality usable within the EIP.

2. “Datagram Handler”, for the purposes of this section, is a layer of code which translates XML request datagrams to native functionality for use by the “Search Functionality Provider” and which translates data returned by the provider into valid XML response datagrams.

3. “Aggregation”, for the purposes of this section, is the ability to merge search result sets from heterogeneous “Search Functionality Providers” in some useful manner.

4. “Query Tree” is a representation of a query in tree form. It is effectively a prefix expression of the query.

5. “Mandatory Operators” are operators in the query language which must be implemented by a handler.

6. “Optional Operators” are operators which may be implemented by a handler. Optional operators support a graceful degradation/fallback mechanism.

7. “Blind Operators” are operators which may be implemented by a handler. Lack of support for a blind operator is ignored during query processing.

8. “Non-Terminal Operators” are operators which contain other operators but which do not otherwise accept data.

9. “Terminal Operators” are operators which perform a comparison of a supplied piece of data against the contents of a column. Terminal operators do not themselves contain other operators.

10. “Environmental Operators” are operators which effect the environment of the search, or branch of the query tree.

11. “Optimization Pass” is an operation performed by a handler to optimize a query tree for its particular engine, before constructing a query for that engine.

In particular, the search method uses “highest common denominator” grammar with built-in graceful degradation on unsupported operators or columns. It is specifically designed to allow for aggregation of disparate data sources and search engines. What this means is that a single query may be sent to multiple search engines, taking advantage of “high value” operators (e.g. a phrase) on search engines that support them, and falling back to simpler operators (e.g. “and”) on engines that do not support the high value operators. This is a unique feature of the exemplary embodiment. Other unique features and advantages of the search method include the following:

1. Ease of Integratioiz. It is simple to integrate a new Search Functionality Provider. Where possible, the burden of implementation effort is placed on the requestor (i.e. the constructor of the query) rather than on the handler, in order to encourage the proliferation of handlers.

2. Single Query Across Multiple Providers. It is possible to construct a single query for use by multiple Search Functionality Providers

3. Aggregation of results. It is possible and not difficult to aggregate result sets from different Search Functionality Providers.

4. Generalization. Each DTD is general enough to be used effectively by component applications and contains a minimum of application specific encoding.

5. Well bounded. Element rules are well defined in order to minimize the post-parsing effort required.

6. Character Set Encoding. Character encoding of datagrams is always UTF-8.

7. Base Schema. Although it is possible to determine schema layout for each Search Functionality Provider in terms of column names and data types, the semantic use of each column cannot be determined without the creation of a complex semantic description language. As such, a simpler approach to schema support is taken. For the purposes of the preferred embodiment, a simple base schema is defined. All Search Functionality Providers (or their handlers) are required to support the base schema. It is possible for Search Functionality Providers to support vendor specific columns beyond the base schema, however these may not be usable for aggregated searches. It is the responsibility of the handler to map each column to some useful piece or pieces of information. The base schema has the following columns:

a) HEADING: A non-narrative label for the item (e.g. title or subject).

HEADING is searchable and may be retrieved in the result set.

b) DESCRIPTION: A summarization-style representation of the content of the item (e.g. keywords or abstract). DESCRIPTION is searchable and may be retrieved in the result set.

c) CONTENT: The content of the item. Represented in a result set as a URL which references the content. CONTENT is searchable. CONTENT may also be retrieved in the result set as a URL which references the content. CONTENT referenced in this manner should be free from added markup (e.g. highlighting).

d) SIZE: The size of the item in bytes. May be empty if size is non-determinable. SIZE is not searchable, but may be retrieved in the result set.

e) URLS: A collection of URLs which reference all possible actions for the item. URLS is not searchable but may be retrieved in the result set.

f) SCORE: The relevance score of the item in the result set. This must be a percentage representation in the range 1 to 100. The handler is responsible for normalizing its internal score value to the percentage representation. Search Functionality Providers that do not support the concept of relevance should, when SCORE is requested in the result set, emit a value of 0 (zero). SCORE is not searchable but may be retrieved in the result set.

8. Base Operators. The following operators are supported by every handler.

a) Non Terminal Operators (i.e. operate on operators)

AND Boolean AND

ORBoolean OR

NOT Boolean NOT

OP Allow the use of a vendor specific operator.

b) Terminal Operators (i.e. operate on data)

CONTAINS String column contains the string value

EQ Column is equal to the value

GE Column data is greater than, or equal to, the value

LE Column data is less than, or equal to, the value

LT Column data is less than the value

GT Column data is greater than the value

NEQ Column data is not equal to the value

OP Allow the use of a vendor specific operator

c) Environmental Operators (i.e. used to control the environment of the query or branch thereof)

COLUMN Restrict query or branch to a particular column.

ENV Apply an engine-specific environment setting.

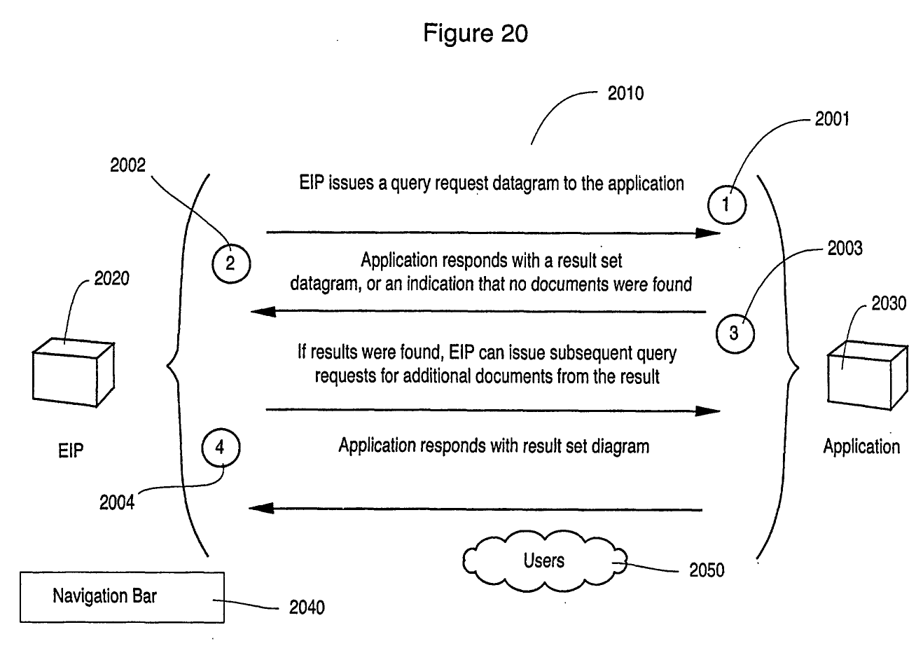

FIG. 20 illustrates the method steps 2010 for searching an application 2030 using the EIP system 2020.

Now, searching uses three existing DTDs (i.e. NAVREQ, NAVRESP, and REQSTATUS), which have been described elsewhere, and two new DTDs, which will be described below, as follows:

QUERYREQ: The request to perform a query.

RESULTSET: The set of results from a query.

The NAVRESP DTD is modified for searching to include the notion of the “searchable” entries in addition to the previously described “browsable” navigation bar entries. The REQSTATUS DTD for searching includes the following additional “CODES”:

1. QRY_NODOCS: The query matched no documents.

2. QRY_CANTHANDLE: The Datagram Handler could not process the query. Used, for example, when a <BRANCHCTL ACTION=“QUERYFAIL”/> is encountered.

3. QRY_BADOP: The query failed because an operator was not supported, and the handler was instructed to fail the query as a result.

4. QRY_BADCOL: The query failed because a column was not supported, and the handler was instructed to fail the query as a result.

5. QRY_BADITEM: A reference to a result-set item was invalid. This would be returned, for example, if a request was made to return a result set where the start item was beyond the last item found by the search.

6. QRY_BADID: The referenced search id was invalid.

7. QRY_BADSCHEMA: The requested schema is not available.

Referring to FIG. 20, at step 2001, the EIP system 2020 issues a query request datagram to the application 2030. This query request has a DTD and XML datagram (i.e. request) associated with it. The DTD and XML datagram may be referred to as “QUERYREQ”. The elements of the “QUERYREQ” DTD will be defined below.

At step 2002, the application 2030 responds to the EIP system's 2020 query request with a result set datagram or with an indication that no documents were found. This result set response has a DTD and XML datagram (i.e. response) associated with it. The DTD and XML datagram may be referred to as “RESULTSET”. The elements of the “RESULTSET” DTD will be defined below.

At step 2003, if the results are found, the EIP system 2020 can issue subsequent query requests to the application 2030 for additional documents from the result set.

At step 2004, the application 2030 responds to the additional query request from the EIP system 2020 with a further result set datagram.

For example, the following is the flow for a search in the case of stateful search engines:

1. Searchable items (e.g. folders, libraries, etc) are returned from each handler in its navigation bar 2040 response (i.e. “NAVRESP”), marked as searchable.

2. The user 2050 marks items he wishes to search and enters search criteria in a form.

3. The search plug-in constructs a single query which reflects the search criteria (2).

4. The search plug-in constructs a domain reference (i.e. where to search) separately for each handler which is participating in the search, by examining the marked searchable items (1) and (2).

5. The search plug-in constructs an XML encoded datagram (i.e. “QUERYREQ”) consisting of the domain reference (4), an identity section and query (3) for each engine and transmits 2001 it to each handler.

6. Each handler deconstructs the XML encoded query request, translates it into the native query syntax for it's application 2030 and performs the search.

7. Each handler takes the results from the search and caches them, returning 2002 a portion of the result set (i.e. the number of rows asked for) along with an ID referencing the result, all encoded in XML (i.e. “RESULTSET”).

8. The EIP 2020 merges the results from each handler and displays the aggregated result set to the user 2050.

9. The user 2050 can page through the merged result set. A request for items which are not located in the merged set (e.g. next 20 items) may require an additional request to the handlers using the search ID (7). In this case, each handler would return the “next items” in the cached result set. Note that in the case of a stateless query engine, the query would be reissued along with the request for additional items instead of referencing a search ID. Handlers are not required to cache searches.

Now, the “QUERYREQ” DTD is used to construct a “QUERYREQ” datagram for transmission to a handler, which is used to perform a query. The “QUERYREQ” DTD consists of three sections:

IDENTITY (REQUIRED): used to reference a user session.

DOMAIN (REQUIRED): used to specify the domain in which the query will operate, and to control the result set it will produce.

QUERY (OPTIONAL): the query itself, represented as a tree. The query is restrictive. In other words, the absence of a QUERY section, where the query does not reference an existing search, implies that all documents are contained in referenced data sources.

Each of these sections will be described in detail in the following.

First, the IDENTITY section is identical to that used in the NAVREQ DTD described elsewhere.

Second, the DOMAIN sections is used to control the sphere of operation of the query both in terms of input (e.g. data sources to which the query will be applied, or schema in which the query will operate) and output (e.g. what columns go into the result set). Input specifications are located within the SOURCE element and SCHEMA element. Output specifications are located within the RESULT element. DOMAIN, instead of specifying data sources, can reference an existing search using the SEARCHID element. If SEARCHID is specified, it may be used either to reference an existing search in order to retrieve additional results, or close an existing search, freeing any resources associated with that search (i.e. CLOSESEARCH). DOMAIN can contain a single SEARCHID element and a single CLOSESEARCH element for the case when it is being used to close a search, or at least one SEARCHID or SOURCE, and at least one RESULT element. Except where a search is being closed, there may be a single SCHEMA element which informs the handler/application for which schema the query is targeted.

Now, the SOURCE element is used to specify the data sources to which the query will be applied. SOURCE has the following required attributes:

STARTTAG: The tag representing the datasource.

SOURCE has the following optional attributes:

INCLUDECHILDREN: Specifies whether children of the source should be searched as well as the source itself.

SOURCE has the following semantic model rules:

STARTTAG is a tag returned in a navigation bar response datagram for the application, for searchable items.

By default, INCLUDECHILDREN is TRUE.

STARTTAG may be “ALL”, in which case the handler receiving the request should apply the query to all searchable sources within its domain.

Next, the SEARCHED element is used to reference an existing search, in order to continue retrieval of rows in a result set. SEARCHID is an empty element and has the following required attributes:

ID: The Search ID returned in the initial result set response to the query.

SEARCHID has the following semantic model rules:

Support for the SEARCHID element is only required for non-stateful Search Functionality Providers.

No QUERY section is required when SEARCHID is used, since by definition SEARCHID references an existing search.

Search lifetime may be defined.

Next, the CLOSESEARCH element is used to terminate an existing search. It is an empty element with no attributes. CLOSESEARCH has the following semantic model rules:

Use of CLOSESEARCH in the DOMAIN section requires an instance of SEARCHID referencing a valid search id.

No other elements are required within DOMAIN except SEARCHID and CLOSESEARCH when a search is being closed.

Next, the SCHEMA element is used to specify the schema to which the query applies. Typically the specified schema would be used by the handler in initial query optimization. SCHEMA is an empty element, and has the following required attributes:

TYPE: The type of schema. May be one of BASE, USER or NATIVE. If USER is specified as the TYPE, then the optional attribute NAME must be supplied

SCHEMA has the following optional attributes:

NAME: The name of a user supplied schema.

SCHEMA has the following semantic model rules:

A schema type of BASE specifies the base schema as described above.

A schema type of NATIVE specifies that the application's native schema is to be used and that the handler should assume that all columns specified within the query are valid

A schema type of USER requires the name of a mutually agreeable, well-known schema be supplied in the NAME attribute.

Next, the RESULT element is used to specify the format and content of the result set returned in response to a query. RESULT may contain a single ORDERBY element and must contain at least one RESULT_COL element. Either a flattened result set or one preserving hierarchy may be requested in the RESULT element.

RESULT has the following required attributes:

START: The (numeric) starting row for the result, starting from “1”.

COUNT: The number of rows to return in the result. In the case where result set depth is enabled, this will be the number of terminal (leaf) nodes.

RESULT has the following optional attributes:

MAXROWS: The maximum number of rows that the handler should make available for output in a result. This is effectively a cutoff on the number of results the search should produce and will typically be passed to the underlying application.

DEPTH: Used to specify the type of depth reflected in a result set.

RESULT has the following semantic model rules:

DEPTH may be set to one of the following values: FLAT—the result set is flat; in other words, no depth is reflected. This is the default behavior if the DEPTH attribute is not specified; PHYSICAL—the result set reflects the physical layout (e.g. folders) of the data source being searched; COLUMN—the result set reflects grouping y columns; and CONCEPT—the result set reflects clustering by concept.

Where a specified DEPTH is not supported, handlers should default to FLAT.

Where DEPTH is not FLAT, MAXROWS applies to the terminal nodes of the result set.

Next, the ORDERBY element is contained in a RESULT element and is used to specify the column by which a search result is ordered. The ORDERBY element may itself contain a single ORDERBY element.

ORDERBY has the following required attributes:

NAME: The name of the column by which the result set should be ordered.

ORDERBY has the following optional attributes:

ORDER: Whether the result should be in ascending order (ASCEND) or descending order (DESCEND).

ORDERBY has the following semantic model rules:

ORDERBY may be nested to allow for sub-grouping.

If ORDER=“ASCEND” or ORDER”=“DESCEND” is not specified, ORDER=“ASCEND” is assumed.

The ORDER attribute applies only to ordering performed for the <ORDERBY> element to which it is attached.

Next, the RESULT_COL element is contained in a RESULT element and is used to specify a column which the handler should place in the result set returned by the query.

RESULT_COL has the following required attributes:

NAME: The name of the column.

RESULT_COL has the following optional attributes:

MAPFROM: The name of a native (i.e. in the native schema) column to map to the requested column for output in the result set.

RESULT_COL has the following semantic model rules:

If the datagram handler is unable to map the column specified in NAME to a column supported by the underlying application, it must emit an empty column in the result set (e.g. <COLUMN NAME=“MODDATE”/></COLUMN>). See below for a description of COLUMN usage in the RESULTSET DTD.

MAPFROM is used to allow a query which supports multiple schemas to emit a filly normalized result set.

Third, QUERY is used to supply the query tree to the handler. QUERY must contain a single COLUMN operator.

Now, non-terminal operators (i.e. <AND>, <OR>, <NOT> and <OP>) must contain at least one operator, of any type. They have the following semantic model rules:

All branches of the query tree below an <AND> operator must evaluate to true for the <AND> operator itself to evaluate to true.

Any branch of the query tree below an <OR> operator may evaluate to true for the <OR> operator itself to evaluate to true.

The <NOT> operator contains a single branch which must evaluate to false for the <NOT> operator to evaluate to true.

When using the <OP> operator as a conjunctive operator, rules for the vendor defined operator being used with <OP> must be well known to both the requestor and handler.

Next, terminal operators (i.e. <CONTAINS>, <EQ>, <GE>, <LE>, <LT>, <GT>, <NEQ>, <OP>) must contain parsable character data. They have the following semantic model rules:

XML treatment of whitespace may require character data supplied in a terminal operator to be placed in a CDATA section.

Next, environmental operators (i.e. <COLUMN>, <ENV>) are used to affect the environment within which the query or branch of the query tree operates. They have the following semantic model rules:

See below for a description of the COLUMN operator.

See below for a description of the ENV operator.

ENV is a blind operator. Datagram handlers may simply discard ENV operators which they do not understand.

Next, the OP operator is used to allow a vendor specific operator to be supplied outside of the set of base operators. It allows for graceful degradation. OP may contain one or more PARAM elements (see below), must contain either character data or operator elements, and must contain a GRAFT element.

OP has one required attribute:

NAME: The name of the vendor specific operator.

OP allows for predetermined action to be taken if the vendor specific operator is not supported, through the use of the GRAFT element thus, for example:

<OP NAME=<”SPLUNGE”>

splungable text to be splunged
<GRAFT>

<CONTAINS>

splungable text to be splunged

</CONTAINS>

</GRAFT>

</OP

In the above example, the requestor is trying to use the “SPLUNGE” operator, which it knows will be supported by some handlers but not by all. The requestor has pre-determined that CONTAINS is similar to a SPLUNGE operator and it will accept items which satisfy the conditions of the CONTAINS if the SPLUNGE operator is not supported.

Handlers receiving a query containing the above fragment will, during query optimization, check to see if they support the SPLUNGE operator. If they do, the GRAFT element will be ignored. If they do not, the query tree branch contained by the GRAFT operator will be used to replace the OP operator containing SPLUNGE, and query optimization will proceed starting at the replaced node.

Requestors, when constructing a query, may also cause an explicit action to be taken on an unsupported operator using the BRANCHCTL element. For example:

<OP NAME=”SPLUNGE”>

splungable text to be splunged
<GRAFT>

<BRANCHCTL ACTION=”QUERYFAIL”/>

</GRAFT>

</OP>

In this example, a handler which does not support the SPLUNGE operator will end up replacing the OP node with BRANCHCTL contained within GRAFT, and will encounter BRANCHCTL when query optimization proceeds. When the BRANCHCTL above is encountered, the handler will take the action defined by the ACTION attribute, which in the example is to fail the entire query with a “no documents found” indication.

Degradation, using the mechanism above, may be arbitrarily complex as shown by the following example:

<OP NAME=”SPLUNGE”

splungable text to be splunged
<GRAFT>

<OP NAME=”SPLURGE”>

splungable text to be splunged
<GRAFT>

<BRANCHCTL ACTION=”QUERYFAIL”/>

</GRAFT>

</OP>

</GRAFT>

</OP>

In this example, the requester will accept results from engines which support either the SPLUNGE operator (i.e. best case) or the SPLURGE operator, but not from engines which support neither. This example may also be expressed as follows:

<OP NAME=”SPLUNGE”

splungable text to be splunged
<GRAFT NAME=”SPLURGE”>

<GRAFT>

<BRANCHCTL ACTION=”QUERYFAIL”/>

</GRAFT>

</GRAFT>

</OP>

In the above case, because the first GRAFT element contains a NAME attribute, the action taken by the handler will be to replace SPLUNGE with SPLURGE if SPLURGE is supported. It will otherwise graft the branch referenced by the second GRAFT element, which will result in the query failing (i.e. <BRANCHCTL ACTION=“QUERYFAIL”/>).

Note that it is possible (and in some cases desirable) to allow required operators to be specified in the GRAFT NAME=“xxx” element (e.g. <GRAFT NAME=“CONTAINS”>). However, this does not make sense for all required operators. The recommended list of required operators which may be specified as the NAME attribute of <GRAFT> is: AND, OR, NOT, EQ, NEQ, LE, GE, LT, GT and CONTAINS. All other required operators specified as the NAME attribute should result in the optimizer treating the operator as unsupported. It is also important to realize that XML DTD validation will not take place when a required operator is specified in this manner. The optimizer must be prepared for this circumstance. For example, an AND operator specified as the NAME attribute of GRAFT will not be guaranteed to contain the correct elements beneath it.

Next, the COLUMN operator is used to specify a column to which to apply the branch of the query tree underneath it. COLUMN must contain a single operator of any type and a GRAFT element.

COLUMN has one required attribute:

NAME: The name of the column.

The column specified in the NAME attribute should be valid in the context of the schema (i.e. specified in SCHEMA in the DOMAIN section).The COLUMN operator may be nested in order to allow for the specification of, “column paths”. The COLUMN operator supports the same “graceful degradation” mechanism used by the OP operator. For example:

<COLUMN NAME=”AUTHOR”>

<CONTAINS>Mickey Mouse<CONTAINS>
<GRAFT>

<COLUMN NAME=”CONTENT”>

<CONTAINS>Mickey Mouse</CONTAINS>
<GRAFT>

<BRANCHCTL ACTION=”QUERYFAIL”/>

</GRAFT>

</COLUMN >

</GRAFT>

</OP

In the example above, the requestor is trying to apply the CONTAINS operator against the column “AUTHOR”. If AUTHOR is unsupported, then the requestor directs that the CONTAINS operator should be applied to the CONTENT column. The above example may also be expressed as follows:

<COLUMN NAME=”AUTHOR”>

<CONTAINS>Mickey Mouse</CONTAINS>
<GRAFT NAME=”CONTENT”>

<CONTAINS>Mickey Mouse</CONTAINS>
<GRAFT>

<BRANCHCTL ACTION=”QUERYFAIL”/>

</GRAFT>

</GRAFT>

</OP

In the above case, because the first GRAFT element contains a NAME attribute, the action taken by the handler will be to replace AUTHOR with CONTENT if CONTENT is a supported column. It will otherwise graft the branch referenced by the second GRAFT element, which will result in the query failing (i.e. <BRANCHCTL ACTION-“QUERYFAIL”/>).

Note that COLUMN always requires a GRAFT child element. The final GRAFT operation on a column should be <BRANCHCTL ACTION=“QUERYFAIL”/>.

Next, GRAFT is used as a child of the OP and COLUMN operators in order to supply an alternate operator/column or query tree branch in the case where the operator (supplied with OP) or column (supplied with COLUMN) is not supported by the search functionality provider/handler.

GRAFT must contain either a single operator, a single BRANCHCTL element or a single GRAFT element.

GRAFT has one optional attribute:

NAME: The name of an operator (i.e. where GRAFT is a child of OP) or of a column (i.e. where GRAFT is a child of COLUMN) to try instead of the current OP or COLUMN name.

GRAFT has the following semantic model rules:

If NAME is supplied, GRAFT must not contain an operator, but may contain either a BRANCHCTL or GRAFT element. In this case, the action taken by the handler should be to simply see if it supports the (operator or column) named in NAME.

If NAME is not supplied, GRAFT must contain either an operator or a BRANCHCTL element. In this case, the action taken by the handler should be to replace the current OP or COLUMN node with the operator referenced underneath GRAFT.

In general, NAME should be used where the criteria referenced by the OP operator does not change with the replaced operator.

Next, BRANCHCTL is used solely within a GRAFT element (see above) to explicitly mark a query tree branch as TRUE or FALSE (see below) or to cause a query to fail. BRANCHCTL is an empty element, and has a single required attribute:

ACTION: One of BRANCHTRUE, BRANCHFALSE or QUERYFAIL.

BRANCHCTL has the following semantic model rules:

BRANCHTRUE indicates that the branch of the query tree referenced by BRANCHCTL should evaluate to TRUE.

BRANCHFALSE indicates that the branch of the query tree referenced by BRANCHCTL should evaluate to FALSE.

QUERYFAIL indicates that the query should fail. A REQSTATUS datagram should be returned in lieu of a result set, with the error code set to QRY_CANTHANDLE.

BRANCHTRUE and BRANCHFALSE are useful only for query optimization where the query is evaluated before being passed to the underlying application. See the description to follow.

Next, the ENV operator is used to apply an environment setting or settings to the branch of the query tree underneath it. ENV must contain at least one PARAM element and must contain a single operator. ENV has no attributes.

Next, PARAM is used to supply a parameter to either the ENV or OP operators. PARAM is an empty element and has the following required attributes:

NAME: The name of the parameter.

VALUE: The value of the parameter

As an illustration, consider the following QUERYREQ datagram for a simple query:

<?xml version=‘1.0’ encoding=‘utf-8’?>
<!DOCTYPE QUERYREQ SYSTEM “hcleip_query_V1.dtd”>
<QUERYREQ>

<IDENTITY USERAGENT=“XMLTest Test Driver”>

<KEYS USERID=“gwyn” PASSWORD=“foobar” QUALIFIER=“elmo”/>

</IDENTITY>
<DOMAIN>

<SOURCE STARTTAG=“kmap”/>
<RESULT START=“1” COUNT=“100”>

<RESULT_COLNAME=“DESCRIPTION”/>

</RESULT>

</DOMAIN>
<QUERY>

<COLUMN NAME=”CONTENT”>
<AND>

<CONTAINS>cat</CONTAINS>
<CONTAINS>dog</CONTAINS>
</AND>
<GRAFT>

<BRANCHCTL ACTION=”QUERYFAIL”/>

</GRAFT>

</COLUMN>
</QUERY>

</QUERYREQ>

In this example, note the following points:

Identity is supplied in the IDENTITY block as a set of keys.

DOMAIN specifies that the data source referenced by the tag “kmap” is to be searched.

DOMAIN requests only the column DESCRIPTION in the result set, and asks for 100 rows starting at row 1.

The query is a simple search in the CONTENT column for items whose content contains “cat” and “dog”.

As a further illustration, consider the following QUERYREQ datagram for a query with a vendor specific operator:

<?xml version=‘1.0’ encoding=‘utf-8’?>
<!DOCTYPE QUERYREQ SYSTEM “hcleip_query_V1.dtd”>
<QUERYREQ>

<IDENTITY USERAGENT=“XMLTest Test Driver”>

<KEYS USERID=“gwyn” PASSWORD=“foobar” QUALIFIER=“elmo”/>

</IDENTITY>
<DOMAIN>

<SOURCE STARTTAG=“cluster1”/>
<SOURCE STARTTAG=”cluster7”/>
<RESULT START=“1” COUNT=“10” MAXROWS=”100”>

<ORDERBY NAME=”DESCRIPTION/>
<RESULT_COL NAME=“DESCRIPTION”/>
<RESULT_COL NAME=”URLS”>

</RESULT>

</DOMAIN>

<QUERY>
<COLUMN NAME=”CONTENT”>

<AND>

<CONTAINS>cat</CONTAINS>
<CONTAINS>dog</CONTAINS>
<OP NAME=”SHAG”>

Yeah Baby!
<GRAFT>

<AND>

<CONTAINS>Yeah</CONTAINS>
<CONTAINS>Baby!</CONTAINS>

</AND>

</GRAFT>

</OP>

</AND>
<GRAFT>

<BRANCHCTL ACTION=”QUERYFAIL”/>

</GRAFT>

</COLUMN>
</QUERY>

</QUERYREQ>

In this example, note the following points:

Identity is supplied in the IDENTITY block as set of keys.

DOMAIN specifies that two data sources are to be searched—“cluster1” and “cluster7”.

DOMAIN requests the columns DESCRIPTION and URLS in the result set and asks for 10 items to be returned, starting at item 1.

DOMAIN instructs the handler that a maximum of 100 rows are needed.

The query is a search in the CONTENT column for “cat” and “dog”, and makes use of the vendor specific operator “SHAG”. If the handler does not support the SHAG operator, the query instructs it to use an AND of the two terms that were supplied to the SHAG operator.

It is possible to optimize a query. Now, processing a QUERYREQ datagram requires (at least logically) two distinct iterations through the QUERY tree:

1. A pass to optimize the QUERY tree.

2. A pass to translate the QUERY tree into the native query format.

The optimization consists basically of an examination and manipulation of the OP and COLUMN nodes and their children.

In the case of the COLUMN node, the optimizer must be aware of the schema in use (i.e. SCHEMA) and based on the schema determine whether or not the column specified in the COLUMN node is supported. If the column is supported, the optimizer should remove the GRAFT node and all children thereof from the COLUMN node being examined. If the column is not supported, then:

If the GRAFT child node contains a NAME attribute, the NAME attribute of the COLUMN node should be replaced with it, and the optimizer should continue at the replaced node.

If the GRAFT child node does not contain a NAME attribute, the COLUMN node should be replaced by the single (operator) child node of GRAFT, and the optimizer should continue at the replaced node.

In the case of the OP node, the optimizer must be aware of the optional operators it supports (if any). As with the COLUMN node, if the operator is supported, the optimizer should remove the GRAFT node and all children thereof from the OP node being examined. If the operator is not supported, then:

If the GRAFT child node contains a NAME attribute, the NAME attribute of the OP node should be replaced with it, and the optimizer should continue at the replaced node.

If the GRAFT child node does not contain a NAME attribute, the OP node should be replaced by the single (operator) child node of GRAFT, and the optimizer should continue at the replaced node.

With respect to ENV node, note that ENV is a blind operator and as such may be safely discarded if not understood. In the case of an unrecognized ENV operator, the optimizer would simply replace the ENV node being examined with its single child node and continue optimizing at the replaced node.

Now, BRANCHCTL allows the generator of the query to direct that some action be taken in the case of an unsupported column or operator (see above). BRANCHCTL can cause it's branch of the query tree to evaluate to TRUE (by specifying ACTION=“BRANCHTRUE”) or to FALSE (by specifying ACTION=“BRANCHFALSE”). BRANCHCTL can also be used to cause the entire query to fail by specifying ACTION=“QUERYFAlL”.

A description will now be given for how to make use of evaluation results of query tree branches. With respect to evaluating a query during optimization, if a QUERY contains optional operators (i.e. OP) or columns (i.e. COLUMN), it is possible that the query may be evaluated by the optimizer without needing to pass a native version of the query to the underlying application.

In order to support evaluation in the optimizer, the optimizer needs to keep track of the evaluation state of each query branch as it is traversed. State may be one of the following:

Branch evaluates to TRUE

Branch evaluates to FALSE

Branch cannot be evaluated by the optimizer (indeterminate result).

Evaluation is accomplished using these rules:

A terminal operator (CONTAINS, EQ, NEQ, LT, GT, LE, GE) cannot be evaluated (indeterminate result).

An AND operator evaluates to TRUE if all of its child operators evaluate to TRUE.

An AND operator evaluates to FALSE if any of its child operators evaluate to FALSE.

An OR operator evaluates to TRUE if any of its child operators evaluate to TRUE.

An OR operator evaluates to FALSE if all of its child operators evaluate to FALSE.

A NOT operator evaluates to TRUE if it's child operator evaluates to FALSE.

Environmental operators (i.e. ENV, COLUMN are not evaluated. A determinate truth value flows unchanged through ENV and COLUMN.

Semantics of optional operators (OP) are dependent on the operator.

A query which evaluates to TRUE matches all items in the data sources specified.

A query which evaluates to FALSE matches no documents.

A query which cannot be evaluated must be passed to the underlying is application.

<BRANCHCTL ACTION=“BRANCHFALSE”/> specifies that the <BRANCHCTL> node evaluates to FALSE.

<BRANCHCTL ACTION=“BRANCHTRUE”/> specifies that the <BRANCHCTL> node evaluates to TRUE.

There are other possible optimizations. Both the AND and OR operators are commutative, and as such, like child nodes, may be merged with the parent thus:

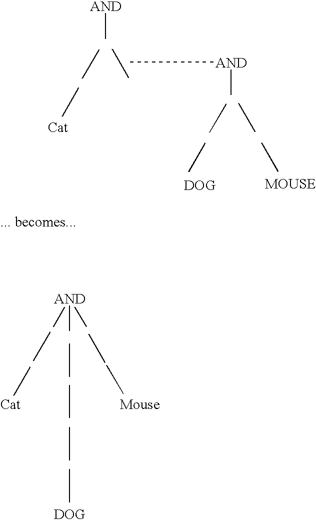

Turning now to the “RESULTSET” DTD, it is used to construct a RESULTSET datagram for transmission from the handler to the originator of the query. The RESULTSET datagram will contain a set of items that matched the query. The result set may optionally reflect depth or, by default, a simple flat list of rows that matched the query. Depth reflection is supported through the ability to nest ROW elements.

The RESULTSET DTD consists of a single section, itself named RESULTSET. RESULTSET is the root element of a result set datagram returned from a query. RESULTSET may contain a single SESSION element and must contain one or more ROW elements. RESULTSET has the following required attributes:

START: The number of the starting row in the result set.

COUNT: The number of rows in the result set.

ROWCOUNT: The number of retrievable rows in the overall result set.

TOTALHITS: The number of items that were “hit” by the query.

This will typically be a larger number than ROWCOUNT.

RESULTSET has the following optional attributes:

SEARCHID: A value which may be used in a subsequent QUERYREQ datagram to reference the completed search.

Next, the ROW element is used to describe an individual row in the result set. ROW must contain at least one COLUMN or ROW element. Nested ROW elements are used to reflect result set depth.

ROW has the following required attributes:

TAG: A unique (in time and space) tag for the row element. TAG is a reflection of the structure of the data source and is not an artifact of the search. TAG is used by processors of a result set to “stitch together” portions of a depth-enabled result set.

ROW has the following optional attributes:

LABEL: A human-readable label for the row.

CLASSID: A unique descriptor identifying the type of this ROW element.

TERMINAL: An indication to the caller that the row contains no children.

VOLATILE: An indication to the caller that the row and its children are likely to change frequently.

Next, the SESSION element allows an application to pass a new session ID back to the caller.

SESSION has a single required attribute:

ID: A new application session ID.

SESSION has the following semantic model rules:

The handler may use SESSION to pass back to the caller a new session ID in the event that was necessary to create a new session or change the session in use.

Next, COLUMN contains the data for a particular column in a row. COLUMN must contain either character data (i.e. #PCDATA) or a URL collection (i.e.one or more URL elements). COLUMN has a single required attribute:

NAME: The name of the column.

Next, the URL element specifies a URL which references a specific action which may be taken on a row (for example, view item as HTML, check out, etc). URL contains the URL as character data (i.e. #PCDATA). URL has the following optional attributes:

DISPOSITION: An indication of how the portal should display data resulting from the use of the URL. May be either INFRAME or NEWWINDOW.

LABEL: A human-readable label for the URL.

URL has the following semantic model rules:

DISPOSITION can be one of the following:

INFRAME—The portal should display the in a separate frame NEWWINDOW—The portal should display the data in a new window.

If neither INFRAME nor NEWWINDOW is specified, the plugin will make its own decision as to the best way to display the information returned from URL.

As an illustration, consider the following “no depth” RESULTSET datagram:

<?xml version=‘1.0’ encoding=‘utf-8’ ?>
<!DOCTYPE RESULTSET SYSTEM “hcleip_resultset_V1.dtd”>
<RESULTSET SEARCHID=”0” START=”1” COUNT=”10”

ROWCOUNT=”100” TOTALHITS=”51238463”>

<ROW TAG=”row1” TERMINAL=”TRUE”>

<COLUMN NAME=”HEADING”>

Introduction to XML

</COLUMN>
<COLUMN NAME=”URLS”>

<URL LABEL=”View as HTML”>

http://elmo/cgi-bin/dfxml.dll?VIEWHTM?srchid=0&item=1

</URL>
<URL LABEL=”Open document”>

http://elmo/cgi-bin/dfxml.dll?OPEN?srchid=0&item=1

</URL>

</COLUMN>

</ROW>
<ROW TAG=”row2” TERMINAL=”TRUE”>

<COLUMN NAME=”HEADING”>

XML-Query WG Minutes for 1015

</COLUMN>
<COLUMN NAME=”URLS”>

<URL LABEL=”View as HTML”>

http://elmo/cgi-bin/dfxml.dll?VIEWHTM?srchid=0&item=2

</URL>
<URL LABEL=”Open document”>

http://elmo/cgi-bin/dfxml.dll?OPEN?srchid=0&item=1

</URL>

</COLUMN>

</ROW>

...snip...

</RESULTSET>

With respect to this example, note the following points:

RESULTSET: The referencable search id is “0” (i.e. SEARCHID).

RESULTSET: This result set datagram contains 10 rows (i.e. COUNT), starting at row 1 (i.e. START). There are 100 retrievable rows (i.e. ROWCOUNT) for this search. 51238463 rows would have matched this search if the query had not set MAXROWS to 100 (i.e. TOTALHITS).

Each ROW contains a tag (i.e. TAG) and has no children (i.e. TERMINAL=“TRUE”).

Each ROW contains two COLUMNS, “HEADING” and “URLs”.

The HEADING column contains a non-narrative heading for the document (in this case, the title).

The URLS column contains two URLS, one which references an HTML view of the document and one which will cause the document to be opened (i.e. LABEL=“View as HTML” and LABEL=“Open document” respectively).

Result set ROW element is not expected to be bookmark-able in the same fashion as navigation bar response ENTRY elements.

As a further illustration, consider the following RESULTSET with a depth reflecting the physical layout of the data source:

<?xml version=‘1.0’ encoding= ‘utf-8’?>
<!DOCTYPE RESULTSET SYSTEM “hcleip_resultset_V1.dtd”>
<RESULTSET SEARCHID=“0” START=“1” COUNT=“10”

ROWCOUNT=“100” TOTALHITS=“51238463”>

<ROW TAG=“My Documents” TERMINAL=“FALSE”>

<ROW TAG=“XML Stuff” TERMINAL=“FALSE”>

<ROW TAG=“row1” TERMINAL=“TRUE”>

<COLUMN NAME=“HEADING”>

Introduction to XML

</COLUMN>
<COLUMN NAME=“URLS”>

<URL LABEL=“View as HTML”>

http://elmo/cgi-bin/dfxml.dll?VIEWHTM?srchid=0&ite

m=1

</URL>
<URL LABEL=“Open document”>

http://elmo/cgi-bin/dfxml.dll?OPEN?srchid=0&item=1

</URL>

</COLUMN

</ROW>
<ROW TAG=“row2” TERMINAL=“TRUE”>

<COLUMN NAME=“HEADING”>

XML-Query WG Minutes for 1015

</COLUMN>
<COLUMN NAME=“URLS”>

<URL LABEL=“View as HTML”>

http://elmo/cgi-bin/dfxml.dll?VIEWHTM?srchid=0&ite

m=2

</URL>
<URL LABEL=“Open document”>

http://elmo/cgi-bin/dfxml.dll?OPEN?srchid=0&item=1

</URL>

</COLUMN>

</ROW>
...snip...

</ROW>

</ROW>

</RESULTSET>

With respect to this example, note the following points:

Depth reflects the structure of the datasource.

This example is identical to the example above except that the two example ROWs are nested in higher level ROW elements which identify the folders in which they reside in the data source (i.e. \My Documents\XML Stuff).

The result set ROW element is not expected to be bookmark-able in the same fashion as navigation bar response ENTRY elements.

As a still further illustration, consider the following RESULTSET with a depth reflecting the column grouping:

<?xml version= ‘1.0’ encoding=‘utf-8’?>
<!DOCTYPE RESULTSET SYSTEM “hcleip_resultset_V1.dtd”>
<RESULTSET SEARCHID=“0” START=“1” COUNT=“10”

ROWCOUNT=“100” TOTALHITS=“51238463”>

<ROW TERMINAL=“FALSE”>
<COLUMN NAME=“AUTHOR”>

Cam Stevenson

</COLUMN>

<ROW TAG=“row1” TERMINAL=“TRUE”>

<COLUMN NAME=“HEADING”>

Introduction to XML

</COLUMN>
<COLUMN NAME=“URLS”>

<URL LABEL=“View as HTML”>

http://elmo/cgi-bin/dfxml.dll?VIEWHTM?srchid=0&item=1

</URL>
<URL LABEL=“Open document”>

http://elmo/cgi-bin/dfxml.dll?OPEN?srchid=0&item=1

</URL>

</COLUMN

</ROW>
<ROW TAG=“row2” TERMINAL=“TRUE”>

<COLUMN NAME=“HEADING”>

Searching using XML

</COLUMN>
<COLUMN NAME=“URLS”>

<URL LABEL=“View as HTML”>

http://elmo/cgi-bin/dfxml.dll?VIEWHTM?srchid=0&item=2

</URL>
<URL LABEL=“Open document”>

http://elmo/cgi-bin/dfxml.dll?OPEN? srchid=0&item=2

</URL>

</COLUMN

</ROW>

</ROW>
<ROW TERMINAL=“FALSE”>
<COLUMN NAME=“AUTHOR”>

Craig Conboy

</COLUMN>

<ROW TAG=“row3” TERMINAL=“TRUE”>

<COLUMN NAME=“HEADING”>

How I Stopped Worrying and Learned
to Love

the NavBar

</COLUMN>
<COLUMN NAME=“URLS”>

<URL LABEL=“View as HTML”>

http://elmo/cgi-bin/dfxml.dll?VIEWHTM?srchid=0&item=3

</URL>
<URL LABEL=“Open document”>

http://elmo/cgi-bin/dfxml.dll?OPEN?
srchid=0&item=3

</URL>
</COLUMN

</ROW>
<ROW TAG=“row4” TERMINAL=“TRUE”>

<COLUMN NAME=“HEADING”>

Guide to Portal Searching

</COLUMN>
<COLUMN NAME=“URLS”>

<URL LABEL=“View as HTML”>

http://elmo/cgi-bin/dfxml.dll?VIEWHTM?srchid=0&item=4

</URL>
<URL LABEL=“Open document”>

http://elmo/cgi-bin/dfxml.dll?OPEN?srchid=0&item=4

</URL>

</COLUMN

</ROW>

</ROW>

</RESULTSET>

With respect to this example, note the following points:

Depth reflects grouping by COLUMNS (in this case, by AUTHOR).

In the following, sample code for query optimization is presented.

First, consider operator evaluation requirements. For each operator known to the optimizer, there are specific requirements as to what its child nodes must evaluate to in order for the operator itself to evaluate to true. In the case of OP_IND, the operator either (a) is terminal and does not rely on evaluation of child nodes to determine its evaluation or (b) simply passes through an evaluation (e.g. COLUMN). Now, consider the following sample code:

//
// Child node requirements of non-terminal operators to evaluate to true
//
enum {

| | |
|---|---|
| OP_ANY, | // Requires any child operator to be true |
| OP_ALL, | // Requires all child operators to be true |
| OP_ONEFALSE, | // Requires one child operator which returns FALSE |
| OP_ONETRUE, | // Requires one child operator which returns TRUE |
| OP_IND, | // Can't determine requirements a priori |

};
// Operator definition
typedef struct {

| | | |
|---|---|---|
| WCHAR | *name; | // Operator name |
| WORD | code; | // Our internal code |
| WORD | req; | // Child node requirements for |
| | | the operator to evaluate to |

TRUE
} OPERATOR;
//
// These operators are GRAFTable using <GRAFT NAME=“xxx”>
//
OPERATOR grOperators [ ] = {

| | | |
|---|---|---|
| {L“AND”, | OP_AND, | OP_ALL} |
| {L“OR”, | OP_OR, | OP_ANY}, |
| {L“NOT”, | OP_NOT, | OP_ONEFALSE}, |
| {L“EQ”, | OP_EQ, | OP_IND}, |
| {L“NEQ”, | OP_NEQ, | OP_IND}, |
| {L“LE”, | OP_LE, | OP_IND}, |
| {L“GE”, | OP_GE, | OP_IND} |
| {L“LT”, | OP_LT, | OP_IND}, |
| {L“GT”, | OP_GT, | OP_IND}, |
| {L“CONTAINS”, | OP_CONTAINS, | OP_IND}, |

};
//
// These operators are *NOT* GRAFTable using <GRAFT NAME=“xxx”>
//
OPERATOR ngrOperators [ ] = {

| | | |
|---|---|---|
| {L“OP”, | OP_OP, | OP_IND}, |
| {L“COLUMN”, | OP_COLUMN, | OP_IND}, |
| {L“ENV”, | OP_ENV, | OP_IND}, |
| {L“QUERY”, | OP_QUERY, | OP_IND}, |
| {L“BRANCHCTL”, | OP_BRANCHCTL, | OP_IND}, |

};

Second, consider possible branch evaluations. During optimization, a branch may evaluate to one of several states. Coupled with the operator requirements (see above), the optimizer may be able to determine the evaluation of the entire query as a result, without needing to pass it to a search engine. Possible evaluations are:

| // | | |
|---|---|---|
| // Possible results of optimization of branch | | |
| // | | |
| enum { | | |
| | BR_TRUE, | // Branch evaluates to true always |
| | BR_FALSE, | // Branch evaluates to false always |
| | BR_IND, | // Indeterminate without executing query |
| | BR_GRAFT, | // Current node should be replaced |
| | BR_FAIL, | // Branch causes query to fail |

};

Third, consider the determination of support for columns. Schema definitions make use of a SCHEMA structure, defined thus:

// Base schema definition
typedef struct {

| | | |
|---|---|---|
| WCHAR | *name; | // Name of the column |
| WCHAR | *nativeName; | // Name of the mapped native column |
| BOOL | query; | // TRUE if it is a queryable column |
| BOOL | result; | // TRUE if it can be used in a result |
| BOOL | srchComputed; | // Column usage in search is computed |
| | | (not passed to engine) |
| BOOL | resComputed; | // Column usage in result set is |
| | | computed (not |
| | | // retrieved from engine) |

} SCHEMA;

And, the base schema is defined as follows:

// Base schema definition
SCHEMA baseSchema[ ] = {

| | | | | | | |
|---|---|---|---|---|---|---|
| | L“HEADING”, | L“TITLE”, | TRUE, | TRUE, | FALSE, | FALSE}, |
| | L“DESCRIPTION”, | L“ABSTRACT”, | TRUE, | TRUE, | FALSE, | FALSE}, |
| | L“CONTENT”, | L“CONTENT”, | TRUE, | TRUE, | FALSE, | TRUE}, |
| | L“SIZE”, | L“CONTENTSIZE”, | FALSE, | TRUE, | FALSE, | FALSE}, |
| | L“SCORE”, | L“SCORE”, | FALSE, | TRUE, | FALSE, | FALSE}, |
| | L“URLS”, | L“”, | FALSE, | TRUE, | TRUE, | TRUE}, |
| }; | | | | | | |

In addition, the notion of a SCHEMA definition from the DOMAIN section of the QUERYREQ datagram, which in this case becomes one of the following:

| // | |
|---|---|
| // | Schema types |
| // | |
| enum { | |
| | SCHEMA_BASE, |
| | SCHEMA_USER, |
| | SCHEMA_NATIVE, |

};

In order to determine whether or not a column is supported, the schema type (i.e. SCHEMA_BASE, SCHEMA USER or SCHEMA_NATIVE) is examined. If the schema type is SCHEMA_BASE, then an attempt is made to match the column name in the base Schema definition (above) and return the mapped name or NULL. In the case of SCHEMA_NATIVE, the supplied name is always passed through. SCHEMA_USER may be supported. The following method handles column name mapping:

WCHAR * CQueryHandler::getNativeColumn(DOM_Element &
theNode)
//

| // | Try to map the column name in theNode to the |
|---|---|
| | appropriate |
| // | native column. If we can't map it, return NULL |
| // | |
| { | |

| | |
|---|---|
| int | i; |
| DOMString | node Value; |

nodeValue = theNode.getAttribute(“NAME”);
if (nodeValue != (DOM_NullPtr *)NULL) {

// Depending upon the schema type, we may map
column names to the native
// format, or just pass them back
if (m_schemaType = = SCHEMA NATIVE) {

return nodeValue.rawBuffer( );

} else if (m_schemaType = = SCHEMA BASE) {

for (i = 0; i < sizeof(baseSchema) /
sizeof(SCHEMA); ++i) {

if (!nodeValue.strcmp(baseSchema[i].name)
&& baseSchema[i].query = =

TRUE) {

return baseSchema[i].nativeName;

}

}

| | |
|---|---|
| } else { | // SCHEMA_USER - currently not |
| supported | |

return NULL;

}

}
return NULL;

}

Third, consider the determination of support for optional operators. The following handler supports several optional operators defined thus (using the _operator structure from the first example above):

//

| | |
|---|---|
| // | Supported optional operators |

//
_operator op_operators[ ] = {

| | | |
|---|---|---|
| {L“PHRASE”, | OP_PHRASE, | OP_IND}, |
| {L“NEAR”, | OP_NEAR, | OP_IND}, |

| | | |
|---|---|---|
| {L“SIMILAR”, | OP_SIMILAR, | OP_IND}, |

| | | |
|---|---|---|
| {L“NLP”, | OP_NLP, | OP_IND}, |

};

In order to determine whether or not an operator is supported, an attempt is made to map the name supplied in the <OP> operator to one of the optional operators above. In addition, since GRAFT allows for a new optional operator to be specified by name (i.e. <GRAFT NAME=“xxx”), a check of the list of GRAFTable operators (i.e. the grOperators array in the first code example above) is required in order to support the following query fragment:

<OP NAME=”NEAR”>

Some words close to each other
<GRAFT NAME=”CONTAINS”>

<GRAFT>

<BRANCHCTL ACTION=”QUERYFAIL”/>

</GRAFT>

</GRAFT>

</OP>

Where, the first GRAFT instructs that in the case where NEAR is not supported, it should be replaced with CONTAINS (a required operator).

The following example code is used to return the code (e.g. OP_PHRASE or OP_UNKNOWN) for an unknown optional operator:

WORD CQueryHandler::getOptionalOperator(DOM_Element &
theNode)
{

| | |
|---|---|
| int | i; |

| | |
|---|---|
| DOMString | nodeValue; |

nodeValue = theNode.getAttribute(“NAME”);
if (nodeValue != (DOM_NullPtr *)NULL) {

// First, look in optional operators
for (i = 0; i < sizeof(opOperators) /
sizeof(OPERATOR); ++i) {

if (!nodeValue.strcmp(opOperators[i].name)) {

return opOperators[i].code;

}

}
// Then, in GRAFTable required operators (e.g.
<GRAFT NAME=“xxx”>)
for (i = 0; i < sizeof(grOperators) /
sizeof(OPERATOR); ++i) {

if (!nodeValue.strcmp(grOperators[i].name)) {

return grOperators[i].code;

}

}

}
return OP_UNKNOWN;

}

Lastly, the following example code performs the query optimization. The result is a query tree that is optimized for this handler.

//

| | |
|---|---|
| // | The Query Optimizer |
| // | |
| // | Returns one of: |
| // | |

| | | |
|---|---|---|
| // | BR_TRUE - | The branch of the query tree being examined evaluated to TRUE |
| // | BR_FALSE - | The branch of the query tree being examined evaluated to FALSE |
| // | BR_FAIL - | The query should fail |
| // | BR_GRAFT - | The root node of the branch being examined is unsupported and |

| | |
|---|---|
| // | requires a GRAFT take place |

//
WORD CQueryHandler::optimizeQueryTree(DOM_Element & theNode)
{

| WORD | opType, brreq, brret; |
|---|---|
| DOM_Element | currNode, graftNode; |
| DOM_NodeList | childNodes, graftNodes; |
| int | i, n, j, trueCount, falseCount, childArrayLen |
| | graftArrayLen; |
| DOMString | nodeValue; |
| WCHAR | *nativeCol; |
| BOOL | failed; |

try {

| opType = getOperatorType(theNode, &brreq); | |
|---|---|
| switch(opType) { | |
| case OP_OP: | // Optional operator |
| case OP_COLUMN: | |

// See if we need to do a graft (unsupported operator for OP_OP,
// unsupported column for OP_COLUMN)
//
// getOptionalOperator( ) returns OP_UNKNOWN if the operator is
// unsupported, otherwise OP_<operator>
// getNativeColumn( ) returns the mapping to the native column (i.e.
// the name) or NULL for an unsupported operator
if ((opType = = OP_OP && getOptionalOperator(theNode) = = OP_UNKNOWN) ||

(opType = = OP_COLUMN && ! (nativeCol = getNativeColumn(theNode)))) {
return BR_GRAFT;

}
if (opType = = OP_COLUMN) {

// Replace the column name with the native one so makeNativeQuery( )
// doesn't have to look it up again when we produce native syntax
if (m_schemaType != SCHEMA_NATIVE) {

theNode.setAttribute(L“NAME”, nativeCol);

}

}
// remove GRAFT node (’cause this column is supported)
graftNodes = theNode.getChildNodes( );
childArrayLen = graftNodes.getLength( );
for (n = 0; n < childArrayLen; ++n) {

graftNode = (DOM_Element &)graftNodes.item(n);
if (graftNode.getNodeType( ) = = ELEMENT_NODE) {

// See if it's a GRAFT node
nodeValue = graftNode.getNodeName( );
if (!nodeValue.strcmp(L“GRAFT”)) {

break;

}

}

}
theNode.removeChild(graftNode);
// Fall through and treat COLUMN/OP as regular non terminal operator
// We can pretend OP is non-terminal even though it may not be, since this
// is just an optimization pass

| case OP_ENV: | |
|---|---|
| case OP_AND: | |
| case OP_OR: | |
| case OP_NOT: | |
| case OP_QUERY: | // The root of any query. |

if (opType = = OP_QUERY) {

| | |
|---|---|
| theNode.normalize( ); | // normalize text nodes |

}
childNodes = theNode.getChildNodes( );
trueCount = falseCount = 0;
childArrayLen = childNodes.getLength( );
for (i = 0; i < childArrayLen; ++i) {

currNode = (DOM_Element &) childNodes.item (i);
do {

brret = optimizeQueryTree(currNode);
if (brret = = BR_GRAFT) {

graftNode = currNode;
do {

// Get all of the GRAFT nodes under this one
failed = TRUE;
graftNodes = graftNode.getChildNodes( );
graftArrayLen = graftNodes.getLength( );
for (j = 0; j < graftArrayLen; ++j) {

graftNode = (DOM_Element &)graftNodes.item(j);
if (graftNode.getNodeType( ) = = ELEMENT_NODE) {

node Value = graftNode.getTagName( );
if (nodeValue != (DOM_NullPtr *)NULL &&

! nodeValue.strcmp(“GRAFT”)) {
failed = FALSE;
break;

}

}

}
if (!failed) {

// If a GRAFT node has a NAME attribute, see if we

support

// the operator referenced by NAME. If we do, currNode
// becomes this operator.
nodeValue = graftNode.getAttribute(“NAME”);
if (nodeValue != (DOM_NullPtr *)NULL) {

// Substitute name
currNode.setAttribute(“NAME”, nodeValue);
nodeValue = currNode.getTagName( );
if ((!nodeValue.strcmp(“OP”) &&

getOptionalOperator(currNode) != OP_UNKNOWN) ||
(!nodeValue.strcmp(“COLUMN”) &&
getNativeColumn(currNode))) {
// Operator/Column is ok. break out of this

loop.

// GRAFT nodes underneath this one will be

trimmed

// out when optimizeQueryTree is called for this
// changed node
break;

}

} else {

// No name means a branch graft
// Perform replacement with child node under GRAFT
// Now get the element node under GRAFT
// (we can reuse graftNodes here since we're going

to

// break out of the for loop
graftNodes = graftNode.getChildNodes( );
graftArrayLen = graftNodes.getLength( );
for (j = 0; j < graftArrayLen; ++j) {

graftNode = (DOM_Element &)graftNodes.item(j);
if (graftNode.getNodeType( ) = = ELEMENT_NODE) {

break;

}

}
//we have to have found an element node, 'cause

it's in

// the DTD!
theNode.replaceChild(graftNode, currNode);
currNode = graftNode;
break;

}

}

} while (!failed);
if (failed) {

brret = BR_FAIL;

}

}

} while (brret = = BR_GRAFT);
switch (brret) {
case BR_FAIL:

return BR_FAIL;
break;

case BR_FALSE:

if (brreq = = OP_ALL) {

// Operator requires all true, FALSE branch causes branch FALSE
return BR_FALSE;

} else if (brreg = = OP_ONEFALSE) {

// Operator requires 1 FALSE branch - causes branch TRUE
return BR_TRUE;

} else if (brreq = = OP_ONETRUE) {

// Operator requires 1 TRUE branch, causes branch FALSE
return BR_FALSE;

}
++falsecount;
theNode.removeChild(currNode);
break;

case BR_TRUE:

if (brreq = = OP_ONEFALSE) {

// Operator requires 1 FALSE branch, causes branch FALSE
return BR_FALSE;

} else if (brreq = = OP_ONETRUE) {

// Operator requires 1 TRUE branch, causes branch TRUE
return BR_TRUE;

}
++trueCount;
theNode.removeChild(currNode);
break;

case BR_IND:

break;

}

}
// Done walking children see how this node evaluates
if (trueCount = = childNodes.getLength( ) &&

(brreq = = OP_ALL | | brreq = = OP_ANY)) {
// all true
return BR_TRUE;

} else if (falseCount = = childNodes.getLength( ) && brreq = = OP_ANY) {

// all false
return BR_FALSE;

}
return BR_IND;
break;

case OP_BRANCHCTL:

nodeValue = theNode.getAttribute(“ACTION”);
if (nodeValue != (DOM_NullPtr *)NULL) {

// Get directive
if (!nodeValue.strcmp(“BRANCHTRUE”)) {

return(BR_TRUE);

} else if (!nodeValue.strcmp(“BRANCHFALSE”)) {

return(BR_FALSE);

} else {

return(BR_FAIL);

}

} else {

return(BR_FAIL);

}
break;

default:

return BR_IND;
break;

}

}
catch (...) {

return BR_FAIL;

}
return BR_FAIL;

}

The following section describes system level (infrastructure) XML Document Type Definitions (DTDs) for use between the EIP and component applications. These system level DTDs include the Session Control DTD (“SESSIONCTL”) and the Request Status DTD (“REQSTATUS”).

In general, communications between an EIP system's plugins (e.g. navigation bar) and an underlying component application are conducted by “A datagrams”. An XML datagram is a packet of control information (i.e. either a request or a response) used to communicate between a client and server or between a server and server, encoded in XML, and adhering to a well-defined document type definition (“DTD”). Each plugin type will typically have its own set of request/response XML datagram pairs. Therefore, in order to allow for the use of validating XML parsers, each request type and response type must have its own well thought out DTD. Such DTDs are provided by the exemplary embodiment of the invention.

In particular, the exemplary embodiment has three distinct communication exchange types for communications between an EIP and an integrated application, as follows:

1. Session Control (to establish and maintain active sessions on behalf of a user between EIP and the integrated application).

2. Navigation bar requests/responses (to obtain a hierarchy from the integrated application that should be placed in the EIP navigation bar).

3. Search (perform search and retrieval against an integrated application).

In general, the DTDs and XML datagrams of the method described herein have the following unique features and advantages:

4. Generalization. It is general enough to be used effectively by component applications and contains a minimum of application specific encoding.

5. Well Bounded. Element rules are well defined in order to minimize post-parsing effort required.

6. Character Set Encoding. Character encoding is via UTF-8.

7. Location of DTDs. DTDs are be distributed (or made available) to all validating XML parsers.

8. Validation of DTDs. Using a well-defined DTD allows for simpler post-parsing code to be written. The DTD itself, however, is validated in much the same way as an application protocol interface (“API”). To validate a DTD, XML files are written for each valid and non-valid case defined in the DTD, and a simple parser must be run on each of these files testing simply that valid XML files are successfully parsed and invalid XML files are not.

The Session Control DTD (“SESSIONCTL”) and the Request Status DTD (“REQSTATUS”) will now be described in detail.

The Session Control DTD (SESSIONCTL) is used to request establishment, request termination and to “keep alive” application session instances. For applications that require session, the EIP establishes a “global” application session valid for the life of the portal instance, and a per-user application session valid from user logon time to user logoff time (requested or via timeout).

SESSIONCTL typically contains two elements, “IDENTITY” and “SESSION”. The SESSION element is required. The IDENTITY element is optional since SESSIONCTL is used both to request a session (in which case it is provided) and to return a session ID (in which case it is not required). SESSIONCTL is used for both the request datagram (from the EIP plugin) for session control and the corresponding response datagram from the component application in the case where a new session is established. In all other request cases, the component application should use a datagram encoded using the REQSTATUS DTD to return either “SUCCESS” or an indication of error.

Now, the IDENTITY element contains authenticating information for the request. Authentication must be in the form of a ticket (“TICKET”) or user ID/password/domain style credentials (“KEYS”) or an indication that the request should be made as the anonymous user (“ANONYMOUS”). The SESSION element controls application session instantiation, destruction and periodic renewal. When the EIP is making a request, “REQUEST” (and dependent attributes) must be filled in as appropriate. When a response is returned by a component application, only ID. The SESSION element has a “CFGINFO” sub-element that provides a location for the transmission of application specific configuration information. The characteristics of each of these elements are listed below.

| | |
|---|---|
| Element | IDENTITY |
| Purpose: | Provide authentication information regarding the user on whose |
| | behalf the request is being made. |

Allowable sub-elements: (KEYS \ TICKET) ANONYMOUS)

| Attributes: | Name: | USERAGENT |
|---|---|---|
| | Description: | Contains the USER AGENT field retrieved from HTTP |
| | | requests from the user's browser. Used by the application to |
| | | target specific browsers. |
| | Type: | CDATA |
| | Default: | Required |
| | Name: | LANGUAGE |
| | Description: | Specifies the (human) language to be used for the session. |
| | Type: | (CDATA) Two character ISO abbreviation for language. |
| | Default: | en |
| | Name: | COUNTRY |
| | Description: | Specifies the country information to be used for the session. |
| | Type: | (CDATA) Two character ISO abbreviation for country. |
| | Default: | US |
| Element | KEYS | |
| Purpose: | Allows a user id/password/domain set to be passed to the server in order to | |
| | perform authentication on the requested search. The KEYS element may | |
| | contain child KEYS elements in order to allow for multiple key sets to be | |
| | passed to an application handler. | |
| Sub-elements: | KEYS* | |
| Attributes: | Name: | USERID |
| | Description: | The textual user id. |
| | Type: | CDATA |
| | Default: | Required |
| | Name: | PASSWORD |
| | Description: | The textual password. |
| | Type: | CDATA |
| | Default: | Required |
| | Name: | QUALIFIER |
| | Description: | A qualifier to determine where USERID & |
| | | PASSWORD are valid. For Windows NT, this would |
| | | be the Domain. |
| | Type: | CDATA |
| | Default: | Implied |
| | Name: | NAME |
| | Description: | An optional differentiator for KEYS. For example, |
| | | NAME=”MSX” to signify Microsoft Exchange |
| | | credentials. |
| | Type: | CDATA |
| | Default: | Implied |
| Example: | <KEYS userid=”cam.stevenson” | |
| | password=”notmypassword” qualifier=”ottawa”/> | |
| Element | TICKET | |
| Purpose: | Specifies a ticket provided by the CAP. The TICKET element may contain | |
| | child KEYS elements in order to allow for multiple key sets to be passed to | |
| | an application handler. Note that since TICKET accepts character data | |
| | (#PCDATA) as well as optional KEYS, that the allowable sub-elements | |
| | becomes ANY to satisfy XML requirements on mixed model sub-elements. | |
| Sub-elements: | ANY | |
| Attributes: | NONE | |
| Example: | <TICKET>{someticketdata}</TICKET> | |
| Element | ANONYMOUS | |
| Purpose: | Specifies that this transaction should take place in the context of the | |
| | anonymous user. The ANONYMOUS element may contain child KEYS | |
| | elements in order to allow for multiple key sets to be passed to an | |
| | application handler. | |
| Sub-elements: | KEYS* | |
| Attributes: | NONE | |
| Example: | <ANONYMOUS/> | |
| Element | SESSION | |
| Purpose: | Allows control of application session | |
| Allowable sub-elements: | CFGINFO | |
| Attributes: | Name: | ID |
| | Description: | Identifier for an established session |
| | Type: | CDATA |
| | Default: | Implied |
| | Name: | REQUEST |
| | Description: | The action to be taken for the application session. |
| | Type: | ESTABLISH \| DESTROY \| KEEPALIVE |
| | Default: | Implied |
| | Notes: | REQUEST can be one of the following: |
| | | ESTABLISH - Establish a new session. ID will not |
| | | exist in the case where SCOPE=”GLOBAL”, but |
| | | should be set to the global session ID where |
| | | SCOPE=”USER”. |
| | | DESTROY - Destroy an established session. ID must |
| | | be valid |
| | | KEEPALIVE - Stop an existing session from timing |
| | | out. ID must be valid. |
| | Name: | TIMEOUT |
| | Description: | Provide an indication to an application when it should |
| | | time out the session if it has not received either |
| | | REQUEST=”KEEPALIVE” or any other requests |
| | | which use the session. Expressed in minutes. |
| | Type: | %INTEGER; |
| | Default: | Implied. If TIMEOUT is not specified, the session |
| | | will not time out |
| | Notes: | It is the responsibility of the application receiving the |
| | | request to cause timeout of sessions it has created. |
| | | Also, a timeout on the global session should cause all |
| | | associated user sessions to be destroyed. |
| | Name: | SCOPE |
| | Description: | Describes the scope of the session being requested or |
| | | being acted upon |
| | Type: | (GLOBAL \| USER) |
| | Default: | USER |
| | Notes: | The SCOPE attribute is used to control the type of |
| | | session being requested or acted upon. |
| | | SCOPE=”GLOBAL” indicates that a global |
| | | application session is being acted upon. |
| | | SCOPE=”USER” indicates that a per-user |
| | | application session is being acted upon. Where a component |
| | | application requires session, the plugin will request a |
| | | single global session, and an application session for |
| | | each user as required. |

| | |
|---|---|
| Notes: | The ID attribute should always be specified, except in the case where |
| | SCOPE=” GLOBAL” and REQUEST=”ESTABLISH” (i.e. the request to |
| | establish a global session). Once a global session has been established, |
| | requests to establish individual user sessions should contain ID, set to the |
| | global session ID. |
| Element | CFGINFO |
| Purpose: | Provides a location for the transmission of application specific |
| configuration information. | |
| Sub-elements: | #PCDATA |
| Attributes: | NONE |
| Example: | <CFGINFO>some config info</CFGINFO> |

For example, the following is the DTD code for a session control request (i.e. “SESSIONCTL”).

<!--

| | |
|---|---|
| # Name: | hcleip_sessionctl_V1.dtd |

| # Description: | DTD for XML based datagrams - |
|---|---|
| | session control |

| | |
|---|---|
| # Version: | 1.3 |
| # Organization: | Hummingbird Communications Ltd. |
| # Date: | November 13, 1999 |

-->
<!--

#
# Changes since 1.2:
#
# REQUEST attribute on SESSION becomes IMPLIED
# from REQUIRED
# Changes since 1.1:
#
# <KEYS> can accept sub <KEY> elements
# <KEYS> may have new attribute NAME
#
# Changes since 1.0:
#
#
# <IDENTITY> becomes optional on <SESSIONCTL>
#

-->
<!ENTITY % BOOLEAN “(TRUE | FALSE)”>
<!ENTITY % INTEGER “CDATA”>
<!ENTITY % SESSCTL “(ESTABLISH | DESTROY |
KEEPALIVE)”>
<!ENTITY % SCOPE “(GLOBAL | USER)”>
<!ELEMENT SESSIONCTL (IDENTITY?, SESSION)>
<!ELEMENT IDENTITY (KEYS | TICKET | ANONYMOUS)>
<!ATTLIST IDENTITY

| | | |
|---|---|---|
| USERAGENT | CDATA | #REQUIRED |
| LANGUAGE | CDATA | “en” |
| COUNTRY | CDATA | “US” |

>
<!ELEMENT KEYS (KEYS*)>
<!ATTLIST KEYS

| | | |
|---|---|---|
| USERID | CDATA | #REQUIRED |
| PASSWORD | CDATA | #REQUIRED |
| QUALIFIER | CDATA | #IMPLIED |
| NAME | CDATA | #IMPLIED |

>
<!--

# TICKET accepts multiple KEYS and #PCDATA for the
ticket itself
# unfortunately this is not expressable in XML so
we use the
# ANY element for allowable children

-->
<!ELEMENT TICKET ANY>
<!ELEMENT ANONYMOUS (KEYS*)>
<!ELEMENT SESSION (CFGINFO?)>
<!ATTLIST SESSION

| | | |
|---|---|---|
| ID | CDATA | #IMPLIED |

| | | |
|---|---|---|
| REQUEST | %SESSCTL; | #IMPLIED |
| TIMEOUT | %INTEGER; | #IMPLIED |
| SCOPE | %SCOPE; | “USER” |

>

Consider the following four additional examples. First, to establish a global session, the plugin would send the following “SessionCTL” datagram

<?xml version=‘1.0’ encoding=‘utf-8’ ?>
<!DOCTYPE SESSIONCTL SYSTEM “hcleip_sessionctl_V1.dtd”>
<SESSIONCTL>

<IDENTITY USERAGENT=”IE4.0xxxxx”>

<KEYS USERID=“the_portal_user” PASSWORD=“foobar”

QUALIFIER=“ottawa”/>

</IDENTITY>
<SESSION REQUEST=”ESTABLISH”SCOPE=”GLOBAL”/>

</SESSIONCTL>

On success, the component application would send the following datagram:

<?xml version=‘1.0’ encoding=‘utf-8’ ?>
<!DOCTYPE SESSIONCTL SYSTEM “hcleip_sessionctl_V1.dtd
< SESSIONCTL >

<SESSION ID=”{82371923871298312}”/>

</ SESSIONCTL >

Second, to keep a global session alive, the plugin would send the following datagram:

<?xml version=‘1.0’ encoding= ‘utf-8’ ?>
<!DOCTYPE SESSIONCTL SYSTEM “hcleip_sessionctl_V1.dtd”>
<SESSIONCTL>

<IDENTITY USERAGENT=”IE4.0xxxxx”>

<KEYS USERID=“the_portal_user” PASSWORD=“foobar”

QUALIFIER=“ottawa”/>

</IDENTITY>
<SESSION ID=”the_global_session_id” REQUEST=”KEEPALIVE”/>

</SESSIONCTL>

On success, the component application would send the following datagram:

<?xml version=‘1.0’ encoding=‘utf-8’ ?>
<!DOCTYPE REQSTATUS SYSTEM “hcleip_reqstatus_V1.dtd”>
<REQSTATUS>

<ERROR CODE=”NOERROR”/>

</REQSTATUS>

Third, to establish a user session, the plugin would send the following datagram:

<?xml version=‘1.0’ encoding=‘utf-8’ ?>
<!DOCTYPE SESSIONCTL SYSTEM “ hcleip_sessionctl_V1.dtd ”>
<SESSIONCTL>

<IDENTITY USERAGENT=”IE4.0xxxxx”>

<KEYS USERID=“cam.stevenson”
PASSWORD=“foobar” QUALIFIER=“ottawa”/>

</IDENTITY>
<SESSION ID=”the_global_session_id”
REQUEST=”ESTABLISH”/>

</SESSIONCTL>

On success, the component application would send the following datagram:

<?xml version=‘1.0’ encoding=‘utf-8’ ?>
<!DOCTYPE SESSIONCTL SYSTEM “hcleip_sessionctl_V1.dtd ”>
< SESSIONCTL >

<SESSION ID=”{3123453871765312}”/>

</ SESSIONCTL >

Fourth, to destroy an established user session, the plugin would send the following datagram:

<?xml version=‘1.0’ encoding=‘utf-8’ ?>
<!DOCTYPE SESSIONCTL SYSTEM “hcleip_sessionctl_V1.dtd ”>
<SESSIONCTL>

<IDENTITY USERAGENT=“IE4.0xxxxx”>

<KEYS USERID=“cam.stevenson”
PASSWORD=“foobar” QUALIFIER=“ottawa”/>

</IDENTITY>
<SESSION ID=”{3123453871765312}” REQUEST=”DESTROY”/>

</SESSIONCTL>

On success, the component application would send the following datagram:

<?xml version=‘1.0’ encoding=‘utf-8’ ?>
<!DOCTYPE REQSTATUS SYSTEM “hcleip_reqstatus_V1.dtd”>
<REQSTATUS>

<ERROR CODE=”NOERROR”/>

</REQSTATUS>

The Request Status DTD (REQSTATUS) DTD is used by the component application to return the status of a request (from a EIP plugin) to the EIP plugin in the case where there is not need to return any other information. The REQSTATUS DTD typically contains one “ERROR” element. The ERROR element provides an indication to the EIP plugin as to the success or failure of the request. The characteristics of this element are listed below.

| Element | ERROR | |
|---|---|---|
| Purpose: | Provide indication of an error, or indication of a successful request in the | |
| | absence of response data. | |
| Allowable sub-elements: | NONE. | |
| Notes: | The ERROR element consists of a CODE attribute, which is selected out | |
| | of a well-defined list. To provide more information to support personnel | |
| | attempting to determine the cause of a failure, the REASON attribute | |
| | should contain a more specific error code or a more detailed explanation of | |
| | the failure. | |
| Attributes: | Name: | CODE |
| | Description: | One of a well-defined list of failure codes. |
| | Type: | (NOERROR \| NOAUTH \| BADAUTH \| BADFORM \| |
| | | INVPARM \| IMMFAIL \| SERVFAIL \| |
| | | BADSESSION \| NOLIC \| NODTD) |
| | | (As well as Query & MetaData errors) |
| | Default: | Required |
| | Notes: | CODE must contain one of a well-defined list of errors, |
| | | defined thus: |
| | | NOERROR - No error occurred. This should be used to |
| | | indicate the success of an operation In the absence of |
| | | response data. |
| | | NOAUTH - Required authentication credentials were needed |
| | | and not supplied in the request. |
| | | BADAUTH - Credentials supplied in the request were invalid. |
| | | BADFORM - Request datagram was not well-formed XML. |
| | | INVPARM - Validation failed on request datagram, or a |
| | | parameter specified in the request was invalid. |
| | | IMMFAIL - the server/application believes that failure is |
| | | imminent (clean up and log off). |
| | | SERVFAIL - a server/application failure prevented the request |
| | | from being fulfilled. |
| | | BADSESSION - the session referenced in the request |
| | | was not available, either because it did not exist or |
| | | because it did not belong to the specified user. |
| | | NOLIC - No licenses were available to service the |
| | | rqeuest |
| | | NODTD - the referenced DTD was not available, |
| | | either because it did not exist or due to a versioning |
| | | mismatch. |
| | Name: | REASON |
| | Description: | An application specific descriptive reason or error |
| | | message. |
| | Type: | CDATA |
| | Default: | Implied |

| | |
|---|---|
| Example: | <ERROR CODE=”INVALID” REASON=”Line 4”/> |

<ERROR CODE=”NOAUTH” REASON=”No soup for you!”>

For example, the following is the DTD code for a status request (i.e. “REQSTATUS”).

<!--

| | |
|---|---|
| # Name: | hcleip_reqstatus_V1.dtd |
| # Description: | DTD for XML based query datagrams - status of request |
| # Version: | 1.2 |
| # Organization: | Hummingbird Communications Ltd. |
| # Date: | November 12, 1999 |

-->
<!--

| # | |
|---|---|
| # | Changes since 1.1: |
| # | |
| # | New error codes for searching (QRYERRCODES) |
| # | New error codes for meta data (MDERRCODES) |
| # | |
| # | |
| # | Changes since 1.0: |
| # | Added the following ERRCODES: |
| # | |
| # | NOLIC - No more licenses available |
| # | NODTD - The DTD that the request is based on is not supported |
| # | |
| # | Changes since 1.1: |
| # | |
| # | Added QRYERRCODES |
| # | |

-->
<!ENTITY % BOOLEAN “(TRUE | FALSE)”>
<!ENTITY % INTEGER “CDATA”>
<!ENTITY % ERRCODES “NOERROR | NOAUTH | BADAUTH | BADFORM | INVPARM |
SERVFAIL | IMMFAIL | BADSESSION | NOLIC | NODTD”>
<!ENTITY % QRYERRCODES “QRY_NODOCS | QRY_CANTHANDLE | QRY_BADOP | QRY_BADCOL
| QRY_BADITEM | QRY_BADID | QRY_BADSCHEMA”>
<!ENTITY % MDERRCODES “MD_BADCLASS | MD_BADDATA”>
<!ELEMENT REQSTATUS (ERROR)>
<!ELEMENT ERROR EMPTY>
<!ATTLIST ERROR

| CODE | (%ERRCODES; \| %QRYERRCODES; \| %MDERRCODES;) #REQUIRED | |
|---|---|---|
| REASON | CDATA | #IMPLIED> |

Consider the following two additional examples. First, if the request is completed successfully, the following “REQSTATUS” datagram is sent:

<?xml version=‘1.0’ encoding=‘utf-8’ ?>
<!DOCTYPE REQSTATUS SYSTEM “hcleip_reqstatus_V1.dtd”>
<REQSTATUS>

<ERROR CODE=”NOERROR”/>

</REQSTATUS>

Second, if the request failed due to an authentication error, the following “REQSTATUS” datagram is sent:

<?xml version=‘1.0’ encoding=‘utf-8’ ?>
<!DOCTYPE REQSTATUS SYSTEM “hcleip_reqstatus_V1.dtd”>
<REQSTATUS>

<ERROR CODE=”NOAUTH” REASON=”Not permitted to log
in at this time of

day”/>
</REQSTATUS>

The following classes were referred to above:

Classes

EIPServlet Class

Declaration

public class com.hcl.portal.server.EIPServlet extends HttpServlet implements WatchDo,TimerListener

Documentation

This class implements a Java servlet to accept client (web browser) queries for search text and documents from Search Server.

Operations

public String getMimeType( String s)

Documentation

This method accepts a file name and returns the standard MIME types. This can be used by any portion of the portal to determine the format of a document. It uses the mime.properties file to lookup types.

param

s The name of the file to lookup

return

String The standard MIME type for the specified file

private void loadMimeProps( )

Documentation

This method loads the MIME type names into an internal property object. This is used by the getMimeType( ) method to determine the type of file being accessed.

public void WatchDogTimerEvent( )

Documentation

This method implements the WatchDogTimer event handler used by the portal. It is used to keep track of session timeouts for all users of the portal

public WatchDogTimer getWatchDogTimer( )

Documentation

This method returns the portal instance of the watchDog timer object. This can be passed from the content manager to various plugins.

return

WatchDogTimer An instance of the portal's watchdog timer

public String getServletUrl( )

Documentation

Return the full URL for the servlet

return

String A String containing the full path to the portal servlet

private void determineLocale( HttpServletRequest req, HttpSession session)

private String buildUserSessionTable( )

Documentation

This method is an admin level function to build the user session table data This is used to display information about the users currently logged in to the portall, and provides data such as user names, and systems. This feature also allows the administrator to invalidate sessions.

return

Returns an HTML formatted list of user infor wrapped in tags.

private void commandRefreshPlugin(HttpServletResponse resp, HttpSession session, Hashtable urlParameters, String cmd) throws IOException

private void commandSessionSnoop(Properties userProps, PrintWriter out)

private void commandHomePage(HttpServletResponse resp, HttpSession session, Hashtable urlParameters, String cmd) throws IOException

private void commandPage(HttpServletResponse resp, HttpSession session, Hashtable urlParameters, String cmd) throws IOException

private void commandBlankPage(HttpServletResponse resp, HttpSession session, Hashtable urlParameters, String cmd) throws IOException

private void commandLogout(HttpServletResponse resp, HttpSession session, Hashtable urlParameters, String cmd) throws IOException

private void commandImage(HttpServletResponse resp, HttpSession session, Hashtable urlParameters, String cmd) throws IOException

private boolean crcateUserSession(HttpServletRequest req)

Documentation

This method returns a handle to the current user session. If the session does not exist, it will be created and initialized. As part of initialization the user's configuration block will be retrieved from the repository and he will be forced to login to the portal.

param

req The servlet request block for this transaction

return

boolean True if the session was created

private void doServletInitialization(HttpServletRequest req,

HttpServletResponse resp)

Documentation

This method handles all of the first time initialization for the portal servlet.

param

req The servlet request

param

resp The servlet response

private String getParameter(Hashtable urlParameters, String parameterName)

Documentation

This help method is called by handleRequest( ) in order to get parameters from the incoming URL.

param

urlParameters A hashtable containg the URL parameters for the request

param

parameterName The name of the parameter to retrieve

return

String The value of the specified parameter.

private final void processRequest(HttpServletRequest req, HttpServletResponse resp, Hashtable urlParameters) throws ServletException, IOException

Documentation

Handle servlet requests from the client. This method parameterizes the request query string and invokes the method to handle it

param

req Servlet request object

param

resp Servlet request object

see

doPost

see

doGet

public void doGet(HttpServletRequest req, HttpServletResponse resp) throws ServletException, IOException

Documentation

Handle GET requests to the servlet. This method parameterizes the request query string and invokes the method to handle it

param

req Servlet request object

param

resp Servlet request object

see

doPost

public void doPost(HttpServletRequest req, HttpServletResponse resp) throws ServletException, IOException

Documentation

Handle requests POSTed to the servlet. This method parameterizes the request and invokes the method to handle it

param

req Servlet request object

param

resp Servlet request object

see

doGet

public String getLocalizedString(String stringKey, Locale locale)

Documentation

Given a key from the ServerListResourceBundle and a locale, this method will return the key's localized string.

if for some reason locale is null, this method returns the string from the servlet's default locale.

if the ListResourceBundle for the locale hasn't been loaded, this method returns the string from the servlet's default locale.

if the key is not found in the ListResourceBundle, this method returns null.

param

stringkey-

param

locale-

return

‘stringKey's value localized to ‘locale’

public ThemeManager getThemeManager( )

Documentation

This method returns the instance of the plugin manager

return

PluginManager The object that manages plugin execution

public PluginManager getPluginManager( )

Documentation

This method returns the instance of the plugin manager

return

PluginManager The object that manages plugin execution

public ContentManager getContentManager( )

Documentation

This method returns the instance of the content manager

return

ContentManager The object that manages rendering of page content

public ApplicationSessionManager getApplicationSessionManager( )

Documentation

This method returns the instance of the application session manager

return

ApplicationSessionManager The object that manages session in cooperating applications

public RepositoryManager getRepositoryManagero

Documentation

This method returns the instance of the repository manager

return

RepositoryManager The object that manages rendering of page content

public String getPortalProperty(String propertyName)

Documentation

This method returns the specified value from the portal properties object

return

String The value of the specified property

public Vector getGlobalPluginVector( )

Documentation

This method returns a vector containing all cached plugins that are available to all users of the portal server. Caching such components eliminates the requirement to process many network transactions to do the same operation, resulting in vastly improved performance.

return

Vector containing all globally cached plugins

public void init(ServletConfig config) throws ServletException

Documentation

Initialize the servlet instance. This method is called only once during the lifetime of the servlet.

Attributes

private String thisServlet

Documentation

Keeps track of the last query string, so it can be referenced later

private final String MIME_PROPERTY_FILE

private Properties mimeProps

Documentation

List of MIME properties supported by the image loader

private Properties portalProperties

Documentation

The configuration properties of the portal

private HttpSessionContext servletContext

Documentation

The context of this servlet—used to track sessions

private Locale defaultLocale

Documentation

Default user locale—mayhaps we won't need this*

private Hashtable serverLRBHashtable

Documentation

Hashtable of Server List Resource Bundles*

private Vector globalPluginVector

Documentation

Vector of cached plugins that are global to all users in the portal

private ApplicationSessionManager am

Documentation

The session manager for cooperating applications

private ThemeManager tm

Documentation

The theme manager for the portal

private RepositoryManager rm

Documentation

The repository for the portal

private PluginManager pm

Documentation

The plugin manager for the portal

private ContentManager cm

Documentation

The content manager for the portal

private boolean initialRequest

Documentation

Flag to indicate first time initialization

private final int MAX_IDLE_TIME

Documentation

Maximum Idle time in milliseconds before a session times outs

private final int WD_TIMER_INTERVAL

Documentation

Default watch dog timer interval in seconds

private WatchDogTimer wdTimer

Documentation

The watchdog timer used by the server

static private final String defaultLanguageCode

static private final String defaultCountryCode

Documentation

codes from iso639 and iso3166*

static public final String LOGIN_RESULT_PAGE

static public final String LOGIN_DOMAIN_PAGE

static public final String LOGIN_SIMPLE_PAGE

static public final String LOGIN_PAGE

static public final String LOGOUT_PAGE

static public final String BLANK_PAGE

static public final String ACCESS_ERROR_PAGE

static public final String CMD_REFRESH

static public final String CMD_LOGOUT

static public final String CMD_LOGIN

static public final String CMD_HOME_PAGE

static public final String CMD_PAGE

static public final String CMD_IMAGE

static public final String URL_PLUGIN

static public final String URL_THEME

static public final String URL_GROUP

static public final String URL_USER

static public final String URL_OBJECT

static public final String URL_COMMAND

static public final String SESSION_STATUS_TIMEOUT

static public final String SESSION_STATUS_FAILED

static public final String SESSION_STATUS_CONNECTED

static public final String SESSION_STATUS_CONNECTING

static public final String SESSION_STATUS_LOGIN

static public final String SESSION_THEME

static public final String SESSION_USER_AGENT

static public final String SESSION_USERNAME

static public final String SESSION_USERCFG

static public final String SESSION_TICKET

static public final String SESSION_STATUS

static public final String SESSION_RESOURCES

static public final String SESSION_REPLACER

static public final String SESSION_PLUGINS

static public final String SESSION_LOCALE

static public final String SESSION_LANGUAGE

static public final String SESSION_HOST_ADDR

static public final String SESSION_HOST

static public final String SESSION_COUNTRY

static public final String USER_ANONYMOUS

static public final String USER_DEFAULT

static public final String USER_PORTAL

int hitCtr

Replacer Interface

Declaration

public abstract interface com.hcl.portal.utility.Replacer

Operations

public String replaceTokens(String text)

WatchDogTimer Class

Declaration

public class com.hcl.portal.utility.WatchDogTimer extends Thread

Operations

public void run( )

Documentation

Runs the timer. The timer will run until stopped and fire a WatchDogTimerEvent notification every clock cycle

public void removeWatchDogTimerListener(WatchDogTimerListener obj)

Documentation

Set the object that gets sent in the event package when the timer event occurs

param

obj The object that gets sent to the event listener

public void addWatchDogTimerListener(WatchDogTimerListener obj)

Documentation

This method adds the specified watch dog timer listener to the listener vector.

When an event occurs all events in this vector will be called.

param

obj The object that gets event notification

public WatchDogTimer(int timeCycle, boolean retrigger)

Documentation

Constructs a new Timer object

param

timeCycle Number of seconds in each timer cycle

param

retrigger Set if the timer is automatically retriggered

Attributes

private Vector objectVector

private boolean retrigger

private int timeCycle

eClipManager Class

Declaration

public class com.hcl.portal.manager.eclip.eClipManager extends PortalManager

Operations

private PortaleClip findeClip(Vector eClipVector, String eClipName, String eClipGuid, String eClipRequest)

Documentation

This method searchs the specified e-clip cache for a specified e-clip identified by name, guid and possibly request.

param

eClipVector The eClip cache to be searched

param

eClipName The name of the eClip to be located.

param

eClipGuid The guid of the eClip to be located.

param

eClipRequest The request of the eclip to be located.

return

PortaleClip The e-clip instance located (can be null if not found)

private String rendereClipDisplay(PortaleClip eClip, PortalSession session, Hashtable urlParameters, String pageName)

Documentation

This method renders the e-clip contents using the appropriate template file. eClips can be rendered with or without a title bar, and the current theme is used to determine and load the correct file.

param

eClip The eClip to be rendered

param

session An reference to the current user session

param

pageName The name of the page that owns the eClip

return

String A string containing the rendered eclip

public void removeCachedeClip(Vector globaleClipVector, Vector sessioneClipVector, String eClipName, String eClipGuid)

Documentation

This method removes the specified object from the global or session caches as required. This is typically used to force a e-clip to refresh itself

param

globaleClipVector The global eclip cache

param

sessioneClipVector The session eclip cache

param

eClipName The name of the eClip to be located.

param

eClipGuid The guid of the eclip to be located.

private void insertCachedeClip(Vector globaleClipVector, Vector sessioneClipVector, PortaleClip eClip)

Documentation

This method inserts the specified object into the global or session caches as required. This is to allow objects to be cached for much faster access.

param

globaleClipVector The global eClip cache

param

sessioneClipVector The session eClip cache

param

eClip The instance of the eClip to be cached

private void setupeClip(PortaleClip eClip, PortalSession session, Hashtable urlParameters, String pageName, eClipinformation pinfo)

Documentation

This method configures the c-clip contents using the specified data.

param

eClip The eClip to be rendered

param

session An reference to the current user session

param

urlParameters The original parameters from the URL command

param

pageName The name of the page that owns the eclip

param

pinfo The reference to the block of eClip attribute information

public String executeeClip(eClipThread eClipThread)

Documentation

This method accepts a e-clip name and a request for that e-clip and executes the request. This generates a response which is preserved within the e-clip attribute space. The method first determines if the eClip has a cached scope. If it does and the request is the same as one previously generated. The result is simple extracted from the eClip without re-executing it, resulting in vastly improved performance.

param

session The user session that is executing this eClip

param

urlParameters The parameter block from the original URL request

param

eClipName The unique name of the e-clip to execute

param

eClipRequest The request string for this e-clip to process

param

pinfo The details of the eClip (name, pageref, border, etc.)

public RepositoryManager getRepositoryManager(Object caller)

Documentation

This method returns the instance of the repository manager

param

caller The object making this request

return

eClipManager The object that manages e-clip loading and execution

public eClipManager(EIPServlet parent)

Documentation

This constructor creates a new instance of the e-clip manager

PortalComponent Class

Declaration

public abstract class com.hcl.portal.manager.eclip.PortalComponent implements Serializable

Documentation

This class acts as the base class for all portal e-clips and components. It defines the request and response data as well as defining the request handling mechanism.

Operations

public abstract void handleRequest( )

Documentation

This method is abstract and hence must be defined by all derived classes. It is automatically called by the portal server when it wants this component/e-clip to process the request data and produce a response string.

public String getResponse( )

Documentation

This method returns the current response data

return

String A string containing the response data

public void setResponse(String response)

Documentation

This method assigns a response buffer to this component.

param

response A string containing the response data this component/e-clip

public String getRequest( )

Documentation

This method returns the current request data

return

String A string containing the request data

public void setRequest(String request)

Documentation

This method assigns a request buffer to this component.

param

request A string containing the request data this component/e-clip

public String getName( )

Documentation

This method returns the unique name of this component/e-clip.

return

String The unique name of this component

public void setName(String name)

Documentation

This method assigns a unique name to this component.

param

name A string containing the unique name of this component/e-clip

public void setAsynchronous(boolean asynch)

Documentation

This method sets the asynchronous operation flag. If a component is flagged as asynchronous, the eClip manager will start a thread to execute the component. This is useful for executing multiple independent components in parallel. The output of each asynchronous component can be subsequently merged into a final component.

param

asynch A boolean flag set to true if this component can be run asynchronously

public boolean isasynchronous( )

Documentation

This method return the asynchronous operation flag. If a component is flagged as asynchronous, the eClip manager will start a thread to execute the component. This is useful for executing multiple independent components in parallel. The output of each asynchronous component can be subsequently merged into a final component.

return

boolean The asynchronous operation flag.

public PortaleClip getParent( )

Documentation

This method returns the reference to the parent e-clip instance.

return

PortaleClip An instance of the parent eclip class

public void setParent(PortaleClip parent)

Documentation

This method assigns the parent component/e-clip value for this instance. This provides acces to public portions of the owner owner object from within and component or e-clip.

param

parent A reference to the parent e-clip for this instance

private void readObjectoiava.io.ObjectInputStream in) throws IOException, ClassNotFoundException

private void writeObject(java.io.ObjectOutputStream out) throws IOException

public PortalComponent( )

Documentation

Construct a new instance of a portal component

Attributes

private boolean asynch

Documentation

The asynch operation flag. Use by the PM to run components in parallel

public String response

Documentation

The current response value

private String request

Documentation

The current request value

private String name

Documentation

The unique name for this object

Association links

PortaleClip parent

Documentation

The part object that owns this component

PortaleClip Class

Declaration

public class com.hcl.portal.manager.eclip.PortaleClip extends PortalComponent implements SecurePortalComponent Serializable

Operations

private String executeComponent(PortalComponent comp, String request)

Documentation

This method execute a component from the internal component chain of this e-clip.

param

PortalComponet A reference to the specified component

param

String A request string that may be passed into this component

return

String The result of the component execution

public void handleRequest( )

Documentation

This method processes the request for this e-clip and builds a response. It does this by sequentially traversing the component list passing the results of one component to the request of another.

public void initialize( )

Documentation

This method is called by the eClip manager whenever this e-clip will be forcibly refreshed. I simply removed the request string from all but the first component in the chain. This forces every component to re-execute without relying on any previously cached information.

public PortalComponent addComponent(String compName, String request)

Documentation

This method can be called to add a new component to the e-clip component chain. It simply creates and adds a new component instance to the vector. This method should be used with caution because adding components after request processing has occurred with produce undesired results.

param

compName A string containing the unique name of the component to add

return

PortalComponent The instance of the component object that was created or null

public Vector getComponentVector( )

Documentation

This method returns a reference to the portal component vector

return

Vector A reference to the internal portal component list

private String getLine(BufferedReader fileReader) throws IOException

Documentation

This helper method is called by the e-clip script loader to read lines from the script file. It returns a line that is devoid of leading and trailing whitespace

param

fileReader The reader from which data is being read

return

String A string containing trimmed text

private void handleReshreshLine(String lowerLine)

Documentation

This method is invoked during e-clip script parsing whenever the e-clip includes a “refresh” entry. This is used to indicate when this e-clip data becomes invalid (forcing a refresh).

param

lineString The line containing the pageRef entry

public void handleCacheLine(String lowerLine)

Documentation

This method is invoked during e-clip script parsing whenever the e-clip includes a “cache” entry. This is used to control if and where this e-clip is cached within the portal memeory space.

param

lowerLine The line containing the pageRef entry

private void handleBorderLine(String lowerLine)

Documentation

This method is invoked during e-clip script parsing whenever the e-clip includes a “border” entry. This is used to draw a border around the e-clip when it is displayed.

param

lowerLine The line containing the pageRef entry

private void handleShowRefreshTimeFlag(String lowerLine)

Documentation

This method is invoked during e-clip script parsing whenever the e-clip includes a “showRefreshTime” entry. This is used to control whether the e-clip is drawn with a caption containing the last refresh time for this component.

param

lowerLine The line containing the pageRef entry

private void handleUnboundedFlag(String lowerLine)

Documentation

This method is invoked during e-clip script parsing whenever the e-clip includes a “unbounded” entry. This is used to control whether the e-clip is drawn within a bounding table or not. Use of this method is dangerous for normal e-clips and is meant for internal use only.

param

lowerLine The line containing the pageRef entry private void handleShowRefreshButtonFlag(String lowerLine)

Documentation

This method is invoked during e-clip script parsing whenever the e-clip includes a “showRefreshButton” entry. This is used to control the visiblity of the refresh button within the titlebar of the displayed e-clip.

param

lowerLine The line containing the pageRef entry

private void handlePageReference(String linestring)

Documentation

This method is invoked during e-clip script parsing whenever the e-clip includes a “pageRef” entry. This is used whenever the e-clip supports the “open this info in a new browser” option.

param

lineString The line containing the pageRef entry

private void handleTitleLine(String LineString)

Documentation

This method is invoked during e-clip script parsing whenever the e-clip includes a “title” entry. This is used whenever the e-clip wants to specify a default title in the caption bar of the e-clip display.

param

lineString The line containing the pageRef entry

private void configureComponent(PortalComponent comp, String compName, String initialRequest, boolean asynch)

Documentation

This method is called whenever the e-clip script contains a new component reference. It extracts the component data from the script and configures the specified component accordingly.

param

comp The component being configured

param

compName The name of the component

param

initialRequest The optional initial request send to this component

param

asynch Set if this component supports asynchronous operation

public boolean loadComponents(String eClipName)

Documentation

Builds the list of part components from a part description file. Note that the e-clip script must have a “.eClip” extension.

param

eClipName The name of the e-clip being loaded

return

boolean true if the eClip was loaded correctly, false on failure

public String getComponentResponse(String compName)

Documentation

This method returns the response data for a given component in the e-clip component chain. All components in the e-clip are named and this method allows extraction for a given named component. This method should be used with caution as it allows code to intervene in the e-clip handler.

param

compName An string containing the name of the component within the e-clip

return

String A string containing the response data

public String getComponentResponse(int position)

Documentation

This method returns the response data for a given component in the e-clip component chain. Components within the e-clip are sequentially stored starting at an index of 0. This method should be used with caution as it allows code to intervene in the e-clip handler.

param

position An integer containing a zero-based component number within the e-clip

return

String A string containing the response data

public String getGuid( )

Documentation

This method returns the current guid for this e-clip. This value can be null.

return

String The unique ID for this e-clip instance

public void setGuid(String guid)

Documentation

This method assigns an identifer string to this e-clip instance. This identifier is meaningful only for cached components in situations where the portal might be caching multiple instances of the same e-clip type.

param

guid A string containing the unique id

public boolean isStatic( )

Documentation

This method returns the state of a cached e-clip's persistence. A true value indicates that this e-clip is allowed to store persistent data. In this case requests are passed to it as in the transient object case. If this flag is false, then the e-clip is simply stored for cached results. The request is not passed to the e-clip, which simply returns the results of it's original execution.

return

boolean The data persistence state of the e-clip.

public long getLastRefresh( )

Documentation

This method returns the gregorian calendar time when the cached instance was last refreshed.

return

long the time of the last refresh

public long getRefreshTime( )

Documentation

This method returns the current refresh time of the eclip. The refresh time determines when the cached data for the eClip will be discarded and reacquired.

return

long the number of seconds between cache refresh

public Hashtable getUrlParameters( )

Documentation

This method returns the hashtable of url parameter values from the browser request. This gives a e-clip access to any parameters from posted HTML forms and allows total flexability to supply a e-clip with data from outside the portal.

return

Hashtable A hashtable of string arrays of url parameters

public void setUrlParameters(Hashtable urlParameters)

Documentation

This method assigns the hashtable of url parameter values from the browser request. This gives a e-clip access to any parameters from posted HTML forms and allows total flexability to supply a e-clip with data from outside the portal.

param

urlParameters A hashtable of string arrays of url parameters

public String getPageName( )

Documentation

This method returns the page on which this instance resides

return

String The name of the page that created this instance

public void setPageName(String pageName)

Documentation

This method assigns the name of the user page on which this eClip resides

param

pageName The name of the page using this eClip

public String getTitle( )

Documentation

This method returns the current title string for this e-clip. This value can be null.

return

String The title for this e-clip instance

public void setTitle(String title)

Documentation

This method assigns a title to the e-clip instance. This title is meaningful only if the e-clip is drawn with a border.

param

title A string containing the e-clip title

public String getReferenceURL( )

Documentation

This method return a reference to a URL from which this e-clip originated. This reference is used to invoke the “full screen” feature whereby the user can click on a e-clip anddisplay a full web page in a separate window.

return

referenceURL A string containing a URL reference to a full page view

public void setReferenceURL(String referenceURL)

Documentation

This method assigns a reference to a URL from which this e-clip originated. This reference is used to invoke the “full screen” feature whereby the user can click on a e-clip anddisplay a fall web page in a separate window.

param

referenceURL A string containing a URL reference to a full page view

public boolean isRefreshTimeVisible( )

Documentation

This return visiblity state of the refresh time string

return

boolean The state of the e-clip refresh time visibility.

public void setRefreshTimeVisible(int showRefreshTime)

Documentation

This method control whether this e-clip shows the refresh time in the caption line of the rendered display

param

showRefreshTime The state of the e-clip border visibility.

public boolean is RefreshButtonVisible( )

Documentation

This return visiblity state of the manual refresh button

return

boolean The state of the e-clip border visibility.

public void setRefreshButtonVisible(int allowsRefresh)

Documentation

This method control whether this e-clip has a manual refresh button

param

allowsRefresh The state of the e-clip border visibility.

public boolean isunbounded( )

Documentation

This method returns the state of the unbounded flag. If true the e-clip is drawn without a bounding HTML table. Using unbounded e-clips is dangerous and is meant for internal use only.

return

boolean The state of the e-clip unboundedness.

public void setUnbounded(int isUnbounded)

Documentation

This method control whether this e-clip is wrapped in a table cell when it is rendered. If not, the e-clip is given free reign to wreak havoc on the display, otherwise the portal will place it within a table to contain any damage. This method is meant for internal applications and should generally never be used by user e-clips.

param

isUnbounded The state of the e-clip display rendering bounds

public void setBorderVisible(int borderVisible)

Documentation

This method control weather the border of this c-clip is visible

param

borderVisible The state of the e-clip border visibility.

public boolean isBorderVisible( )

Documentation

This method returns the state of the border visibility flag. If true the e-clip is drawn with a border and title bar along with any embellishments (titlebar buttons).

return

boolean The state of the e-clip border visibility.

public int getCacheScope( )

Documentation

This method returns the current cache scope of the eClip

return int Returns CACHE_GLOBAL, CACHE_LOCAL, CACHE_TRANSIENT or CACHE_STATIC

public Object getScratchPadData(String name)

Documentation

This method extract a selected data element from the e-clip's scratch pad memory. The object extracted is untyped, so it must be casted to whatever object type was stored. This determination the responiblity of the component code. If the named object does not exist in the scratch pad, the value returned will be null

param

name The name of the sctachpad data element

return

Object An untyped object containing the data

public void deleteScratchPadData(String name)

Documentation

This removes data from the e-clip's scratch pad.

param

name The name of the scratchpad data element to be removed

public void addScratchPadData(String name, Object obj)

Documentation

This method adds data to the e-clip's scratch pad so it can be shared among any of the e-clip's component parts.

param

name The name of the scratchpad data element

param

obj The data object to be stored in scratch pad memory

public byte[ ] getPersistentData(String hashName)

Documentation

This method retrieves presistent binary data from the repository

param

hashname The name of the data element

return

byte[ ] The binary data element retrieved or NULL if not found

public String getPersistentString(String hashName)

Documentation

This method retrieves presistent string data from the repository

param

hashName The name of the data element

return

String The data element retrieved or NULL if not found

public void putPersistentData(String hashName, bytes data)

Documentation

This method stores presistent binary data to the repository

param

hashName The name of the data element

param

data The data element to store

public void putPersistentString(String hashName, String data)

Documentation

This method stores a presistent data string to the repository

param

hashName The name of the data element

param

data The string data element to store

public void deletePersistentData(String hashName)

Documentation

This method removes a presistent data element from the repository

param

hashName The name of the data element

public void putSessionItem(Object caller, String itemName, Object data)

Documentation

This method returns the specified item from the session. For security reasons e-clips are not allowed to write anything directly to the session. For sessioned data sotrage, e-clips should use the c-clip scratchpade memory available to all cached components.

param

caller The object making this request

param

itemName The name of the session item to write

param

data The object data to store

public Object getSessionItem(String itemName)

Documentation

This method returns the specified item from the session. For security reasons e-clips are not allowed to write anything directly to the session. For sessioned data sotrage, e-clips should use the e-clip scratchpade memory available to all cached components.

param

itemName The name of the session item to write

return

Object The value of the specified session item, or NULL.

public PortalSession getSession(Object caller)

Documentation

This method returns the user session reference within this instance. Note: For security reasons, the session object is settable only if the eClip is cached in the user session. Globally cached e-clips can never access a user session.

param

caller The object making this request

return

PortalSession A reference to the user session the owns this e-clip instance

public void setSession(Object caller, PortalSession session)

Documentation

This method saves the user session reference within this instance. Note: For security reasons, the session object is settable only if the eClip is cached in the user session. Globally cached e-clips can NEVER access a user session

param

caller The object making this request

param

session A reference to the user session the owns this e-clip instance

public eClipManager geteClipManager( )

Documentation

This method returns the instance of the eClip manager

return

eClipManager The object that manages e-clip loading and execution

public String getRedirectedInternalResponse(Object caller, String urlString)

Documentation

This method allows a eClip to set it's response via a redirected call to some internal page that is specified by the urlString. Since this method uses the wwwComponent to perform the redirection, all URLs within the page will automatically be fully qualified.

NOTE: The use of this method consitutes a major hack, and it should be used only is absolutely necessary.

param

urlString A fully qualified URL for the redirection

return

Sting A string containing the page data from the redirection

private void readObject(java.io.ObjectInputStream in) throws IOException, ClassNotFoundException

private void writeObject(java.io.ObjectOutputStream out) throws IOException

public PortaleClip(eClipManager ecm)

Documentation

This constructor creates a new instance of a e-clip. To do this it initializes the component list vector, which will be populated with component instances.

param

eClipManager The instance of the owner eClip manager

param

RepositoryManager The instance of the system repository manager

Attributes

private PortalSession session

Documentation

The user session that has control of this e-clip (only for session-cached e-clips)

private Hashtable scratchPad

Documentation

Hashtable where e-clips can store data shared by its components

private Hashtable urlParameters

Documentation

The url parameter block from the original browser request

private Vector componentVector

Documentation

The list of components that make up this e-clip

private long lastRefresh

Documentation

The time at which the last refresh occurred in milliseconds

private int refreshTime

Documentation

The cache refresh interval in millisecondseconds

private boolean isUnbounded

Documentation

Determines if this eClip has an unbounded display rendering (no table wrapper)

private boolean showRefreshTime

Documentation

Determines if this eClip shows the refresh time in the caption line

private boolean allowsRefresh

Documentation

Determines if this eClip shows the manual refresh button

private boolean borderVisible

Documentation

Determines if this eClip is drawn with a border

private boolean staticCache

Documentation

Determines if this is a persitsent eClip or not

private int cache

Documentation

The current cache setting for this eClip

private String referenceURL

Documentation

An optional URL referenace to the page/app from which this e-clip originated

private String title

Documentation

An optional title string used in the titlebar

private String pageName

Documentation

The name of the user page on which this eClip resides

private String guid

Documentation

An optional unique identifier for this e-clip

public static final int CACHE_STATIC

public static final int CACHE_GLOBAL

public static final int CACHE_SESSION

public static final int CACHE TRANSIENT

ScriptedComponent class

Declaration

public class com.hcl.portal.manager.eclip.ScriptedComponent extends

PortalComponent implements SecurePortalComponent

Operations

private String insertNewLinesInHTML(String source, int lineLength)

Documentation

insertNewLinesInHTML( )

SUMMARY: This method takes a source string and breaks it into approximately ‘lineLength’ lengths by inserting newlines (‘\n’). The resulting lines are ‘approximately’ ‘lineLength’ because newlines are not inserted until a space is encountered.

param

String source—the original source string

int lineLength—the length of desired lines

return

String—the source string broken to ‘lineLength’ char lengths

public void handleRequest( )

Documentation

This method implements the required abstract to handle requests for this component. It enumerates the data vectors and executes each script command in sequence.

public void loadExtractionRules( ) throws FileNotFoundException, IOException

Documentation

This method builds the list of rules extracted from a script file matching the unique name of the component. Note that component scripts must have a “.comp” file extension.

public ScriptedComponent(eClipManager ecm)

Documentation

This constructor creates a new instance of a scripted component. It intializes all internal data structures used by this component

Attributes

private String postfixString

Documentation

Storage for postfix text

private String prefixString

Documentation

Storage for prefix text

private String replaceString

Documentation

Storage for replacement text

private Vector substituteNewVector

Documentation

Storage for new strings for substitution tags

private Vector substituteOldVector

Documentation

Storage for old strings for substitution tags

private Vector deleteEndVector

Documentation

Storage for end information for delete tags

private Vector deleteStartVector

Documentation

Storage for start information for delete tags

private Vector tagEndVector

Documentation

Storage for end information for replacer tags

private Vector tagStartVector

Documentation

Storage for start information for replacer tags

private Vector tagVector

Documentation

Storage for script replacer tags

Association Links

eClipManager ecm

Documentation

The eClip manager reference

DI.eClip Class

Declaration

public class com.hcl.portal.manager.eclip.eClipliformation

Operations

public eClipInformation( )

Attributes

public int isUnbounded

public int showRefreshTime

public int hasRefreshButton

public int hasBorder

public String renderer

public String pageRef

public String request

public String title

public String name

public String guid

DI.11 DAComponent Class

Declaration

public abstract class com.hcl.portal.manager.eclip.DAComponent extends PortalComponent

Operations

protected abstract String getApplicationResponse(String resource, String request)

Documentation

This method is abstract and hence must be defined by all derived classes. It is responsible for retrieving the response from the application.

param

String resource The resource identifier for the application handling the request.

param

String request The request datagram for the application.

return

String A string containing the response from the application.

public void setProtocolManager(ProtocolManager pm)

Documentation

A method which, unless overriden, simply ignores the passed-in protocol manager reference. The HTTP DAC, particularly, needs this in order to be able to communicate with the outside world.

public void handleRequest( )

Documentation

This method implements the required PortalComponent abstract to handle requests for this component. This component's request string is tokenized into an application resource identifier and an application request string.

public DAComponent( )

Documentation

Construct a new instance this component

DI.13 SecurePortalComponent Interface

Declaration

public abstract interface com.hcl.portal.manager.eclip.SecurePortalComponent

Documentation

This interface provides an internal mechanism to breach the security firewall surrounding normal e-clips and allows a component to write to the users session.

Currently the only justification for this is to write login information from the CAP login e-clip into the session.

DI.14 WwwComponent Class

Declaration

public class com.hel.portal.component.wwwComponent extends

PortalUIComponent

Operations

public void handleRequest( )

Documentation

This method implements the required abstract to handle requests for this component. It loads the contents of the URL (with hyperlink fixups) into the response buffer.

public wwwComponent( )

Documentation

Construct a new instance this component

DI.15 HtmlImageComponent Class

Declaration

public class com.hcl.portal.component.htmlImageComponent extends PortalComponent

Operations

public void handleRequest( )

Documentation

This method implements the required abstract to handle requests for this component. It the image URL into an HTML image tag.

public htmlImageComponent( )

Documentation

Construct a new instance of the HTML image component

DI.16 CAPLoginComponent Class

Declaration

public class com.hcl.portal.component.CAPLoginComponent extends PortalUIComponent implements SecurePortalComponent

Operations

public void handlerequest( )

Documentation

This method implements the required abstract to handle requests for this component.

private void initialize( )

Documentation

This method is called whenever the CAP login component is initialized This is used internally by handleRequest( ) method.

public CAPLoginComponent( )

Documentation

Construct a new instance this component

Attributes

private String table1Template

private String tableTemplate

private Cap capServer

Documentation

Instance of the CAP server used by the login

private int authType

Documentation

The type of user authorization in use by CAP

eClipCredentials Class

Declaration

public class com.hcl.portal.manager.eclip.eClipCredentials

Operations

public void setKeys(String[ ] v)

public void setaonymous(boolean b)

public void setCfgInfo(String s)

public String[ ] getkeys( )

public boolean hasKeys( )

public boolean isAnonymous( )

public String getCfgInfo( )

public eClipCredentials( )

Attributes

private boolean defu

private boolean anon

private String extra

private String[ ] keys

DI.18 PortalUIComponent Class

Declaration

public class com.hcl.portal.component.PortalUIComponent extends PortalComponent implements SecurePortalComponent

Operations

public String applyThemeTitlebar(String content, int title, String toolbar)

public void handleRequest( )

Documentation

This method implements the required abstract to handle requests for this component.

public void handleRequest(boolean forceRefresh)

Documentation

This method implements the required abstract to handle requests for this component.

public void initializeUIData( )

Documentation

This method is called whenever the CAP login component is initialized. This is used internally by handlerequest( ) method.

public PortalUIComponent( )

Documentation

Construct a new instance this component

Attributes

private String titleFontString

protected String eClipTemplate

protected String themeName

protected Vector dialogTitles

protected Hashtable urlParameters

protected ProtocolManager pm

protected ThemeManager tm

protected RepositoryManager rm

protected ApplicationSessionManager am

The Embodiments of the Invention in which an Exclusive Property or Privilege is claimed are Defined as Follows:

1. A system for providing a portal to a user via a browser on a network, said portal comprising:
(a) an interface for communicating between said portal and said user;
(b) a theme manager for selecting a theme, said theme defining a presentation format for said browser; and
(c) a plug-in manager for controlling a plurality of plug-ins, said plug-ins for retrieving and formatting information content for said user, wherein said plug-in retrieves information from both local and remote sources.
